(19) United States
(12) Patent Application Publication
(10) Pub. No.: US 2023/0010434 A1
(43) Pub. Date: Jan. 12, 2023

(54) MOUNTING ASSEMBLY HANGABLE FROM A WALL PANEL ASSEMBLY

(71) Applicant: 2840629 ONTARIO INC., Woodbridge (CA)

(72) Inventors: Giuseppe PRIZZI, Kleinburg (CA); Marcello VENAFRO, Toronto (CA)

(73) Assignee: 2840629 ONTARIO INC., Woodbridge (CA)

(21) Appl. No.: 17/859,768

(22) Filed: Jul. 7, 2022

Related U.S. Application Data
(60) Provisional application No. 63/219,208, filed on Jul. 7, 2021.

(51) Int. Cl. F16M 13/02

(52) U.S. Cl. CPC F16M 13/02

(57) ABSTRACT

Disclosed herein is a mounting assembly configured to be hung from a wall panel assembly, and includes a bracket and a load supporter rotatable relative to the bracket. The load supporter is transitionable between a support-ready configuration and a storage. In the support-ready configuration, the load-supporting portion extends in a direction along an axis that traverses a plane defined by the front surface of the wall panel assembly. In the storage configuration, the load-supporting portion extends in a direction along an axis that is parallel to the plane defined by the front surface of the wall panel assembly. Also disclosed herein is a mounting assembly, with the load supporter releasably receivable in a cavity of the bracket. While the load supporter is received in the cavity, a retainer is vertically supporting the load supporter, and opposing displacement of the load supporter, relative to the bracket, in an outwardly direction.

### CROSS REFERENCE TO RELATED APPLICATION

This application claims priority to U.S. Provisional Application No. 63/219,208 filed on Jul. 7, 2021, which is hereby incorporated herein by reference in its entirety.

### FIELD

The present disclosure relates to a mounting assembly, and in particular, a mounting assembly with a load supporter that is rotatable relative to a bracket, and a mounting assembly with a load supporter that is releasably retainable to a bracket.

### BACKGROUND

To avoid clutter, and to organize objects, such as tools, toys, organizing boxes and bins, equipment, and the like, the objects may be hung from a wall. A mounting bracket may be secured to the wall, and the object may be hung from the mounting bracket, such that the object is hung from the wall via the mounting bracket. The mounting bracket is typically secured to a stud of the wall such that the weight of the object hung from the mounting bracket is supported by the stud rather than the drywall. Accordingly, a relatively heavy object may be hung from the mounting bracket. However, each wall has a limited number of studs, and the bracket are secured to the studs where a user may access with relative ease, which limits the number of mounting brackets that may be secured to the wall.

To increase the number of mounting bracket that may be secured to the wall, a wall panel assembly may first be secured to the wall. Existing wall panel assemblies comprise a plurality of wall panels that are connected together to define the wall panel assembly. The wall panel assembly is typically secured to two adjacent studs, such that the wall panel assembly extends between the adjacent studs. The wall panel assembly defines one or more cavities to retain the mounting bracket, such that the mounting bracket is secured to the wall via the wall panel assembly. The one or more cavities extend along the length of the wall panel assembly, such that a plurality of mounting brackets may be retained by the wall panel assembly.

Unfortunately, existing mounting brackets are limited to being retained by one slot of the wall panel assembly, and are not securable to the wall panel assembly. Moreover, when not being used, the load supporter continues to extend outward from the bracket, which takes up space, and creates safety risk when walking or working around the wall panel assembly.

### SUMMARY

In one aspect, there is provided a mounting assembly configured to be hung from a recess defined within a wall panel assembly, the wall panel assembly including a front surface, the mounting assembly comprising: a bracket; a load supporter, including a load-supporting portion, the load-supporting portion configured to support a load, the load supporter coupled to the bracket, such that the load supporter is rotatable, relative to the bracket, about a rotation axis; wherein: the load supporter is transitionable between a support-ready configuration and a storage configuration via rotation of the load supporter, relative to the bracket, about the rotation axis; in the support-ready configuration, the load-supporting portion extends in a direction along an axis that traverses a plane defined by the front surface of the wall panel assembly; in the storage configuration, the load-supporting portion extends in a direction along an axis that is parallel to the plane defined by the front surface of the wall panel assembly.

In another aspect, there is provided a mounting assembly configured to be hung from a recess of a wall panel assembly, the wall panel assembly including a front surface, the mounting assembly comprising: a bracket, including a front surface and a retainer, and a cavity disposed between the front surface and the retainer; a load supporter, including: a load-supporting portion, the load-supporting portion configured to support a load; wherein: the front surface of the bracket, the retainer of the bracket, and the load supporter are co-operatively configured such that downwardly insertion of the load supporter into the cavity is with effect that the load supporter becomes disposed in a retained configuration; in the retained configuration: the retainer is: vertically supporting the load supporter; and opposing displacement of the load supporter, relative to the bracket, in an outwardly direction relative to the front surface of the wall panel assembly; and the load-supporting portion extends in a direction along an axis that traverses a plane defined by the front surface of the wall panel assembly.

In another aspect, there is provided a mounting assembly configured to be hung from a wall panel assembly, the wall panel assembly including a front surface, the mounting assembly comprising: a bracket; a load supporter, including a load-supporting portion, the load-supporting portion configured to support a load, the load supporter coupled to the bracket, such that the load supporter is rotatable, relative to the bracket, about a rotation axis; wherein: the connection of the bracket and the wall panel assembly is effectible by hanging of the bracket from the wall panel assembly; the load supporter is transitionable between a support-ready configuration and a storage configuration via rotation of the load supporter, relative to the bracket, about the rotation axis; in the support-ready configuration, the load-supporting portion extends in a direction along an axis that traverses a plane defined by the front surface of the wall panel assembly; in the storage configuration, the load-supporting portion extends in a direction along an axis that is disposed at an acute angle, relative to the plane defined by the front surface of the wall panel assembly, the acute angle has a maximum value of 10 degrees.

In another aspect, there is provided a mounting assembly configured to be hung from a wall panel assembly, the wall panel assembly including a front surface, the mounting assembly comprising: a bracket; a load supporter, including a load-supporting portion, the load-supporting portion configured to support a load, the load supporter coupled to the bracket, such that the load supporter is rotatable, relative to the bracket, about a rotation axis; wherein: the connection of the bracket and the wall panel assembly is effectible by hanging of the bracket from the wall panel assembly; the load supporter is transitionable between a support-ready configuration and an storage configuration via rotation of the load supporter, relative to the bracket, about the rotation axis; in the support-ready configuration, the load-supporting portion extends in a direction along a first axis; in the storage configuration, the load-supporting portion extends in a direction along a second axis; an acute angle defined between the first axis and the second axis has a minimum value of at least 50 degrees.

In another aspect, there is provided a kit for a mounting assembly configured to be hung from a wall panel assembly, the wall panel assembly including a front surface, the kit comprising: a bracket; a load supporter, including a load-supporting portion, the load-supporting portion configured to support a load, the load supporter configured for coupling to the bracket, such that while the load supporter is coupled to the bracket, the load supporter is rotatable, relative to the bracket, about a rotation axis; wherein: while the load supporter is coupled to the bracket, the load supporter is transitionable between a support-ready configuration and an storage configuration via rotation of the load supporter, relative to the bracket, about the rotation axis; in the support-ready configuration, the load-supporting portion extends in a direction along an axis that traverses a plane defined by the front surface of the wall panel assembly; in the storage configuration, the load-supporting portion extends in a direction along an axis that is parallel to the plane defined by the front surface of the wall panel assembly.

In another aspect, there is provided a kit for a mounting assembly configured to be hung from a recess of a wall panel assembly, the wall panel assembly including a front surface, the kit comprising: a bracket, including a front surface and a retainer, and a cavity disposed between the front surface and the retainer; a load supporter, including: a load-supporting portion, the load-supporting portion configured to support a load; wherein: the front surface of the bracket, the retainer of the bracket, and the load supporter are co-operatively configured such that downwardly insertion of the load supporter into the cavity is with effect that the load supporter becomes disposed in a retained configuration; in the retained configuration: the retainer is: vertically supporting the load supporter; and opposing displacement of the load supporter, relative to the bracket, in an outwardly direction relative to the front surface of the wall panel assembly; and the load-supporting portion extends in a direction along an axis that traverses a plane defined by the front surface of the wall panel assembly.

Other aspects will be apparent from the description and drawings provided herein.

### BRIEF DESCRIPTION OF DRAWINGS

In the figures, which illustrate example embodiments,

FIG. 1 is a cross-sectional view of an example embodiment of a panel;

FIG. 2 is an enlarged view of a portion of the panel of FIG. 1, the portion of the panel identified by window 2 in FIG. 1;

FIG. 3 is an enlarged view of a portion of the panel of FIG. 1, the portion of the panel identified by window 3 in FIG. 1;

FIG. 4 is a cross-sectional view of a wall panel assembly including the panel of FIG. 1;

FIG. 5A is a cross-sectional view of a panel defined configuration disposed at a first end of the panel of FIG. 1, with a projection disposed in a relative movement effective configuration;

FIG. 5B is a cross-sectional view of the panel defined configuration disposed at the first end of the panel of FIG. 1, with the projection disposed in a connection prevention configuration;

FIG. 6 is another enlarged view of a portion of the panel of FIG. 1, the portion of the panel identified by window 3 in FIG. 1, wherein an interacting portion is disposed in a pre-deformation configuration;

FIG. 7 is an enlarged view of the portion of the panel of FIG. 1, the portion of the panel identified by window 3 in FIG. 1, wherein the interacting portion is disposed in an interference effective configuration;

FIG. 8 is enlarged view of a portion of the panel of FIG. 1, the portion of the panel identified by window 3 in FIG. 1, wherein the interacting portion is disposed in an interference ineffective configuration;

FIG. 9 is a cross-sectional view of a panel-defined configuration disposed at a first end of the panel of FIG. 1, and a panel-defined configuration disposed at a second end of another panel, wherein an interacting portion of the panel-defined configuration disposed at the second end of the another panel is disposed in a pre-deformation configuration;

FIG. 10 is a cross-sectional view of a panel-defined configuration disposed at a first end of the panel of FIG. 1, and a panel-defined configuration disposed at a second end of another panel, wherein an interacting portion of the panel-defined configuration disposed at the second end of the another panel is disposed in an interference ineffective configuration;

FIG. 11 is an enlarged view of a portion of the wall panel assembly of FIG. 4, the portion of the panel identified by window 11 in FIG. 4;

FIG. 12 is a cross-sectional view of a panel-defined configuration disposed at a first end of the panel of FIG. 1, and a panel-defined configuration disposed at a second end of another panel, wherein an insertable projection of the panel of FIG. 1 is disposed in a connection prevention configuration;

FIG. 13 is a cross-sectional view of the wall panel assembly of FIG. 4;

FIG. 14 is a cross-sectional of a wall panel assembly, the wall panel assembly including an alternate embodiment of the panel of FIG. 1;

FIG. 15 is a cross-sectional view of an alternate embodiment of the panel of FIG. 1;

FIG. 16 is a cross-sectional view of an alternate embodiment of the panel of FIG. 1;

FIG. 17 is a cross-sectional view of a wall panel assembly comprising panels of FIG. 16;

FIG. 18 is a cross-sectional view of a wall panel assembly comprising panels of an alternate embodiment of the panel of FIG. 1;

FIG. 19 is a cross-sectional view of an alternate embodiment of the panel of FIG. 1;

FIG. 20 is a cross-sectional view of an alternate embodiment of the panel of FIG. 19;

FIG. 21 is a cross-sectional view of a trim for connecting with a panel defined configuration disposed at a first end of the panel of FIG. 1;

FIG. 22 is a cross-sectional view of a trim for connecting with a panel defined configuration disposed at a second end of the panel of FIG. 1;

FIG. 23 is an alternate embodiment of the trim of FIG. 22;

FIG. 24 is a cross-sectional view of a wall panel assembly comprising the panel of FIG. 15 and the trim of FIG. 22;

FIG. 25 is a cross-sectional view of a wall panel assembly comprising the panel of FIG. 18 and the trim of FIG. 23;

FIG. 26 is a cross-sectional view of a wall panel assembly comprising the panel of FIG. 19 and the trim of FIG. 22;

FIG. 27 is a cross-sectional view of a wall panel assembly comprising the panel of FIG. 20 and the trim of FIG. 23;

FIG. 28 is a perspective view of a wall panel assembly connected to a wall;

FIG. 29 is an exploded view of the wall panel assembly of FIG. 28;

FIG. 30 is a front perspective view of a mounting assembly, with the mounting assembly disposed in a retracted configuration;

FIG. 31 is a cross-sectional view of a bracket of the mounting assembly of FIG. 30;

FIG. 32 is a cross-sectional view of the mounting assembly of FIG. 30 retained to a wall panel assembly;

FIG. 33 is a cross-sectional view of a bracket connector of a bracket being inserted into a cavity of a wall panel assembly;

FIG. 34 is an enlarged view of the mounting assembly and wall panel assembly of FIG. 41, the portion identified by window 34 in FIG. 32;

FIG. 35 is a rear perspective view of the mounting assembly of FIG. 30;

FIG. 36 is a front perspective view of the mounting assembly of FIG. 30, with the mounting assembly disposed in an extended configuration;

FIG. 37 is a front perspective view of the mounting assembly of FIG. 30, connected to a panel;

FIG. 38 is a front perspective view of the mounting assembly of FIG. 30, connected to another panel;

FIG. 39 is a front perspective view of an alternate embodiment of the mounting assembly of FIG. 30, with the mounting assembly disposed in a retracted configuration;

FIG. 40 is a front perspective view of the mounting assembly of FIG. 39, with the mounting assembly disposed in an intermediate configuration;

FIG. 41 is a front perspective view of the mounting assembly of FIG. 39, connected to a panel;

FIG. 42 is a front perspective view of an alternate embodiment of the mounting assembly of FIG. 30, with the mounting assembly disposed in a retracted configuration;

FIG. 43 is a rear perspective view of the mounting assembly of FIG. 42;

FIG. 44 is a front perspective view of the mounting assembly of FIG. 42, with the mounting assembly disposed in an extended configuration;

FIG. 45 is a rear perspective view of the mounting assembly of FIG. 44;

FIG. 46 is a front perspective view of an alternate embodiment of the mounting assembly of FIG. 42, with the mounting assembly disposed in a retracted configuration;

FIG. 47 is a rear perspective view of the mounting assembly of FIG. 46;

FIG. 48 is a front perspective view of the mounting assembly of FIG. 46, with the mounting assembly disposed in an extended configuration;

FIG. 49 is a rear perspective view of the mounting assembly of FIG. 48.

FIG. 50 is a front perspective view of a mounting assembly, with the assembly disposed in a retracted configuration;

FIG. 51 is a rear perspective view of the mounting assembly of FIG. 50;

FIG. 52 is a front perspective view of the mounting assembly of FIG. 50, with the assembly disposed in an extended configuration;

FIG. 53 is a rear perspective view of the mounting assembly of FIG. 50, with the assembly disposed in an extended configuration;

FIG. 54 is a front perspective view of the mounting assembly of FIG. 50 secured to a wall panel assembly, the load supporter in a support-ready configuration;

FIG. 55 is a front perspective view of the mounting assembly of FIG. 50 secured to a wall panel assembly, the load supporter in a storage configuration;

FIG. 56 is a front view of a plurality of mounting assemblies of FIG. 50, each assembly secured to a wall panel assembly and supporting a wheel of an automobile;

FIG. 57 is a front perspective view of an alternate embodiment of the mounting assembly of FIG. 50, with the assembly disposed in an extended configuration, and the load supporter disposed in the cavity;

FIG. 58 is a front perspective view of the mounting assembly of FIG. 57, with the assembly disposed in an extended configuration, and the load supporter disposed out of the cavity;

FIG. 59 is a front perspective view of the mounting assembly of FIG. 57, with the assembly disposed in a retracted configuration, and the load supporter disposed in of the cavity;

FIG. 60 is a rear perspective view of the mounting assembly of FIG. 57, with the assembly disposed in a retracted configuration, and the load supporter disposed in the cavity;

FIG. 61 is a rear perspective view of the mounting assembly of FIG. 57, with the assembly disposed in an extended configuration, and the load supporter disposed in the cavity;

FIG. 62 is a front perspective view of the mounting assembly of FIG. 57 secured to a wall panel assembly, the load supporter disposed out of the cavity;

FIG. 63 is a front perspective view of the mounting assembly of FIG. 57 secured to a wall panel assembly, the load supporter disposed in the cavity;

FIG. 64 is a front perspective view of a plurality of mounting assemblies of FIG. 57, each assembly secured to a wall panel assembly and supporting a wheel of an automobile;

FIG. 65 is a front view of a plurality of mounting assemblies of FIG. 57, each assembly secured to a wall panel assembly and supporting a wheel of an automobile;

FIG. 66 is a front perspective view of an alternate embodiment of the mounting assembly of FIG. 57, with the assembly disposed in a retracted configuration, and the load supporter disposed in the cavity;

FIG. 67 is a front perspective view of the mounting assembly of FIG. 66, with the assembly disposed in an extended configuration, and the load supporter disposed out of the cavity;

FIG. 68 is a front perspective view of the mounting assembly of FIG. 66, with the assembly disposed in an extended configuration, and the load supporter disposed in the cavity;

FIG. 69 is a rear perspective view of the mounting assembly of FIG. 66, with the assembly disposed in a retracted configuration, and the load supporter disposed in the cavity;

FIG. 70 is a rear perspective view of the mounting assembly of FIG. 66, with the assembly disposed in an extended configuration, and the load supporter disposed in the cavity;

FIG. 71 is a front perspective view of the mounting assembly of FIG. 66 secured to a wall panel assembly, the load supporter disposed out of the cavity;

FIG. 72 is a front perspective view of the mounting assembly of FIG. 66 secured to a wall panel assembly, the load supporter disposed in the cavity.

### DETAILED DESCRIPTION

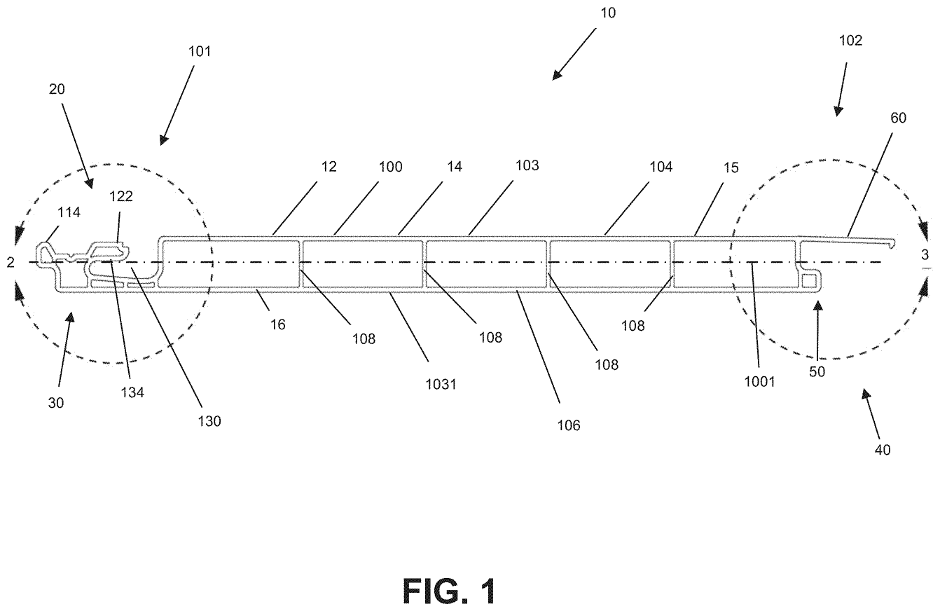

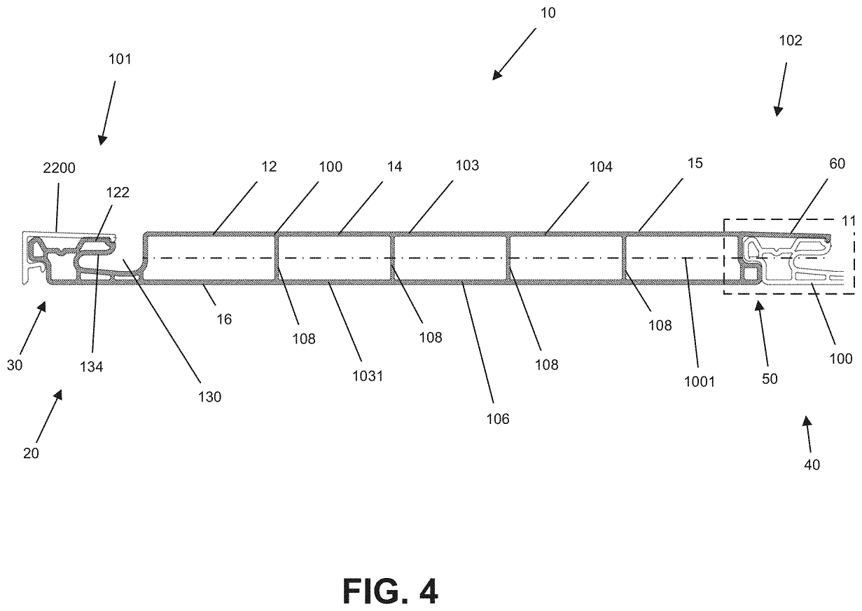

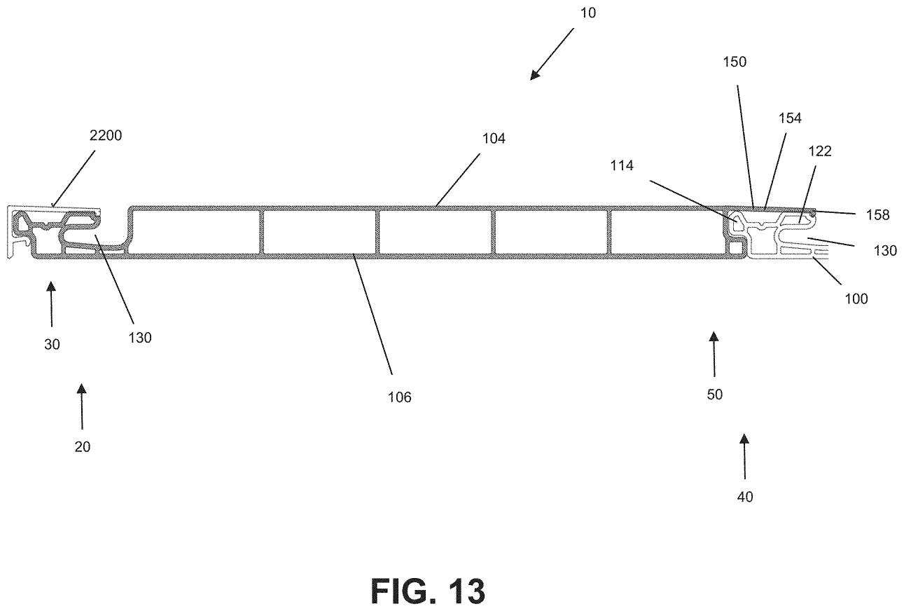

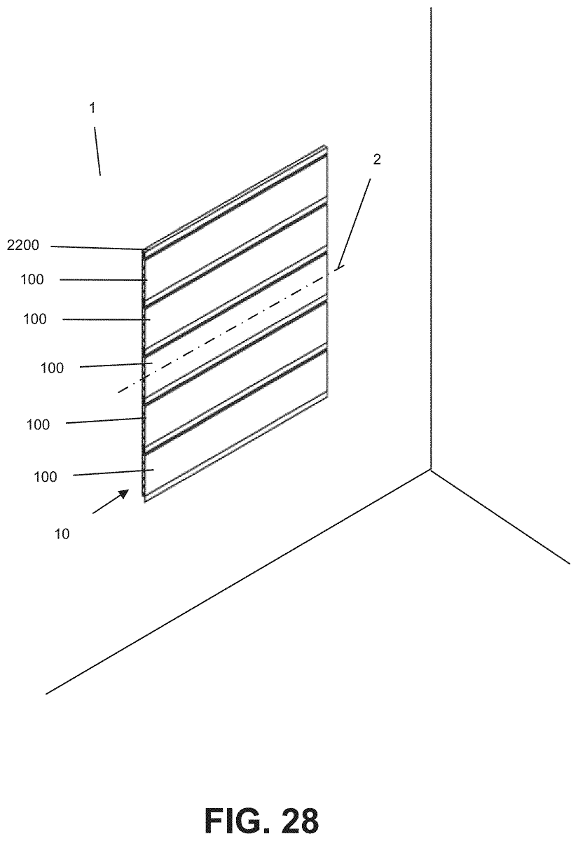

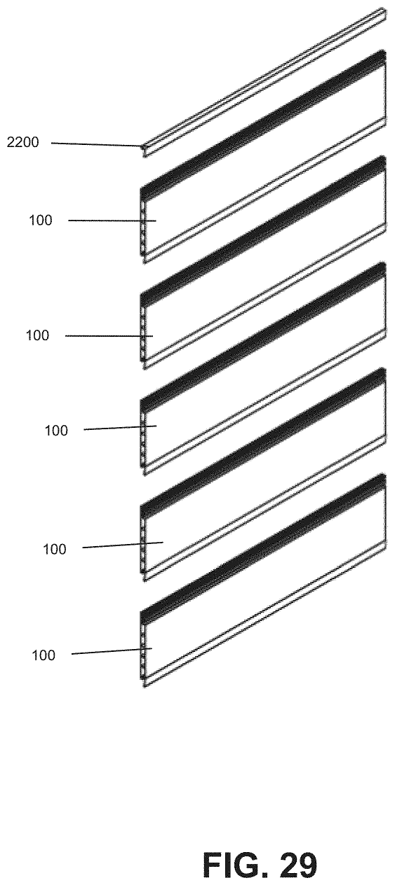

FIG. 1 depicts an embodiment of a panel 100. FIG. 4 and FIG. 13 depict a wall panel assembly 10, including a first panel 100 and a second panel 100 that are connected together. As depicted, the wall panel assembly 10 is established by the connection of the wall panels such that the wall panels are disposed in adjacent relationship. In some embodiments, for example, each one of the panels 100 of the panel assembly 10 is identical. In some embodiments, for example, at least one of the plurality of panels 100 of the panel assembly 10 is different from the other panels 100 of the assembly 10. It is understood that the wall panel assembly 10 can include more than two panels 100, connected together and disposed in adjacent relationship. Each one of the panels 100, independently, is configured to be secured to a mounting wall 1 (e.g. a wall of a building structure). FIG. 28 depicts the wall panel assembly 10 connected to a wall 1, such that the panels 100 are disposed in a vertical series. FIG. 29 is an exploded view of the wall panel assembly 10 of FIG. 28. In some embodiments, for example, the wall panel assembly 10 further includes one or more trims, for example, a trim 2200 connected to the uppermost one of the panels 100 of the assembly 10, or a trim 2300 connected to the lowermost one of the panels 100 of the assembly 10. As depicted in FIG. 4, a panel 100 is connected to another panel 100, and the panel 100 is also connected to the trim 2200.

As depicted in FIG. 1, the panel 100 defines a central longitudinal axis 1001. The panel 100 further defines a first end 101, a second end 102 that is opposite the first end 101, a first side 103, and a second side 1031 disposed on an opposite side of the panel relative to the first side 103.

The first side 103 of the panel 100 includes a front facing wall 14 that defines a front facing surface 104 configured for being visible while the panel 100 is secured to the wall 1. In some embodiments, for example, the visible surface of the panel 10 is defined by a planar continuous surface having a minimum surface area of at least 3 inches squared. In some embodiments, for example, the minimum width of the outermost surface 104, measured along the axis 1001, is at least 1 inch. In some embodiments, for example, the minimum length of the outermost surface 104, measured along the axis 2, as depicted in FIG. 28, is at least 3 inches. In some embodiments, for example, the axis 2 is parallel to an axis of extrusion of the panel 100. The second side 1031 of the panel 100 includes a rear facing wall 16 that defines a rear-facing surface or wall-opposing surface 106 that is configured for opposing the wall while the panel 100 is secured to the wall. In some embodiments, for example, the panel 100 includes a wall covering portion 12, wherein, while the panel 100 is secured to the wall 1, the wall covering portion covers a portion of the wall 1, such that the covered portion of the wall 1 is occluded from view. In some embodiments, for example, the wall covering portion of the panel 100 includes the front facing wall 14 and the rear facing wall 16.

In some embodiments, for example, the panel 100 further comprises a plurality of ribs 108 that connect the first side 103 and the second side 1031. In some embodiments, for example, the ribs 108 are configured to support a load that is supported by the panel 100 (e.g. the load that is mounted to a mounting assembly 500 that is retained to the panel 100). In some embodiments, for example, the ribs 108 are configured such that the load supported by the panel 100 is distributed about the panel 100

In some embodiments, for example, the panel 100 is connectible to another panel 100, such that connected first and second panels are established, for example, to define a wall panel assembly 10. Similar to the panel 100, the second panel 100 is configured to be secured to the wall, and defines a wall covering portion 12, a first end 101, a second opposite end 102, a first side 103, and a second opposite side 1031. The first side 103 includes a front facing wall 14 that defines an outermost surface 104 configured for being visible while the panel 100 is secured to the wall, and the second side 1031 includes a rear facing wall 16 that defines a wall-opposing surface 106 configured for opposing the wall while the panel 100 is secured to the wall.

In some embodiments, for example, the panel 100 defines, at the first end 101, a panel-defined configuration 20, which includes a first connection system counterpart configuration 30, and, at the second end 102, a panel-defined configuration 40, which includes a second connection system counterpart configuration 50. Similarly, the second panel 100 defines, at the first end 101, a panel-defined configuration 20, which includes a first connection system counterpart configuration 30, and, at the second end 102, a panel-defined configuration 40, which includes a second connection system counterpart configuration 50. The connection of the first panel 100 and the second panel 100 is effected by interaction of one of the first connection system counterpart configuration 30 and the second connection system counterpart configuration 50, of the first panel 100, and the other of the first connection system counterpart configuration 30 and the second connection system counterpart configuration 50, of the second panel 100.

The connection of a first panel 100 and a second panel 100 is effected between the first connection system counterpart configuration 30 of one of the first and second panels and the second connection system counterpart configuration 50 of the other one of the first and second panels. In some embodiments, for example, one of the first connection system counterpart configuration 30 and the second connection system counterpart 50 (in the illustrated embodiment, this is the first connection system counterpart configuration 30) is a male connection system counterpart configuration, and the other one of the first connection system counterpart configuration 30 and the second connection system counterpart configuration 50 (in the illustrated embodiment, this is the second connection system counterpart configuration 50) is a female connection system counterpart configuration, such that the connection of the first and second panels 100 is effectuated by connection the male connection system counterpart configuration, of one of the first and second panels 100, and the female connection system counterpart configuration of the other one of the first and second panels 100. In some embodiments, for example, the connection includes a snap fit connection. In some embodiments, for example, the connection includes an interference fit connection. In some embodiments, for example, the connection includes a friction fit connection.

In some embodiments, for example, the fastener-receiving portion 116 is configured to receive one or more mechanical fasteners, for example, screws, bolts, pins, and the like, to connect the panel 100 to a wall 1. The fastener-receiving portion 116 includes a fastener-engaging surface 118. The fastener-engaging surface 118 is configured to engage with a head of a fastener, and further configured to resist further displacement of the fastener through the panel 100 while the fastener-engaging surface 118 is engaged to the head of the fastener. In some embodiments, for example, the connection of the panel 100 to the wall 1 is effectuated by penetration of the fastener-receiving portion 116 with the mechanical fastener such that the mechanical fastener extends through the fastener-receiving portion 116 and into the wall 1, and the head of the mechanical fastener is bearing against the fastener-engaging surface 118, urging the panel 100 into contact engagement with the wall 1.

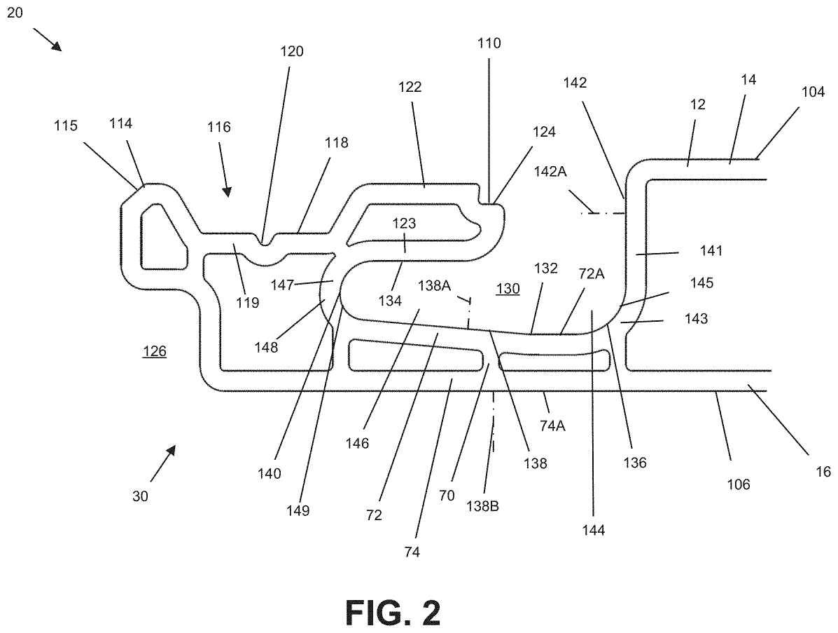

In some embodiments, for example, the fastener-receiving portion 116 includes a fastener locator 120 for locating placement of a fastener in a fastener effective position, and for guiding the penetration of the panel 100 by the mechanical fastener. In some embodiments, for example, the fastener locator 120 is defined by a panel member 119, as depicted in FIG. 2. In some embodiments, for example, the fastener is disposed in the fastener effective position while the fastener is disposed perpendicular to the wall 1 to which the panel 100 is to be connected. In some embodiments, for example, the fastener locator 120 includes a groove. In some embodiments, for example, the fastener locator 120 is configured to receive the tip of a fastener. In some embodiments, for example, the fastener locator 120 is sufficiently deep and wide to receive the tip of the fastener. In some embodiments, for example, the fastener locator 120 and the tip of the fastener are co-operatively configured such that, while the tip of the fastener is received in the fastener locator 120, the position of the fastener-receiving portion 116 is identified for a user to fasten the panel 100 to a wall 1. In some embodiments, for example, the fastener locator 120 and the tip of the fastener are co-operatively configured such that, while the tip of the fastener is received in the fastener locator 120, the fastener is oriented such that the fastener is able to fasten the panel 100 to a wall 1 in response to penetration of the fastener receiving portion 116. In some embodiments, for example, the groove 120 is defined on the fastener-engaging surface 118.

To connect the panel 100 to a wall 1, the panel 100 is disposed in abutting engagement against the wall 1, the fastener is emplaced via the fastener locator 120 in the fastening effective position, and penetrated through the fastener-engaging surface 118 the panel 100 and further penetrated through the fastener receiving portion 116, until the fastener engages and penetrates into the wall, such that the panel 100 is coupled to the wall via the fastener.

In some embodiments, for example, while the panel 100 is connected to the wall 1, for example, via a fastener, the visible portion of the outermost surface 104 is parallel to the surface of the wall 1 on which the panel 100 is mounted.

In some embodiments, for example, while the panel 100 is connected to the wall 1 via the penetration of the fastener through the panel 100 and into the wall 1, the fastener is retained by the panel member 118.

In some embodiments, for example, the panel 100 is co-operable with another panel for concealing the fastener while the connection is established between the panel 100 and the another panel 100 via the first connection system counterpart configuration 30 and the second connection system counterpart configuration 50.

In some embodiments, for example, the first panel 100 the second panel 100 are co-operatively configured such that, while the first panel 100 the second panel 100 are connected, and at least one of the first and second panels 100 are secured to a wall 1, for each one of the first panel 100 the second panel 100, independently, the panel is secured to the wall such that displacement of the panel, relative to the wall, at least within a plane that is parallel to the surface of the wall, is resisted.

In some embodiments, for example, the visible surfaces of first panel 100 the second panel 100 are co-planar while the two panels are connected to provide an aesthetically pleasing appearance.

In some embodiments, for example, the visible surface of the first panel 100 is defined by a planar continuous surface having a surface area of at least 3 inches squared.

In some embodiments, for example, the visible surface of the second panel 100 is defined by a planar continuous surface having a surface area of at least 3 inches squared.

FIG. 2 depicts an example embodiment of the first connection system counterpart configuration 30.

As depicted in FIG. 2, the first connection system counterpart configuration 30 includes a first connection system counterpart 110 of a first connection system 32. In some embodiments, for example, the first connection system counterpart 110 of the first connection system 32 includes a notch 124. The notch 124 is configured to receive a rearward projection 158 for connecting the panel 100 and an adjacent panel 100. In some embodiments, for example, while the rearward projection 158 is disposed in or received in the notch 124, the connection between the panel 100 and the adjacent panel 100 is retained.

As depicted in FIG. 2, the panel defined configuration 20 includes an arm 122. In some embodiments, for example, the arm 122 is configured to support an interacting portion 154 of the second connection system counterpart configuration 50 of an adjacent panel 100 while the panel 100 is connected to the adjacent panel 100. In some embodiments, for example, as depicted in FIG. 2, the first connection system counterpart 110 of the first connection system 32 is defined by the arm 122.

In some embodiments, for example, the arm 122 is a retaining surface-defining configuration 122, which includes a retaining surface-defining wall 123 that defines a retaining surface 134. The retaining surface 134 is configured to oppose displacement of a mounting assembly 500, for example, a bracket 502 of the mounting assembly 500, that is retained by the panel 100.

As depicted in FIG. 2, the first connection system counterpart configuration 30 includes a first connection system counterpart 114 of a second connection system counterpart 34. In some embodiments, for example, the first connection system counterpart 114 of the second connection system 34 includes an insertable projection 114.

In some embodiments, for example, the projection 114 is configured to be received in a recess 164 of the panel defined configuration 40 of an adjacent panel 100, for connecting the panel 100 and the adjacent panel 100. In some embodiments, the receiving of the projection 114 in the recess 164 includes a friction fit. In some embodiments, the receiving of the projection 114 in the recess 164 includes an interference fit.

In some embodiments, for example, the projection 114 is sufficiently wide to increase the structural strength of the projection 114 and the connection between the first panel 100 and the second panel 100, and to increase the air flow through the projection 114.

In some embodiments, for example, the projection 114 is configured to support the interacting portion 60 of the second connection system counterpart configuration 50 of an adjacent panel 100 while the panel 100 is connected to the adjacent panel 100.

In some embodiments, for example, as depicted in FIG. 2, the projection 114 includes an urging surface 115. In some embodiments, for example, the urging surface 115 is angled relative to the outermost surface 104. In some embodiments, for example, the urging surface 115 defines a normal axis, the outermost surface 104 defines a normal axis, and an acute angle defined between said normal axes has a minimum value of at least 10 degrees. In some embodiments, for example, said acute angle has a value of 45 degrees. In some embodiments, for example, the urging surface 115 is configured to engage with the interacting portion 60 of the second connection system counterpart configuration 50, and to urge the interacting portion 60 in a direction away from the axis 1001, such that displacement of the first panel 100 and the second panel 100 towards each other is effectible to effect the interaction between the first connection system counterpart configuration 30 and the second connection system counterpart configuration 50, to connect the first panel 100 and the second panel 100.

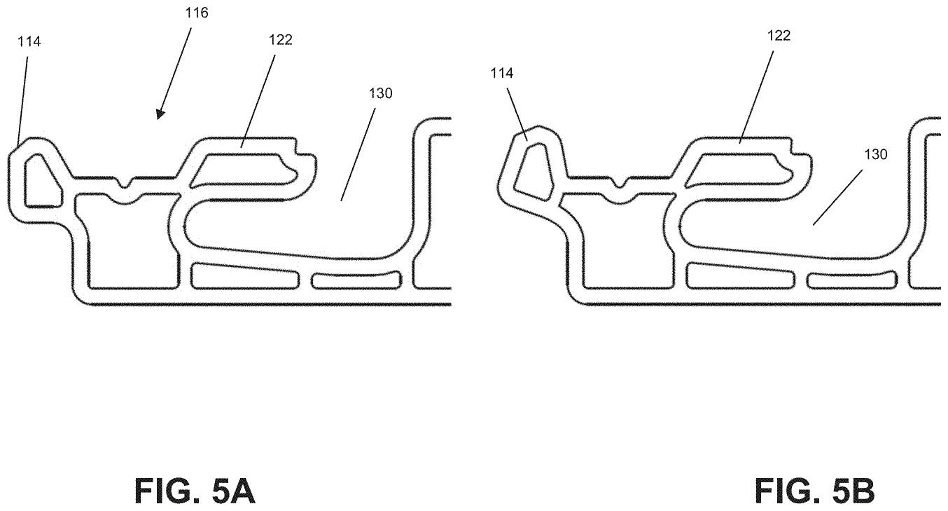

In some embodiments, for example, the projection 114 is connected to a residual panel portion, wherein the residual panel portion is the portion of the panel that excludes the projection 114. In some embodiments, for example, the projection 114 is configurable in a relative movement-effective configuration, as depicted in FIG. 5A. In some embodiments, for example, the projection is deformable for effecting transitioning of the projection 114 from the relative movement-effective configuration to a connection prevention configuration, as depicted in FIG. 5B, wherein the transitioning includes a forwardly displacement of the projection 114, relative to the residual panel portion. In some embodiments, for example, the forwardly displacement of the projection 114, relative to the residual panel portion, for effecting transitioning of the projection 114 from the relative movement-effective configuration to the connection prevention configuration, includes rotation of the projection 114, relative to the residual panel portion.

As depicted in FIG. 2, in some embodiments, for example, the panel defined configuration 20 includes the fastener receiving portion 116. As depicted, in some embodiments, for example, the projection 114 is connected to the fastener receiving portion 116, and the retaining surface defining configuration 122 is also connected to the fastener receiving portion 116, wherein the projection 114 and the retaining surface-defining configuration 112 are disposed on opposite sides of the fastener receiving portion 116.

In some embodiments, for example, the panel-defined configuration 20 includes a recess 126, configured to receive a second connection system counterpart 160 of the second connection system 34 of the panel-defined configuration 40 of an adjacent panel 100, for effecting connection of the connected panel 100 and the adjacent panel 100. As depicted in FIG. 2, the recess 126 is defined between the projection 114 and the fastener-receiving portion 116.

As depicted in FIG. 2, in some embodiments, for example, the panel-defined configuration 20 includes a rear wall configuration 70, comprising a first wall 72 and a second wall 74. As depicted, the second wall 74 is disposed rearwardly of the first wall 72, and extending from the rear-facing wall 16. The rear wall configuration 70 connects the first connection system counterpart configuration 30, the fastener-receiving portion 116, and the retaining surface defining configuration 122 to the wall covering portion 12. In some embodiments, for example, the rear wall configuration 70 extends between: 1) the fastener-receiving portion 116, and 2) the wall covering portion 12. In some embodiments, for example, the rear wall configuration 70 is disposed in force transmission communication with the retaining surface defining configuration 122.

In some embodiments, for example, the first wall 72 includes an outer surface 72A, and the second wall 74 includes an outer surface 74A. In some embodiments, for example, the outer surface 72A of the first wall 72 is a front facing surface of the rear wall configuration 70. In some embodiments, for example, the outer surface 74A of the second wall 74 is a rear facing surface of the rear wall configuration 70. The surface 74A is disposed, relative to the surface 72A, on an opposite side of the rear wall configuration 70. While the panel 100 is secured to a wall 1, the outer surface 74A of the second wall is disposed in opposing relationship to the wall 1.

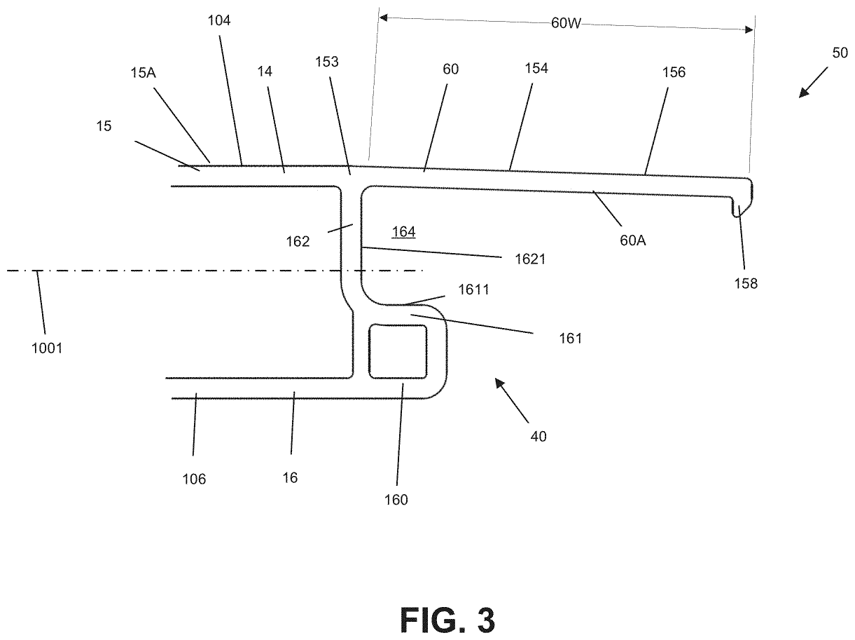

As depicted in FIG. 1 and FIG. 3, the panel 100 includes, at the second end 102, the panel-defined configuration 40. The panel-defined configuration 40 includes the second connection system counterpart configuration 50.

The second connection system counterpart configuration 50 includes an interacting portion 60. The front facing wall 14 includes the interacting portion 60, the interacting portion 60, having a terminal end that is, in some embodiments, a free end, and extending from a joint 153. In this respect, in some embodiments, for example, the front facing wall 14 is defined by the interacting portion 60 and a residual front facing wall portion 15, wherein the interacting portion 60 is connected to the residual front facing wall portion 15 at the joint 153. The interacting portion 60 includes a fastener receiver-covering portion 154 and a second connection system counterpart 158 of the first connection system 32. In some embodiments, for example, the second connection system counterpart 158 of the first connection system 32 includes a projection 158. In some embodiments, for example, the projection 158 extends perpendicularly, in a rearwardly direction, from the covering portion 154. In some embodiments, for example, the second connection system counterpart 158 of the first connection system 32 is disposed at the terminal end of the interacting portion 60. The projection 158 is configured to interact with the notch 124 of another panel 100, with effect that the projection 158 and the notch 124 are co-operatively disposed in a relative movement interference relationship, as explained in further detail below.

In some embodiments, for example, as depicted in FIG. 3, the interacting portion 60 has a width 60W having a minimum value of at least 0.375 inches.

In some embodiments, for example, while the panel 100 is connected to an adjacent panel 100, the covering portion 154 conceals at least a portion of, for example, the entirety of, the first connection system counterpart configuration 30 of the adjacent panel 100. In some embodiments, for example, while the panel 100 is connected to an adjacent panel 100 from view, the covering portion 154 conceals at least a portion of, for example, the entirety of, the fastener receiving portion 116 of the adjacent panel 100 from view. In some embodiments, for example, while the panel 100 is connected to an adjacent panel 100, and the adjacent panel 100 is secured to the wall 1 by a fastener, the covering portion 154 conceals at least a portion of, for example, the entirety of, the fastener from view.

The covering portion 154 includes an outermost surface 156 configured for being visible while the panel 100 is connected to another panel 100, and while the connected panel 100 and the another panel 100 are secured to the wall 1. In some embodiments, for example, the outermost surface 156 including a continuous surface that extends along the length of the covering portion 154.

In some embodiments, for example, the visible surface of the covering portion 154 has a minimum surface area of at least 1.125 inches squared. In some embodiments, for example, the visible surface of the covering portion 154 has a minimum width of at least ⅜ inches. In some embodiments, for example, the visible surface of the covering portion 154 has a minimum length of at least 3 inches.

The concealing of the fastener of the another panel by the panel 100, while the connection is established between the panel 100 and the another panel via the connection system counterpart configurations 30, 50, is effectuated by the covering portion 154. In this respect, in some embodiments, for example, the first panel 100 is co-operable with the second panel 100 such that, while the connection between the first and second panels is established via the connection system counterpart configuration 30 of the first panel and the connection system counterpart configuration 50 of the second panel, the covering portion 154 is covering (e.g. concealing) the fastener, which is effectuating the connection of the first panel 100 to the wall 1.

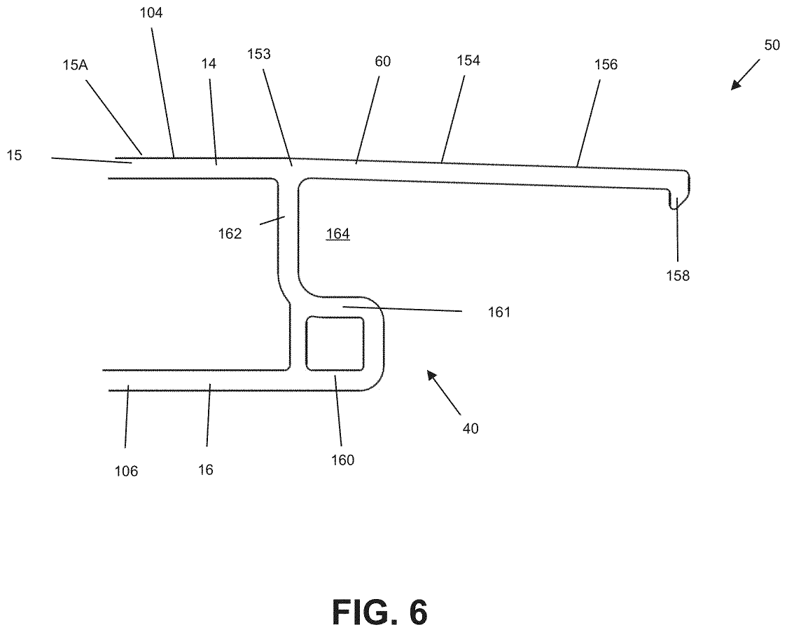

In some embodiments, for example, the interacting portion 60 is configurable in a pre-deformation configuration, as depicted in FIG. 3 and FIG. 6. In some embodiments, for example, the interacting portion 60 is disposed in the pre-deformation while there is an absence of interaction (e.g. absence of connection or engagement) between the panel 100 and an adjacent panel 100.

In some embodiments, for example, in the pre-deformation configuration, the extending of the interacting portion 60 from the joint 153 is with effect that the interacting portion 60 is tapering rearwardly, from the residual front facing wall portion 15, in a direction towards the central longitudinal axis 1001 of the panel 100. In some of these embodiments, for example, in the pre-deformation configuration, a normal axis of the outermost surface 156 of the covering portion 154 is disposed at an acute angle relative to the normal axis of an outermost surface 15A of the residual front facing wall portion 15, and in some of these embodiments, for example, the acute angle has a minimum value of at least 3 degrees.

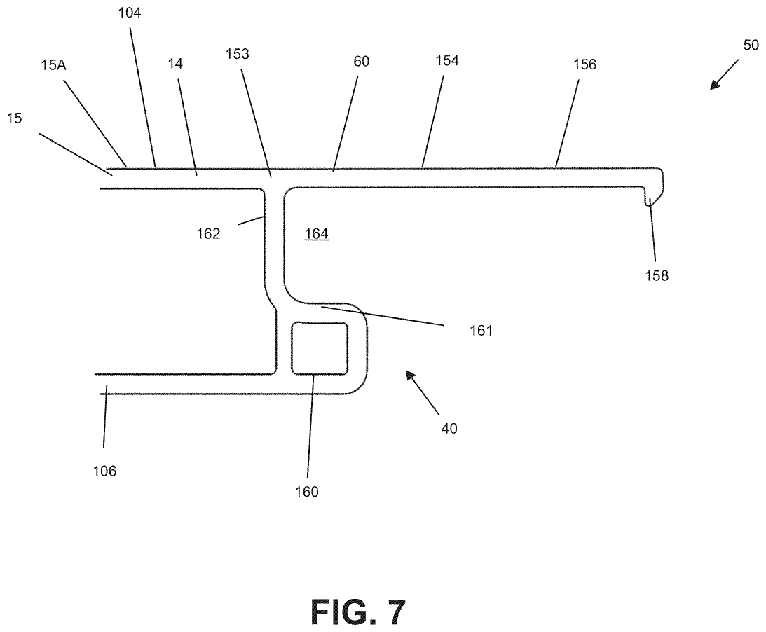

In some embodiments, for example, the interacting portion 60 is configurable in an interference effective configuration, as depicted in FIG. 7. In some embodiments, for example, the interacting portion 60 is disposed in the interference effective configuration while the panel 100 is connected to the adjacent panel 100 via the connection system counterpart configurations 30, 50.

In the interference-effective configuration, the extending of the interacting portion 60 from the joint 153 is with effect that the outermost surface 104 of the front facing wall 14 is a planar surface (e.g. outermost surface 156 of the covering portion 154 is co-planar with the outermost surface 15A of the residual front facing wall portion 15).

While the interacting portion 60 is disposed in the interference-effective configuration, the second connection system counterpart 158 (e.g. the projection 158) of the panel 100 is receivable in the notch 124 of the adjacent panel 100, such that the projection 158 and the notch 124 of the adjacent panel 100 are co-operable to interfere with relative movement between the panel 100 and the adjacent panel 100. In some embodiments, for example, while the panel 100 and the adjacent panel 100 are disposed in abutting engagement with a wall 1, and the projection 158 of the panel 100 is disposed in or received in the notch 124 of the adjacent panel 100, the projection 158 and the notch 124 are co-operatively configured to interference with displacement of the one of the panel 100 and the adjacent panel 100, relative to the other one of the panel 100 and the adjacent panel 100, within a plane that is parallel to the surface of the wall 1, and in a direction away from the other one of the panel 100 and the adjacent panel 100.

The interacting portion 60 is deformable for effectuating transitioning of the interacting portion 60 from the pre-deformation configuration to the interference-effective configuration. In some embodiments, for example, the transitioning of the interacting portion 60 from the pre-deformation configuration to the interference-effective configuration includes a forwardly displacement of the second connection system counterpart 158 of the first connection system 32.

In some embodiments, for example, the forwardly displacement of the second connection system counterpart 158 of the first connection system 32, for transitioning of the interacting portion 60 from the pre-deformation configuration to the interference-effective configuration, includes a displacement of the second connection system counterpart 158 of the first connection system 32 by a distance of at least 0.030 inches in a forwardly direction.

In some embodiments, for example, the transition of the interacting portion 60 from the pre-deformation configuration to the interference-effective configuration includes rotation of the interacting portion 60. In some embodiments, for example, the interacting portion 60 is rotatable about the joint 153, as depicted in FIG. 3. In some embodiments, for example, the angle of rotation of the covering portion 60 from the pre-deformation configuration to the interference-effective configuration has a minimum value of at least 3 degrees.

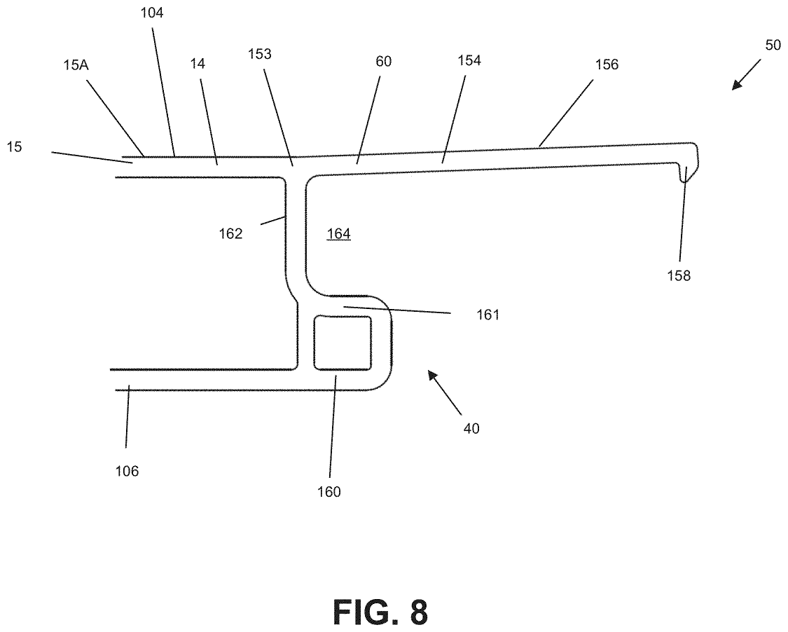

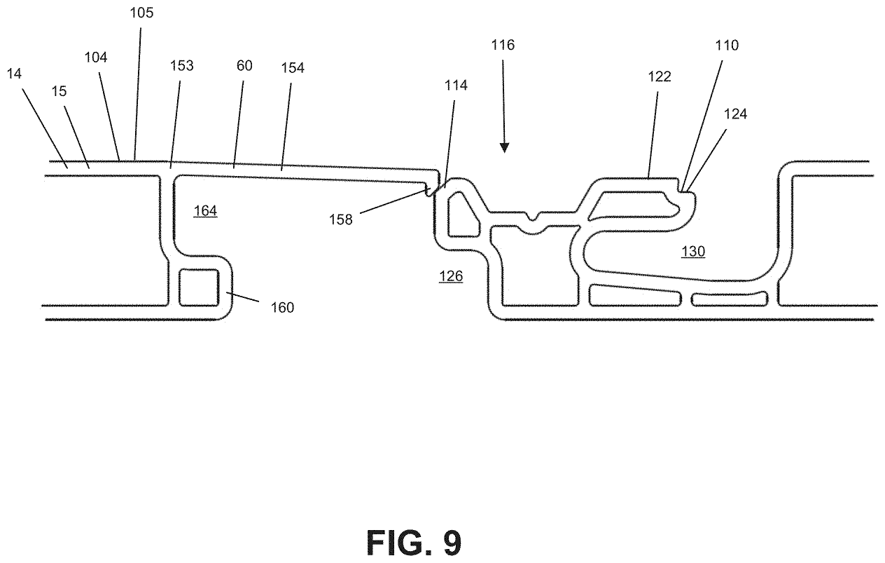

In some embodiments, for example, the interacting portion 60 is configurable in an interference ineffective configuration, as depicted in FIG. 8. In some embodiments, for example, the interacting portion 60 is disposed in the interference ineffective configuration while: 1) the panel 100 is engaged with the adjacent panel 100 and being displaced towards the adjacent panel 100 to effect the connection between the panel 100 and the adjacent panel 100, or 2) the connection between a connected panel 100 and adjacent panel 100 is to be defeated.

In some embodiments, for example, in the interference ineffective configuration, the extending of the interacting portion 60 from the joint 153 is with effect that the interacting portion 60 is tapering forwardly from the residual front facing wall portion 15, in a direction away from the central longitudinal axis 1001 of the panel 100. In some of these embodiments, for example, in the interference ineffective configuration, a normal axis of the outermost surface 156 of the covering portion 154 is disposed at an acute angle relative to the normal axis of the outermost surface 15A of the residual front facing wall portion 15, and in some of these embodiments, for example, the acute angle has a minimum value of at least 3 degrees.

While the interacting portion 60 is disposed in the interference-ineffective configuration, the panel 100 is displaceable towards, or away from, the adjacent panel 100, while the second connection system counterpart configuration 50 is disposed in an interacting relationship (e.g. contact engagement) with the first connection system counterpart configuration 30 of the adjacent panel 100, for example, to effect the connection between the panel 100 and the adjacent panel 100, or to defeat the connection between the connected panel 100 and the adjacent panel 100.

The interacting portion 60 is deformable for effectuating transitioning of the interacting portion 60 from the interference-effective configuration to the interference ineffective configuration. In some embodiments, for example, the transitioning of the interacting portion 60 from the interference-effective configuration to the interference-ineffective configuration includes a forwardly displacement of the second connection system counterpart 158 of the first connection system 32.

In some embodiments, for example, the forwardly displacement of the second connection system counterpart 158 of the first connection system 32, for transitioning of the interacting portion 60 from the interference-effective configuration to the interference-ineffective configuration, includes a displacement of the second connection system counterpart 158 of the first connection system 32 by a distance of at least 0.030 inches in a forwardly direction.

In some embodiments, for example, the transition of the interacting portion 60 from the interference-effective configuration to the interference-ineffective configuration includes rotation of the interacting portion 60 about the joint 153, as depicted in FIG. 3. In some embodiments, for example, the angle of rotation of the covering portion 60 from the interference-effective configuration to the interference-ineffective configuration has a minimum value of at least 3 degrees.

In some embodiments, for example, the interacting portion 60 is urged by a bias to the pre-deformation configuration. In some embodiments, for example, the bias is a material bias of the interacting portion 60. In some embodiments, for example, the bias of the interacting portion 60 is effected by the extension of the interacting portion 60 towards the central longitudinal axis 1001 of the panel 100 while there is an absence of connection between the panel 100 and another panel 100. In this respect, in some embodiments, for example, the interacting portion 154 is resilient.

In some embodiments, for example, the interacting portion 60 is resiliently deformable or resiliently displaceable between: 1) the pre-deformation configuration, 2) the interference effective configuration, and 3) the interference ineffective configuration.

In some embodiments, for example, the interacting portion 60 is transitionable between two of: 1) the pre-deformation configuration, 2) the interference effective configuration, and 3) the interference ineffective configuration. In some embodiments, for example, the interacting portion 60 is resiliently deformable or resiliently displaceable between two of: 1) the pre-deformation configuration, 2) the interference effective configuration, and 3) the interference ineffective configuration.

In some embodiments, for example, the second connection system counterpart configuration 50 includes a second connection system counterpart 160 of the second connection system 34. The second connection system counterpart 160 of the second connection system 34 includes a wall member 161 disposed rearwardly of the interacting portion 60. As depicted in FIG. 3, the second connection system counterpart 160 of the second connection system 34 has a square cross-section. In some embodiments, for example, the second connection system counterpart 160 of the second connection system 34 is defined by the member 161, wherein the member 161 is extending from the rear facing wall 16. The second connection system counterpart 160 of the second connection system 34 of the panel 100 is configured to be received in the recess 126 of the panel-defined configuration 20 of the adjacent panel 100 to effect the connection between the panel 100 and the adjacent panel 100. As described in greater detail herein, the second connection system counterpart 160 of the panel 100 and the projection 114 of the adjacent panel 110 are co-operatively configured such that, while the panel 100 and the adjacent panel 100 are connected, displacement of the panel 100, relative to the adjacent panel 100, in a direction that is parallel to a normal axis of a wall 1, on which the panel 100 and the adjacent panel 100 are disposed in abutting relationship, is resisted.

As depicted in FIG. 3, the panel defined configuration 40 includes an intermediate wall 162. The intermediate wall 162 is disposed intermediate the front facing wall 14 and the rear facing wall 16. The intermediate wall 162 is connected to the front facing wall 14 at the joint 153, and extends from the joint 153. In some embodiments, for example, the intermediate wall 162 extends from the joint 153 to the wall member 161. In some embodiments, for example, the intermediate wall 162 and the residual front facing wall portion 15 are disposed in a perpendicular relationship. In some embodiments, for example, while the panel 100 is connected to an adjacent panel via the first connection system counterpart configuration 30 and the second connection system counterpart configuration 50, the intermediate wall 162 and the front facing wall 14 are disposed in a perpendicular relationship. In some embodiments, for example, while the panel 100 is connected to an adjacent panel via the first connection system counterpart configuration 30 and the second connection system counterpart configuration 50, the intermediate wall 162 and the covering portion 154 are disposed in a perpendicular relationship. In some embodiments, for example, the intermediate wall 162 and the wall member 161 are disposed in a perpendicular relationship.

In some embodiments, for example, the panel-define configuration 40 includes a recess 164. The recess 164 of the panel 100 is configured to receive the projection 114 of the adjacent panel 100 for connecting the panel 100 and the adjacent panel 100. The recess 164 is defined by: 1) an inner surface 60A of the interacting portion 60, an inner surface 1611 of the wall member 161, and 3) the intermediate wall 162, for example, an intermediate wall surface 1621 of the intermediate wall 162. The recess 164 is disposed intermediate the front facing wall 14 and the rear facing wall 16.

In some embodiments, for example, the panel 100 is configured for defining a first panel 100 which is connectible with a second panel 100, for example, via the first connection system counterpart configuration 30 of the first panel 100 and the second connection system counterpart configuration 50 of the second panel 100. The connection of the first and second panels is effected by: 1) snap fit engagement between the first connection system counterpart 110 (e.g. the notch 124) of the first connection system 32, of the first panel 100, and the second connection system counterpart 158 (e.g. the rearward projection 158) of the first connection system 32, of the second panel 100, and 2) disposition of the first connection system counterpart 114 (e.g. the projection 114) of the second connection system 34, of the first panel 100, in the recess 164 of the second panel 100, and disposition of the second connection system counterpart 160 of the second connection system 34, of the second panel 100, in the recess 126 of the first panel 100, such that the first connection system counterpart 114 (e.g. the projection 114) of the second connection system 34, of the first panel 100, is disposed forwardly of the second connection system counterpart 114 (e.g. the projection 114) of the second connection system 34, of the second panel 100.

In some embodiments, for example, the snap-fit engagement between the first connection system counterpart 110 (e.g. the notch 124) of the first connection system 32, of the first panel 100, and the second connection system counterpart 158 (e.g. the rearward projection 158) of the first connection system 32, of the second panel 100 is effected by the displacement of the interacting portion 60 from the interference ineffective configuration to the interference effective configuration.

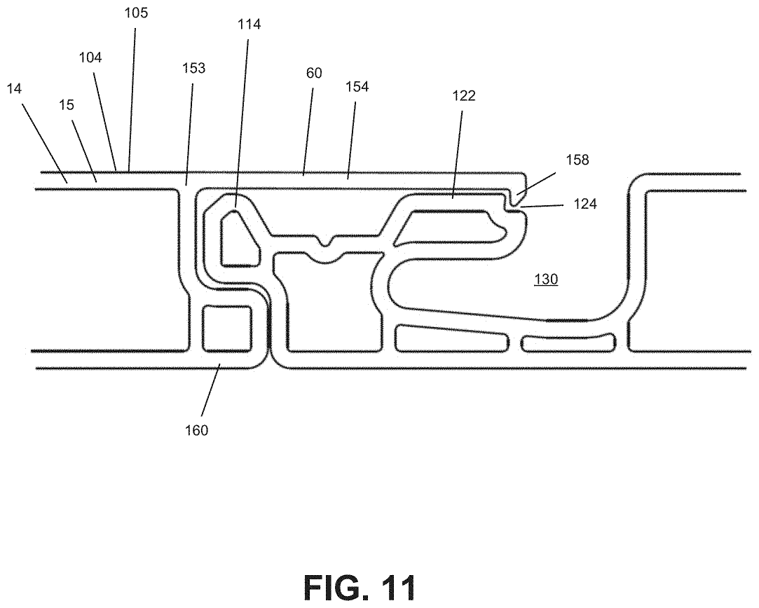

In some embodiments, for example, while the first and second panels are connected, the first connection system counterpart 110 (e.g. the notch 124) of the first connection system 32, of the first panel 100, and the second connection system counterpart 158 (e.g. the rearward projection 158) of the first connection system 32, of the second panel 100 are configured for disposition in a relative movement interference relationship, as depicted in FIG. 11, wherein, in the relative movement interference relationship: 1) the interacting portion 60 is disposed in the interference-effective configuration, as depicted in FIG. 7, and 2) the first connection system counterpart 110 (e.g. the notch 124) of the first connection system 32, of the first panel 100, and the second connection system counterpart 158 (e.g. the rearward projection 158) of the first connection system 32, of the second panel 100 are co-operatively configured such that displacement of the second panel 100, away from to the first panel 100, in a direction that is perpendicular to a normal axis of the front-facing wall of the second panel, is resisted (e.g. the notch 124 and the projection 158 co-operate to resist pulling apart of the first and second panels), such that defeating of the connection of the first and second panels is resisted. In this respect, in some embodiments, for example, the snap fit connection between the first connection system counterpart 110 (e.g. the notch 124) of the first connection system 32, of the first panel 100, and the second connection system counterpart 158 (e.g. the rearward projection 158) of the first connection system 32, of the second panel 100 is with effect that displacement of the second panel 100, away from to the first panel 100, in a direction that is perpendicular to a normal axis of the front-facing wall of the second panel, is resisted.

In some embodiments, for example, while the first and second panels are connected, and the panels are abutting against a wall 1, the first connection system counterpart 110 (e.g. the notch 124) of the first connection system 32, of the first panel 100, and the second connection system counterpart 158 (e.g. the rearward projection 158) of the first connection system 32, of the second panel 100 are configured for disposition in a relative movement interference relationship, wherein, in the relative movement interference relationship: 1) the interacting portion 60 is disposed in the interference-effective configuration, as depicted in FIG. 7, and 2) the first connection system counterpart 110 (e.g. the notch 124) of the first connection system 32, of the first panel 100, and the second connection system counterpart 158 (e.g. the rearward projection 158) of the first connection system 32, of the second panel 100 are co-operatively configured such that displacement of the second panel 100, away from to the first panel 100, within a plane that is parallel to the surface of the wall, is resisted, such that defeating of the connection of the first and second panels is resisted.

In some embodiments, for example, while the first and second panels are connected, and the first panel is secured to a wall 1, for example, by a fastener, the first connection system counterpart 110 (e.g. the notch 124) of the first connection system 32, of the first panel 100, and the second connection system counterpart 158 (e.g. the rearward projection 158) of the first connection system 32, of the second panel 100 are configured for disposition in a relative movement interference relationship, wherein, in the relative movement interference relationship: 1) the interacting portion 60 is disposed in the interference-effective configuration, as depicted in FIG. 7, and 2) the first connection system counterpart 110 (e.g. the notch 124) of the first connection system 32, of the first panel 100, and the second connection system counterpart 158 (e.g. the rearward projection 158) of the first connection system 32, of the second panel 100 are co-operatively configured such that displacement of the second panel 100, away from to the first panel 100, in a direction that is perpendicular to a normal axis of the surface of the wall, is resisted, such that defeating of the connection of the first and second panels is resisted.

In some embodiments, for example, while the first connection system counterpart 110 (e.g. the notch 124) of the first connection system 32, of the first panel 100, and the second connection system counterpart 158 (e.g. the rearward projection 158) of the first connection system 32, of the second panel 100 are disposed in the relative movement interference relationship, the second connection system counterpart 158 (e.g. the rearward projection 158) of the first connection system 32, of the second panel 100, is received in the first connection system counterpart 110 (e.g. the notch 124) of the first connection system 32, of the first panel 100, such that the interference, to relative movement, between the first and second panels, is established, and that defeating of the connection of the first and second panels is resisted.

In some embodiments, for example, while the first connection system counterpart 110 (e.g. the notch 124) of the first connection system 32, of the first panel 100, and the second connection system counterpart 158 (e.g. the rearward projection 158) of the first connection system 32, of the second panel 100 are disposed in the relative movement interference relationship, the second connection system counterpart 158 (e.g. the rearward projection 158) of the first connection system 32, of the second panel 100 is engaging the first connection system counterpart 110 (e.g. the notch 124) of the first connection system 32, of the first panel 100, such that the interference, to relative movement, between the first and second panels, is established, and that defeating of the connection of the first and second panels is resisted.

In some embodiments, for example, while the first connection system counterpart 110 (e.g. the notch 124) of the first connection system 32, of the first panel 100, and the second connection system counterpart 158 (e.g. the rearward projection 158) of the first connection system 32, of the second panel 100 are disposed in the relative movement interference relationship, the second connection system counterpart 158 (e.g. the rearward projection 158) of the first connection system 32, of the second panel 100 is bearing against the first connection system counterpart 110 (e.g. the notch 124) of the first connection system 32, of the first panel 100, such that the interference, to relative movement, between the first and second panels, is established, and that defeating of the connection of the first and second panels is resisted.

In some embodiments, for example, the bias of the interacting portion 60 resists defeating of the relative movement interference relationship between the first connection system counterpart 110 (e.g. the notch 124) of the first connection system 32, of the first panel 100, and the second connection system counterpart 158 (e.g. the rearward projection 158) of the first connection system 32, of the second panel 100.

In some embodiments, for example, while the first and second panels are connected, the first connection system counterpart 114 (e.g. the projection 114) of the second connection system 34, of the first panel 100, and the second connection system counterpart 160, for example, the wall member 161, of the second connection system 34, of the second panel 100, are configured for disposition in a relative movement interference relationship, as depicted in FIG. 11, wherein, in the relative movement interference relationship, the first connection system counterpart 114 (e.g. the projection 114) of the second connection system 34, of the first panel 100, and the second connection system counterpart 160, for example, the wall member 161, of the second connection system 34, of the second panel 100, are co-operatively configured such that displacement of the second panel 100, away from to the first panel 100, in a direction that is parallel to a normal axis of the front-facing wall 104 of the second panel, is resisted (e.g. the projection 114 and the wall member 161 co-operate to resist lifting of the second panel away from the first panel), such that defeating of the connection of the first and second panels is resisted.

In some embodiments, for example, while the first and second panels are connected, and the panels are abutting against a wall 1, the first connection system counterpart 114 (e.g. the projection 114) of the second connection system 34, of the first panel 100, and the second connection system counterpart 160, for example, the wall member 161, of the second connection system 34, of the second panel 100, are configured for disposition in a relative movement interference relationship, wherein, in the relative movement interference relationship, the first connection system counterpart 114 (e.g. the projection 114) of the second connection system 34, of the first panel 100, and the second connection system counterpart 160, for example, the wall member 161, of the second connection system 34, of the second panel 100, are co-operatively configured such that displacement of the second panel 100, away from to the first panel 100, within a plane that is perpendicular to the surface of the wall, is resisted, such that defeating of the connection of the first and second panels is resisted.

In some embodiments, for example, while the first and second panels are connected, and the and the first panel is secured to a wall 1, for example, by a fastener, the first connection system counterpart 114 (e.g. the projection 114) of the second connection system 34, of the first panel 100, and the second connection system counterpart 160, for example, the wall member 161, of the second connection system 34, of the second panel 100 are configured for disposition in a relative movement interference relationship, wherein, in the relative movement interference relationship, the first connection system counterpart 114 (e.g. the projection 114) of the second connection system 34, of the first panel 100, and the second connection system counterpart 160, for example, the wall member 161, of the second connection system 34, of the second panel 100 are co-operatively configured such that displacement of the second panel 100, away from to the first panel 100, in a direction that is parallel to a normal axis of the surface of the wall, is resisted, such that defeating of the connection of the first and second panels is resisted.

In some embodiments, for example, while the first panel 100 is connected to the second panel 100, the projection 114 of the first panel is received in the recess 164 of the second panel 100, and the second connection system counterpart 160 of the second connection system 34 of the second panel 100 is received in the recess 126 of the first panel 100. In some embodiments, for example, while the projection 114 is received in the recess 164, the shoulder 114 is disposed in opposing relationship with the intermediate wall 162, the covering portion 154, and the second connection system counterpart 160 of the second connection system 34.

In some embodiments, for example, while the projection 114 is received in the recess 164, the intermediate wall 162 is configured to resist relative displacement of the first connection system counterpart configuration 30 of the first panel 100 and the second connection system counterpart configuration 50 of the second panel 100 towards each other, with effect that defeating of the connection of the connected first panel 100 and the second panel 100 is resisted.

In some embodiments, for example, while the projection 114 is received in the recess 164, the covering portion 154 is disposed forwardly of the projection 114, and is configured to resist displacement of the first connection system counterpart configuration 30 of the first panel 100, relative to the second connection system counterpart configuration 50 of the second panel 100, in a direction perpendicular to the outermost surface 104 of the first panel 100, with effect that defeating of the connection of the connected first panel 100 and the second panel 100 is resisted.

In some embodiments, for example, while the projection 114 is received in the recess 164, the second connection system counterpart 160 of the second connection system 34 of the second panel 100 is disposed rearwardly of the projection 114, and is configured to resist displacement of the first connection system counterpart configuration 30 of the first panel 100, relative to the second connection system counterpart configuration 50 of the second panel 100, away from covering portion 154, in a direction perpendicular to the wall-opposing surface 106, with effect that defeating of the connection of the connected first panel 100 and the second panel 100 is resisted.

In some embodiments, for example, while the second connection system counterpart 160 of the second connection system 34 of the second panel 100 is received in the recess 126 of the first panel 100, the second connection system 34 of the second panel 100 is disposed in opposing relationship with the fastener receiving portion 116 of the first panel 100, and co-operate to resist relative displacement of the first panel 100 and the second panel 100 towards each other, with effect that defeating of the connection of the connected first panel 100 and the second panel 100 is resisted.

In some embodiments, for example, while the first panel 100 is connected to the second panel 100, the second connection system counterpart 160 of the second connection system 34 of the second panel 100 is disposed in abutting relationship with the fastener receiving portion 116 of the first panel 100.

In some embodiments, for example, while the first and second panels are connected, the first connection system counterpart 110 (e.g. the notch 124) of the first connection system 32, of the first panel 100, the second connection system counterpart 158 (e.g. the rearward projection 158) of the first connection system 32, of the second panel 100, the first connection system counterpart 114 (e.g. the projection 114) of the second connection system 34, of the first panel 100, and the second connection system counterpart 160, for example, the wall member 161, of the second connection system 34, of the second panel 100 are configured for disposition in a relative movement interference relationship, as depicted in FIG. 11, wherein, in the relative movement interference relationship: 1) the interacting portion 60 is disposed in the interference-effective configuration, and the first connection system counterpart 110 (e.g. the notch 124) of the first connection system 32, of the first panel 100, and the second connection system counterpart 158 (e.g. the rearward projection 158) of the first connection system 32, of the second panel 100 are co-operatively configured such that displacement of the second panel 100, away from to the first panel 100, in a direction that is perpendicular to a normal axis of the front-facing wall of the second panel, is resisted (e.g. the notch 124 and the projection 158 co-operate to resist pulling apart of the first and second panels), and 2) the first connection system counterpart 114 (e.g. the projection 114) of the second connection system 34, of the first panel 100, and the second connection system counterpart 160, for example, the wall member 161, of the second connection system 34, of the second panel 100 are co-operatively configured such that displacement of the second panel 100, away from to the first panel 100, in a direction that is parallel to a normal axis of the front-facing wall 104 of the second panel, is resisted (e.g. the projection 114 and the wall member 161 co-operate to resist lifting of the second panel away from the first panel), such that defeating of the connection of the first and second panels is resisted.

In some embodiments, for example, while the first and second panels are connected, and the panels are abutting against a wall 1, the first connection system counterpart 110 (e.g. the notch 124) of the first connection system 32, of the first panel 100, the second connection system counterpart 158 (e.g. the rearward projection 158) of the first connection system 32, of the second panel 100, the first connection system counterpart 114 (e.g. the projection 114) of the second connection system 34, of the first panel 100, and the second connection system counterpart 160, for example, the wall member 161, of the second connection system 34, of the second panel 100 are configured for disposition in a relative movement interference relationship, wherein, in the relative movement interference relationship: 1) the interacting portion 60 is disposed in the interference-effective configuration, and the first connection system counterpart 110 (e.g. the notch 124) of the first connection system 32, of the first panel 100, and the second connection system counterpart 158 (e.g. the rearward projection 158) of the first connection system 32, of the second panel 100 are co-operatively configured such that displacement of the second panel 100, away from to the first panel 100, within a plane that is parallel to the surface of the wall, is resisted, and 2) the first connection system counterpart 114 (e.g. the projection 114) of the second connection system 34, of the first panel 100, and the second connection system counterpart 160, for example, the wall member 161, of the second connection system 34, of the second panel 100 are co-operatively configured such that displacement of the second panel 100, away from to the first panel 100, within a plane that is perpendicular to the surface of the wall, is resisted, such that defeating of the connection of the first and second panels is resisted.

In some embodiments, for example, while the first and second panels are connected, and the first panel is secured to a wall 1, for example, by a fastener, the first connection system counterpart 110 (e.g. the notch 124) of the first connection system 32, of the first panel 100, the second connection system counterpart 158 (e.g. the rearward projection 158) of the first connection system 32, of the second panel 100, the first connection system counterpart 114 (e.g. the projection 114) of the second connection system 34, of the first panel 100, and the second connection system counterpart 160, for example, the wall member 161, of the second connection system 34, of the second panel 100 are configured for disposition in a relative movement interference relationship, wherein, in the relative movement interference relationship: 1) the interacting portion 60 is disposed in the interference-effective configuration, and the first connection system counterpart 110 (e.g. the notch 124) of the first connection system 32, of the first panel 100, and the second connection system counterpart 158 (e.g. the rearward projection 158) of the first connection system 32, of the second panel 100 are co-operatively configured such that displacement of the second panel 100, away from to the first panel 100, in a direction that is perpendicular to a normal axis of the surface of the wall, is resisted, and 2) the first connection system counterpart 114 (e.g. the projection 114) of the second connection system 34, of the first panel 100, and the second connection system counterpart 160, for example, the wall member 161, of the second connection system 34, of the second panel 100 are co-operatively configured such that displacement of the second panel 100, away from to the first panel 100, in a direction that is parallel to a normal axis of the surface of the wall, is resisted, such that defeating of the connection of the first and second panels is resisted.

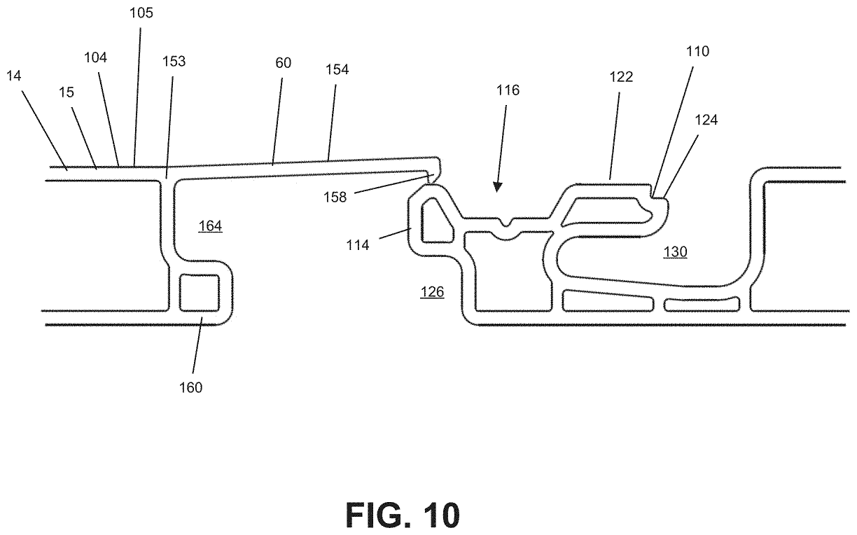

In some embodiments, for example, the first panel 100 and the second panel 100 are co-operable such that the first connection system counterpart 110 (e.g. the notch 124) of the first connection system 32, of the first panel 100, and the second connection system counterpart 158 (e.g. the rearward projection 158) of the first connection system 32, of the second panel 100 are configured for disposition in a relative movement effectible relationship, as depicted in FIG. 10. In the relative movement effectible relationship, the interacting portion 60 is disposed in the interference-ineffective configuration, as depicted in FIG. 8, and there is an absence of interference, to relative movement, between the first and second panels. In some embodiments, for example, the absence of the interference, to relative movement, between the first panel and the second panel, is the absence of interference, to relative movement, of the second panel, relative to the first panel, in a direction that is perpendicular to a normal axis of the front-facing wall 104 and away from the first panel.

In some embodiments, for example, while the first and second panels are abutting against a wall 1, and the first connection system counterpart 110 (e.g. the notch 124) of the first connection system 32, of the first panel 100, and the second connection system counterpart 158 (e.g. the rearward projection 158) of the first connection system 32, of the second panel 100 are configured for disposition in the relative movement effectible relationship, the absence of the interference, to relative movement, between the first panel and the second panel, is the absence of interference, to relative movement, of the second panel, relative to the first panel, within a plane that is parallel to the surface of the wall and away from the first panel.

In some embodiments, for example, while the first and second panels are abutting against a wall 1, and the first connection system counterpart 110 (e.g. the notch 124) of the first connection system 32, of the first panel 100, and the second connection system counterpart 158 (e.g. the rearward projection 158) of the first connection system 32, of the second panel 100 are configured for disposition in the relative movement effectible relationship, the absence of the interference, to relative movement, between the first panel and the second panel, is the absence of interference, to relative movement, of the second panel, relative to the first panel, in a direction that is perpendicular to a normal axis of the surface of the wall and away from the first panel.

In some embodiments, for example, the first connection system counterpart 110 (e.g. the notch 124) of the first connection system 32, of the first panel 100, and the second connection system counterpart 158 (e.g. the rearward projection 158) of the first connection system 32, of the second panel 100 are disposed in a relative movement effectible relationship, as depicted in FIG. 10, while: 1) the first and second panels are being displaced towards each other to effect the connection between the first and second panels, or 2) the first and second panels are being displaced away from each other to defeat the connection between connected first and second panels.

In some embodiments, for example, the transition of the first connection system counterpart 110 (e.g. the notch 124) of the first connection system 32, of the first panel 100, and the second connection system counterpart 158 (e.g. the rearward projection 158) of the first connection system 32, of the second panel 100 from the relative movement interference relationship to the relative movement effectible relationship is effected by transitioning of the interacting portion 60 from the interference-effective configuration to the interference-ineffective configuration. In some embodiments, for example, the transitioning of the interacting portion 60 from the interference-effective configuration to the interference-ineffective configuration is with effect that the interference, to relative movement, between the first panel and the second panel, is defeated (e.g. the interference to pulling the first and second panels away from each other is defeated).

In some embodiments, for example, while the first panel 100 is connected to the second panel 100 via the first connection system counterpart configuration 30 of the first panel 100 and the second connection system counterpart configuration 50 of the second panel 100, the covering portion 154 of the second panel 100 conceals at least a portion of the first connection system counterpart configuration 30 of the first panel 100. In some embodiments, for example, while the first panel 100 is connected to the second panel 100 via the first connection system counterpart configuration 30 of the first panel 100 and the second connection system counterpart configuration 50 of the second panel 100, the covering portion 154 of the second panel 100 conceals the entirety of the first connection system counterpart configuration 30 of the first panel 100. In some embodiments, for example, while the first panel 100 is connected to the second panel 100 via the first connection system counterpart configuration 30 of the first panel 100 and the second connection system counterpart configuration 50 of the second panel 100, the covering portion 154 of the second panel 100 conceals the fastener-receiving portion 116 of the first panel 100, such that a fastener extending through the fastener-receiving portion 116 for securing the first panel 100 to a wall 1 is concealed by the covering portion 154. Such concealment of the of the first connection system counterpart configuration 30, the fastener-receiving portion 116, and the fastener extending through the fastener-receiving portion 116, provides an aesthetically pleasing appearance to the connected first panel 100 and second panel 100.

In some embodiments, for example, while the first connection system counterpart 110 (e.g. the notch 124) of the first connection system 32, of the first panel 100, and the second connection system counterpart 158 (e.g. the rearward projection 158) of the first connection system 32, of the second panel 100 are disposed in the relative movement interference relationship, and the first panel 100 is connected to a wall with a fastener, the covering portion 154 of the second panel 100 is covering the fastener.

In some embodiments, for example, while the first connection system counterpart 110 (e.g. the notch 124) of the first connection system 32, of the first panel 100, the second connection system counterpart 158 (e.g. the rearward projection 158) of the first connection system 32, of the second panel 100, the first connection system counterpart 114 (e.g. the projection 114) of the second connection system 34, of the first panel 100, and the second connection system counterpart 160, for example, the wall member 161, of the second connection system 34, of the second panel 100 are disposed in the relative movement interference relationship, and the first panel 100 is connected to a wall with a fastener, the covering portion 154 of the second panel 100 is covering the fastener.

In some embodiments, for example, while the first panel 100 and the second panel 100 are connected together, and while at least one of the first and second panels is connected to the wall 1, for example, via a fastener, the visible portion of the outermost surface 156 of the covering portion 154 is parallel to the surface of the wall 1 on which the connected first panel 100 and second panel 100 is mounted.

In some embodiments, for example, the visible surfaces of the wall covering portion 12 and the covering portion 154 of the second panel 100 are co-planar when the first and second panels are connected to provide an aesthetically pleasing appearance.

In some embodiments, for example, to connect the first and second panels via the first connection system counterpart configuration 30 of the first panel 100 and the second connection system counterpart configuration 50 of the second panel 100, the second connection system counterpart 158 (e.g. the rearward projection 158) of the first connection system counterpart 32, of the second panel 100, is to be displaced past the first connection system counterpart 114 (e.g. the projection 114) of the second connection system 34, of the first panel 100, to effect: 1) snap fit engagement between the first connection system counterpart 110 (e.g. the notch 124) of the first connection system 32, of the first panel 100, and the second connection system counterpart 158 (e.g. the rearward projection 158) of the first connection system 32, of the second panel 100, and 2) disposition of the first connection system counterpart 114 (e.g. the projection 114) of the second connection system 34, of the first panel 100, in the recess 164 of the second panel 100, and disposition of the second connection system counterpart 160 of the second connection system 34, of the second panel 100, in the recess 126 of the first panel 100.

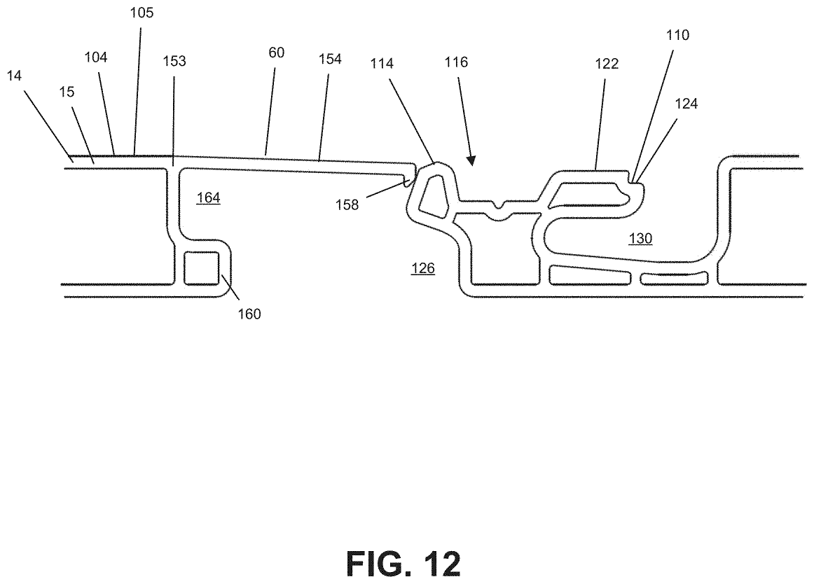

In this respect, in some embodiments, for example, the co-operability of the first and second panels is such that the projection 114 of the first panel 100 and the interacting portion 60 of the second panel 100 are configurable for disposition in a relative movement effectible relationship, as depicted in FIG. 10, and a relative movement interference relationship, as depicted in FIG. 12.

In the relative movement effectible relationship, the projection 114 of the first panel 100 is disposed in the relative movement-effective configuration, the interacting portion 60 of the second panel 100 is disposed in the interference-ineffective configuration, and the second panel 100 is displaceable towards the first panel 100, such that the second connection system counterpart 158 (e.g. the rearward projection 158) of the first connection system counterpart 32, of the second panel 100 is displaceable, past the projection 114 of the first panel 100 and towards the first connection system counterpart 110 (e.g. the notch 124) of the first connection system 32, of the first panel 100, for aligning the second connection system counterpart 158 (e.g. the rearward projection 158) and the first connection system counterpart 110 (e.g. the notch 124) of the first connection system 32, to effect the snap fit connection between the first connection system counterpart 110 (e.g. the notch 124) of the first connection system 32, of the first panel 100, and the second connection system counterpart 158 (e.g. the rearward projection 158) of the first connection system 32, of the second panel 100.

In the relative movement interference relationship, the projection 114 of the first panel 100 is disposed in the connection-prevention configuration, and interference, to relative movement, of the second panel 100 towards the first panel 100, by the projection 114 of the first panel 100, is established, such that the displaceability of the second connection system counterpart 158 (e.g. the rearward projection 158) of the first connection system counterpart 32, of the second panel 100, past the projection 114 of the first panel and towards the first connection system counterpart 110 (e.g. the notch 124) of the first connection system 32, of the first panel 100, for aligning the second connection system counterpart 158 (e.g. the rearward projection 158) and the first connection system counterpart 110 (e.g. the notch 124) of the first connection system 32, to effect the snap fit connection between the first connection system counterpart 110 (e.g. the notch 124) of the first connection system 32, of the first panel 100, and the second connection system counterpart 158 (e.g. the rearward projection 158) of the first connection system 32, of the second panel 100, is resisted.

In some embodiments, for example, to couple the first panel 100 and the second panel 100 via the first connection system counterpart configuration 30 of the first panel 100 and the second connection system counterpart configuration 50 of the second panel 100, the first connection system counterpart configuration 30 of the first panel 100 and the second connection system counterpart configuration 50 of the second panel 100 are disposed in alignment. In some embodiments, for example, while the first connection system counterpart configuration 30 of the first panel 100 and the second connection system counterpart configuration 50 of the second panel 100 are disposed in alignment, the first connection system counterpart configuration 30 of the first panel 100 and the second connection system counterpart configuration 50 of the second panel 100 are disposed in opposing relationship. In some embodiments, for example, to align the first connection system counterpart configuration 30 of the first panel 100 and the second connection system counterpart configuration 50 of the second panel 100, the first and second panels are disposed in abutting engagement with a wall 1 and the first connection system counterpart configuration 30 of the first panel 100 and the second connection system counterpart configuration 50 of the second panel 100 are disposed in opposing relationship. At this point, the projection 114 of the first panel 100 is disposed in the relative movement-effective configuration, and the interacting portion 60 is disposed in the pre-deformation configuration. The first panel 100 and the second panel 100 are displaced towards each other, for example, the second panel 100 is displaced towards the first panel 100, until the interacting portion 60 of the second panel 100 becomes disposed in contact engagement with the the projection 114 of the first panel 100, for example, the urging surface 115 of the projection 114. In response to further displacement of the second panel 100 towards the first panel 100, a force is applied, by the interacting portion 60 of the second panel 100, to the projection 114 of the first panel. In response to the force, applied by the interacting portion 60 of the second panel 100 to the projection 114 of the first panel 100, a reaction force is applied by the projection 114, for example, the urging surface 115, of the first panel 100 to the interacting portion 60 of the second panel 100, the reaction force having a direction oriented away from the axis 1001, with effect that the interacting portion 60 of the second panel 100 is deformed or deflected, such that: 1) the interacting portion 60 of the second panel 100 is transitioned from the pre-deformation configuration to the interference-ineffective configuration, and 2) the projection 114 of the first panel 100 and the interacting portion 60 of the second panel 100 become disposed in the relative movement effective relationship. At this point, the second panel 100 continues to be displaced towards the first panel 100, such that the second connection system counterpart 158 (e.g. the rearward projection 158) of the first connection system 32, of the second panel 100, is displaced past the projection 114 of the first panel 110, until the second connection system counterpart 158 (e.g. the rearward projection 158) of the first connection system 32, of the second panel 100 becomes disposed in alignment with the first connection system counterpart 110 (e.g. the notch 124) of the first connection system 32, of the first panel 100. At this point, in response to the material bias of the interacting portion 60, the interacting portion is transitioned from the interference-ineffective configuration to the interference-effective configuration, and the and the projection 158 becomes disposed in the notch 124, to effect the snap fit engagement between the second connection system counterpart 158 (e.g. the rearward projection 158) of the first connection system 32, of the second panel 100, and the first connection system counterpart 110 (e.g. the notch 124) of the first connection system 32. Simultaneously, while the second connection system counterpart 158 (e.g. the rearward projection 158) of the first connection system 32, of the second panel 100, is displaced past the projection 114 of the first panel 110 and becomes disposed in the first connection system counterpart 110 (e.g. the notch 124) of the first connection system 32, of the first panel 100, the first connection system counterpart 114 (e.g. the projection 114) of the second connection system 34, of the first panel 100, becomes disposed in the recess 164 of the second panel 100, and the second connection system counterpart 160 of the second connection system 34, of the second panel 100, becomes disposed in the recess 126 of the first panel 100, thereby establishing connection between the first panel 100 and the second panel 100. Additional like panels can be, successively, added to this assembly, in similar manner, such that the wall panel assembly, established by the connection of the panels, is defined by disposition of the panels in adjacent relationship to one another, for example, in a vertical series. In this respect, each one of the panels of wall panel assembly, independently, is elongated and is defined by a longitudinal axis, such that the disposition of the wall panels in adjacent relationship to one another, in a vertical series, is such that, for each one of the walls panels, independently, the longitudinal axis is horizontally oriented.

In some embodiments, for example, the first panel 100 can be displaced towards the second panel 100 to effect the connection between the first and second panels, similar to the manner by which the second panel is displaced towards the first panel 100 to effect the connection between the first and second panels.

In some embodiments, for example, the first panel 100 is first connected to the wall 1 via a fastener configuration (e.g. one or more mechanical fasteners) that is penetrated through the fastener-receiving portion 116 of the first panel 100, and then the second panel 100 is connected to the first panel 100. Then, the second panel 100 is connected to the wall 1 via a fastener configuration that is penetrated through the fastener-receiving portion 116 of the second panel 100.

In some embodiments, for example, the first and second panels are connected via the via the second connection system counterpart configuration 50 of the first panel 100 and the first connection system counterpart configuration 30 of the second panel 100, similar to the manner by which the first and second panels are connected via the via the first connection system counterpart configuration 30 of the first panel 100 and the second connection system counterpart configuration 50 of the second panel 100.

In some embodiments, for example, to defeat or release the connection between connected first and second panels, the interacting portion 60 of the second panel 100 is transitioned from the interference-effective configuration to the interference-ineffective configuration. At this point, the second panel 100 is displaceable away from the first panel 100, within a plane that is parallel to the surface of the wall, to effect the defeating of the connection between the first and second panels.

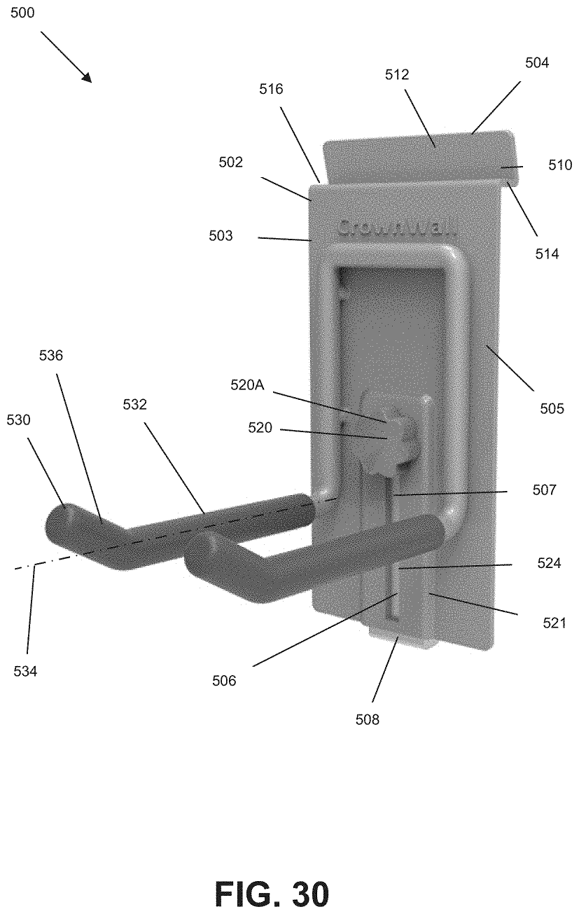

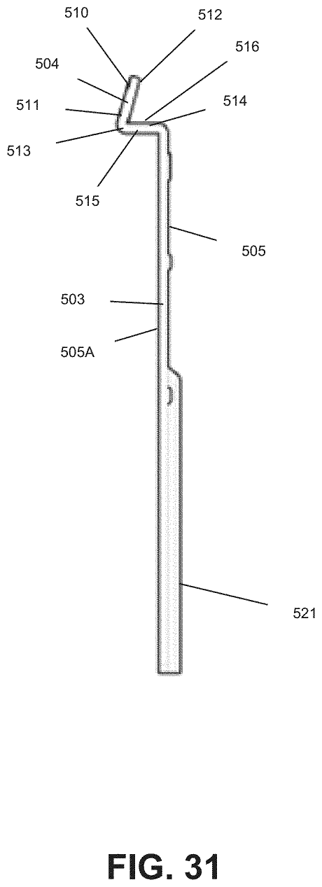

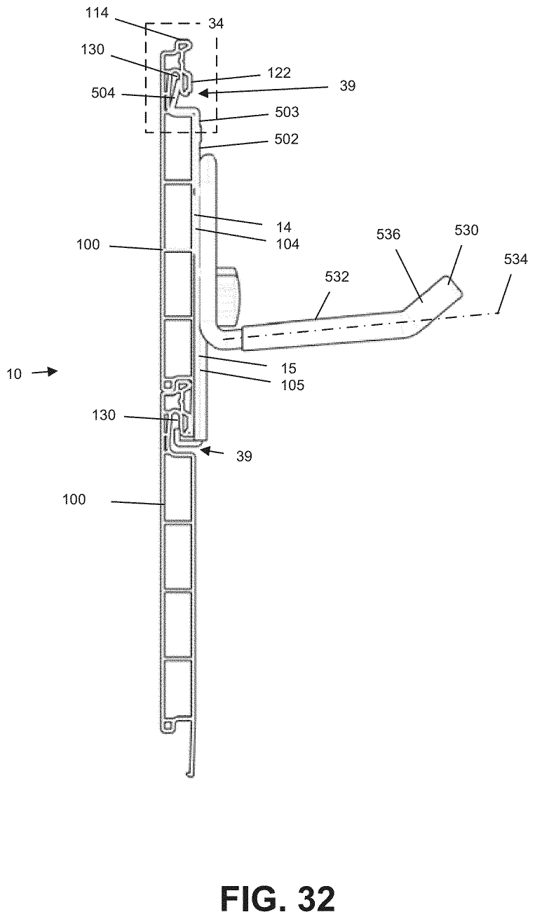

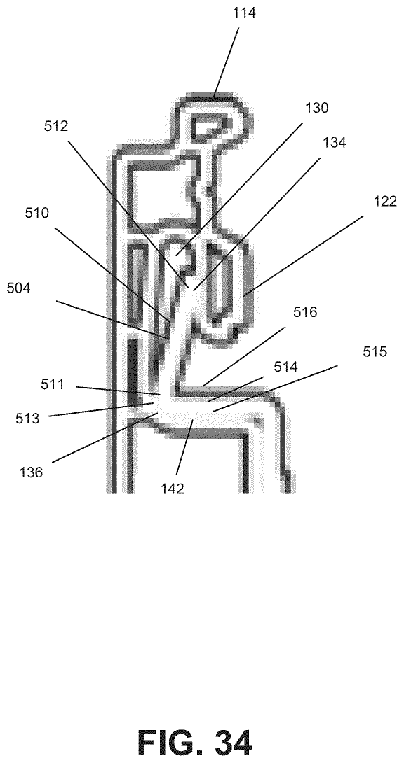

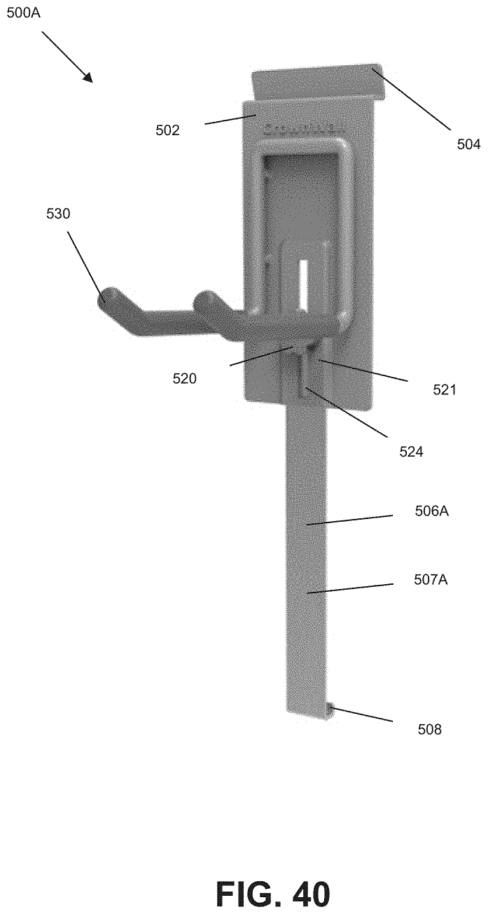

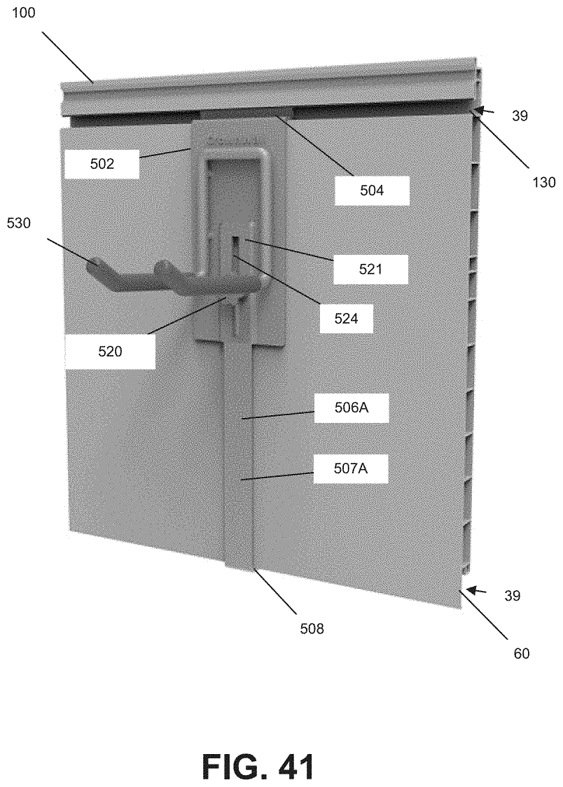

In some embodiments, for example, the panel 100 is configured to receive and retain a mounting bracket 502. The panel 100 defines a bracket connector receiving cavity 130, as depicted in FIG. 2, for receiving a bracket connector 504 of a mounting bracket 502, and for hanging of the mounting bracket from the panel 100, as depicted in FIG. 32 and FIG. 34. In some embodiments, for example, the cavity 130 is defined by a cavity defining surface 132. In some embodiments, for example, the cavity defining surface 132 includes the outer surface 72A of the first wall 72 of the rear wall configuration 70. In some embodiments, for example, the cavity defining surface 132 includes the retaining surface 134. An example of a mounting bracket 502, that is configured for hanging from, and retention to, the panel 100 or a wall panel assembly 10, is depicted in FIG. 30 to FIG. 41. The mounting bracket 502 includes the connector 504 that is configured to co-operate with the panel 100 for retention of the bracket 502 to the panel 100, for example, the first connection counterpart 504 as depicted in FIG. 30 to FIG. 35.

As depicted in FIG. 32, the cavity 130 and the retaining surface 134, defined by the retaining surface defining configuration 122 of the panel-defined configuration 20 at the first end 101, are co-operatively configured such that, while the panel 100 is secured to a wall 1, insertion of the bracket connector 504 into the cavity 130 is with effect that the bracket connector 504 is rotated, relative to the panel 100, with effect that a retained configuration is established. In the retained configuration: 1) the bracket 502 is vertically supported by the panel 100, and the retaining surface 134 is opposing displacement of the bracket 502, relative to the panel 100, away from the wall 1, for example, in a direction that is normal to the wall 1.

As depicted in FIG. 2, in some embodiments, for example, the cavity 130 is an L-shaped cavity.

In some embodiments, for example, the panel 100 comprises a guide surface 136. The guide surface 136 is configured to facilitate retention the bracket to the panel 100, for example, by facilitating rotation of the bracket connector relative to the panel 100 while the bracket connector is disposed in the cavity 130. In some embodiments, for example, as depicted in FIG. 2, the panel 100 includes a wall member 141 that extends rearwardly from the front facing wall 14, and connecting the front facing wall 14 and the first wall 72 of the rear wall configuration 70. The wall member 141 includes a wall portion 143 that has an arcuate wall surface 145. In some embodiments, for example, the guiding surface 136 is defined by the arcuate wall surface 145.

The cavity 130, the guide surface 136, and the retaining surface 134 are co-operatively configured such that, while the panel 100 is secured to the mounting wall 1 and the bracket connector 504 is being inserted into the cavity 130, the guide surface 136 engages the bracket connector 504 with effect that the connector 504 is rotated, relative to the panel 100, such that movement of the bracket connector 504, within the cavity 130, is directed, with effect that the retained configuration is established.

In some embodiments, for example, the bracket 500 is displaced towards the panel 100 to insert the bracket connector into the cavity 130.

In some embodiments, for example, the minimum rotation of the connector 504 effected by the guide surface 136 is at least 30 degrees.

In some embodiments, for example, while the connector 504 is engaged with the guide surface 136, in response to further displacement of the mounting bracket towards the panel 100, a force is applied by the guide surface 136 to the connector 504, with effect that the connector 504 is rotated, relative to the panel 100, such that movement of the bracket connector, within the cavity 130, is directed, with effect that the retained configuration is established.

In some embodiments, for example, the rotation of the connector 504, relative to the panel 100, that is effected by the guide surface 136, is such that movement of the bracket connector 504, within the cavity 130, is directed further into the cavity 130.

In some embodiments, for example, the guide surface 136 has an arcuate surface portion. The arcuate surface portion of the guide surface 136 has a minimum radius of curvature of at least 1/16 inches.

In some embodiments, for example, as depicted in FIG. 2, the cavity 130 is defined by the cavity-defining surface 132, and the cavity-defining surface 132 includes the guide surface 136.

In some embodiments, for example, the cavity-defining surface 132 includes an end surface 138 (defined by the outermost surface 72A of the first wall 72 of the rear wall configuration 70), a rounded surface 140 extending between the retaining surface 134 and the end surface 138, and a supporting surface 142.

In some embodiments, for example, the rounded surface 140 is disposed between the retaining surface 134 and the end surface 138, to facilitate extrusion of the panel 100 and to improve strength of the cavity 130. In some embodiments, for example, the rounded surface 140 has a minimum radius of curvature of at least 1/16 inches.

In some embodiments, for example, the supporting surface 142 is configured to vertically support the bracket while the bracket connector is disposed in the cavity 130. In some embodiments, for example, the supporting surface 142 is defined by the outer surface of the wall member 141. In some embodiments, for example, while the panel 100 is connected to the wall and the bracket is retained to the panel 100, the bracket connector 504 is engaged with the supporting surface 142, for example, seated against the supporting surface 142, while the supporting surface 142 is vertically supporting the bracket.

In some embodiments, for example, the end surface 138 is angled relative to the supporting surface 142, for example, to facilitate extrusion of the panel 100, and to increase strength of the cavity 130. The end surface 138 defines a perpendicular axis 138A, the supporting surface defines a perpendicular axis 142A, and the acute angle defined between the perpendicular axis 138A and the perpendicular axis 142A has a maximum value of 87 degrees.

In some embodiments, for example, the cavity 130 includes a counterpart receiving portion 144 and a counterpart retaining portion 146. The counterpart-receiving portion 144 is configured to receive the bracket connector 504, and to enable rotation of the bracket while the bracket connector 504 is disposed in the counterpart-receiving portion 144. In some embodiments, for example, the counterpart-receiving portion 144 is defined by at least a portion of the end surface 138, the guide surface 136, and the supporting surface 142. The counterpart-retaining portion 146 is configured to retain the mounting bracket 502 to the panel 100 while the bracket connector 504 is disposed in the counterpart-retaining portion 146. In some embodiments, for example, the counterpart-retaining portion 146 is defined by at least a portion of the end surface 138, the rounded surface 140, and the retaining surface 134. While the bracket connector 504 is disposed in the counterpart-retaining portion 146, the bracket connector 504 is bearing against the guiding surface 136 and the retaining surface 134, as depicted in FIG. 34, such that the tolerance between the bracket connector 504, the end surface 138, the rounded surface 140, and the retaining surface 134 is such that displacement of the bracket connector 504, and thus, the bracket 502, is substantially limited. The substantially limited displacement of the bracket connector 504, and thus, the bracket 502, results in less wear and tear on the bracket 502, and less displacement of a load that is supported by the bracket.

In some embodiments, for example, the counterpart-receiving portion 144 is wider than the counterpart-retaining portion 146, such that the bracket connector 504 is rotatable while disposed in the counterpart-receiving portion 144, and that displacement of the bracket connector 504 is limited, such that the bracket connector 504 is retainable to the panel 100, while disposed in the counterpart-retaining portion 146.

In some embodiments, for example, the spacing distance between the rounded surface 140 and the supporting surface 142 is such that the bracket connector is receivable and retainable in the cavity 130. In some embodiments, for example, the minimum spacing distance between the rounded surface 140 and the supporting surface 142 is at least ⅝ inches.

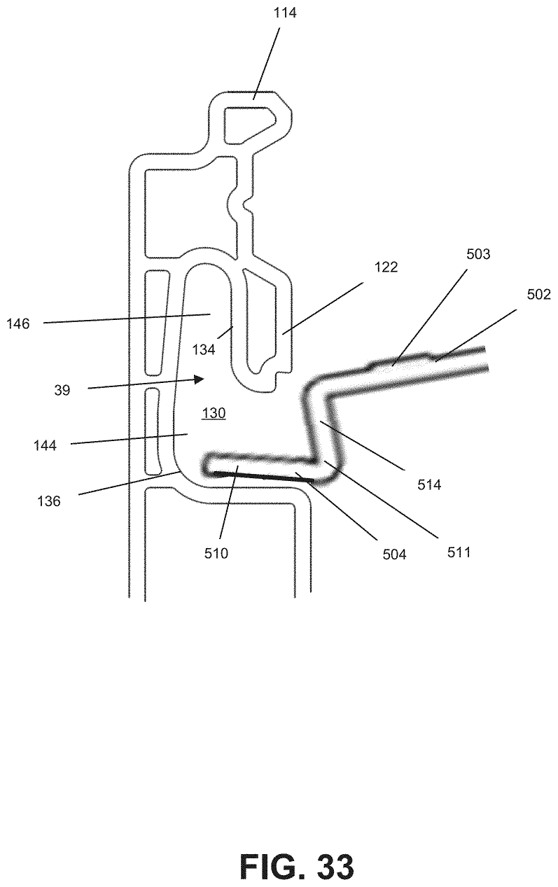

To retain the bracket to the panel 100, the bracket connector 504 is inserted into the counterpart-receiving portion 144 of the cavity 130, as depicted in FIG. 33. In some embodiments, for example, the direction of insertion of the bracket connector 504 into the counterpart-receiving portion 144 is parallel to the perpendicular axis of the outermost surface 104. The bracket connector 504 is displaced further into the counterpart-receiving portion 144 until the bracket connector 504 is engaged with the guide surface 136, as depicted in FIG. 33. In response to a force applied to the bracket connector 504 to further displace the bracket connector 504 into the counterpart-receiving portion 144, the guide surface 136 applies a reaction force to the bracket connector 504, with effect that the connector 504 is rotated relative to the panel 100, such that the connector 504 is disposed further in the cavity 130, for example, in the counterpart retaining portion 146, and disposed in opposing relationship to the retaining surface 134. At this point, the bracket 502 is disposed in the retained configuration, as depicted in FIG. 32 and FIG. 34. In some embodiments, for example, at this point, the bracket 502 is hanging from the panel 100. In some embodiments, for example, the retaining and hanging of the bracket 502 from the panel 100 is effected without the use of fasteners, for example, mechanical fasteners. In some embodiments, for example, while the bracket 502 is hung from the panel 100, the bracket is vertically supported by the panel 100, and displacement of the bracket, relative to the panel 100, in a direction that is normal to the an outermost surface of the panel 100, is opposed.

To release the bracket 502 from retention of the panel 100, the bracket connector 504 is rotated in a direction opposite the direction for retaining the bracket 502 to the panel 100, such that there is an absence of disposition of the bracket connector 504 in opposing relationship to the retaining surface 134. At this point, the bracket connector 504 is displaced away from the panel 100 until the bracket connector 504 is disposed outside the cavity 130.

In some embodiments, for example, the structure of the cavity 130 is configured such that the panel 100 is able to support a heavier load that is mounted to a bracket 502 that is retained to the panel 100 via the cavity 130. In this respect, the load bearing capacity of the cavity 130 is increased.

In some embodiments, for example, as depicted in FIG. 2, to increase the load bearing capacity of the cavity 130, the panel 100 includes a wall member 141 that extends rearwardly from the front facing wall 14, and connecting the front facing wall 14 and the first wall 72 of the rear wall configuration 70. The wall member 141 includes a wall portion 143 that has an arcuate wall surface 145. The arcuate wall surface 145 has a radius of curvature having a minimum value of at least 1/16 inches. In some embodiments, for example the cavity defining surface 132 includes the arcuate wall surface 145 of the wall member 141.

In some embodiments, for example, while the retained configuration is established, in response to mounting of a load to the bracket 502, a displacement-urging force is applied by the bracket connector 504 to the retaining surface 134, with effect that rotation of a rotation-urgable portion of the panel 100, in a direction away from the rear facing wall 16, is urged. In some embodiments, for example, the rotation of a rotation-urgable portion of the panel 100, in a direction away from the rear facing wall 16, is resisted, by the wall portion 143. In some embodiments, for example, the resistance to the rotation of a rotation-urgable portion of the panel 100, in a direction away from the rear facing wall 16, is due to the arcuate wall surface 145 having a radius of curvature having a minimum value of at least 1/16 inches.

In some embodiments, for example, the rotation-urgable portion includes the retaining surface defining configuration 122.

In some embodiments, for example, the displacement-urging force has a maximum value of 300 pounds. In some embodiments, for example, the displacement-urging force has a maximum value of 300 pounds per linear foot of the panel 100 (e.g. measured along the axis 2).

In some embodiments, for example, as depicted in FIG. 2, to increase the load bearing capacity of the cavity 130, the first wall 72 and the second wall 74 of the rear wall configuration 70 are configured such that the first wall 72 and the second wall 74 are disposed in a non-parallel relationship.

In some embodiments, for example, while the retained configuration is established, in response to mounting of a load to the bracket 502, a displacement-urging force is applied by the bracket connector 504 to the retaining surface 134, with effect that displacement of the retaining surface-defining configuration 122, in the direction away from the mounting wall, is urged, In some embodiments, for example, the first wall 72 and the second wall 74 of the rear wall configuration 70 are co-operatively configured such that the displacement of the retaining surface-defining configuration 122, in the direction away from the mounting wall 1, is resisted. In some embodiments, for example, relative to a rear wall configuration wherein a first wall and a second wall are disposed in a parallel relationship, the ability of the first wall 72 and the second wall 74, of the rear wall configuration 70, wherein the first wall 72 and the second wall 74 are disposed in the non-parallel relationship, to resist the displacement of the retaining surface-defining configuration 122, in the direction away from the mounting wall, is increased, due to the non-parallel relationship between the first wall 72 and the second wall 74.

In some embodiments, for example, while the retained configuration is established, in response to mounting of the load to the bracket 502, the displacement-urging force is applied by the bracket connector 504 to the retaining surface 122, with effect that bending of the rear wall configuration 70, in a direction away from the mounting wall 1, is urged. In some embodiments, for example, the first wall 72 and the second wall 74 of the rear wall configuration 70 are co-operatively configured such that the bending of the rear wall configuration 70, in the direction away from the mounting wall 1, is resisted. In some embodiments, for example, relative to a rear wall configuration wherein a first wall and a second wall are disposed in a parallel relationship, the ability of the first wall 72 and the second wall 74, of the rear wall configuration 70, wherein the first wall 72 and the second wall 74 are disposed in the non-parallel relationship, to resist the bending of the rear wall configuration 70, in the direction away from the mounting wall 1, is increased, due to the non-parallel relationship between the first wall 72 and the second wall 74.

In some embodiments, for example, the front-facing surface 72A defines a normal axis 138A, the rear-facing surface 74A defines a normal axis 138B, as depicted in FIG. 2, and an acute angle defined between the normal axis 138A of the front-facing surface 72A and the normal axis 138B of the rear-facing surface 74A has a minimum value of at least 3 degrees.

In some embodiments, for example, the displacement-urging force has a maximum value of 300 pounds. In some embodiments, for example, the displacement-urging force has a maximum value of 300 pounds per linear foot of the panel 100 (e.g. measured along the axis 2).

In some embodiments, for example, as depicted in FIG. 2, the disposition of the first wall 72 and the rear wall 74 of the rear wall configuration 70 in the non-parallel relationship is such that the first wall 72 extends from the wall covering portion 12 towards the fastener receiving portion 116 in a direction away from the second wall 74. In some embodiments, for example, as depicted in FIG. 2, the disposition of the first wall 72 and the rear wall 74 of the rear wall configuration 70 in the non-parallel relationship is such that the first wall 72 extends from the wall covering portion 12 in a direction towards the front side of the panel 100.

In some embodiments, for example, as depicted in FIG. 2, to increase the load bearing capacity of the cavity 130, the panel 100 includes a wall member 147, connecting the retaining surface-defining wall 123 of the retaining surface defining configuration 122 and the first wall 72 of the rear wall configuration 70. The wall 147 member includes a wall portion 148 including an arcuate wall surface 149. In some embodiments, for example, the cavity defining surface 132 includes the arcuate wall surface 149 of the wall portion 148. In some embodiments, for example, the arcuate wall surface 149 defines the rounded surface 140.

In some embodiments, for example, while the retained configuration is established, in response to mounting of a load to the bracket 502, a displacement-urging force is applied by the bracket connector 504 to the retaining surface 134, with effect that displacement of the retaining surface-defining configuration 122, in the direction away from the mounting wall 1, is urged. In some embodiments, for example, the displacement of the retaining surface-defining configuration 122, away from the mounting wall 1, is resisted, by the wall portion 148. In some embodiments, for example, relative to a wall member that extends between the retaining surface defining wall 123 and the first wall 72 of the rear wall configuration that is absent an arcuate wall surface (e.g. a planar wall member), the ability of the wall portion 148, wherein the wall portion 148 includes the arcuate wall surface 149, to resist the displacement of the retaining surface-defining configuration 122, in the direction away from the mounting wall 1, is increased, due to the arcuate wall surface 149.

In some embodiments, for example, the displacement-urging force has a maximum value of 300 pounds. In some embodiments, for example, the displacement-urging force has a maximum value of 300 pounds per linear foot of the panel 100 (e.g. measured along the axis 2).

In some embodiments, for example, as depicted in FIG. 2, the retaining surface-defining configuration 122 is connected to the fastener-receiving portion 116. In some embodiments, for example, while the retained configuration is established, in response to mounting of the load to the bracket 502, the displacement-urging force is applied by the bracket connector 504 to the retaining surface 134, with effect that rotation of the retaining surface-defining configuration 122, relative to the fastener-receiving portion 116, in a direction away from the wall 1, is urged. In some embodiments, for example, the rotation of the retaining surface-defining configuration 122, relative to the fastener-receiving portion 116, in the direction away from the wall 1, is resisted by the wall portion 148. In some embodiments, for example, relative to a wall member that extends between the retaining surface defining wall 123 and the first wall 72 of the rear wall configuration that is absent an arcuate wall surface (e.g. a planar wall member), the ability of the wall portion 148, wherein the wall portion 148 includes the arcuate wall surface 149, to resist the rotation of the retaining surface-defining configuration 122, relative to the fastener-receiving portion 116, in the direction away from the mounting wall 1, is increased, due to the arcuate wall surface 149.

In some embodiments, for example, as depicted in FIG. 2, the wall member 147 is an arcuate wall member, the wall portion 148 is defined by a portion of the arcuate wall member, and the arcuate wall surface 147 of the wall portion 148 is defined by an arcuate wall surface of the arcuate wall member.

In some embodiments, for example, the wall member 147 defines a terminal end of the cavity 130.

In some embodiments, for example, with respect to existing slat wall panels, said slat wall panels are secured to a mounting wall 1 via fasteners that is received through a fastener receiving portion, and also via fasteners that are received through a cavity for receiving a bracket connector to retain a bracket to the panel. The additional fasteners through the cavity are needed to secure the panel to the wall while a bracket is retained to the panel and a load is mounted to the bracket. In some embodiments, for example, the industry standard width of an opening of the cavity of existing slat wall panels is 0.390 inches. The industry standard width is based on the width of the head of common fasteners (e.g. No. 8 or No. 10 head fasteners) used to secure existing slat wall panels to the wall. The width of the opening of the cavity of existing slat wall panels has to be sufficiently wide to provide clearance for the head of the fastener. In some embodiments, for example, due to the structural features of the cavity 130 that increase the load bearing capacity of the cavity 130, the width of the opening of the cavity 130 can be reduced from the industry standard of 0.390 inches to, for example, 0.300 inches. By reducing the width of the opening of the cavity 130, the minimum spacing distance from the fastener receiving portion 116 and the cavity 130, for example, between the fastener locator 120 and the wall member 141, is reduced, which is desirable, as the minimum spacing distance from the fastener, while the fastener is received in the fastener receiving portion 116, and the bracket 502, is reduced, while the retained configuration is established. By reducing the distance between the fastener and the bracket 502, the panel 100 is less susceptible to deformation, for example, bending, while the bracket 502 is loaded, as the fastener opposes more of the load that is supported by the bracket 502.

In some embodiments, for example, the minimum spacing distance between the fastener locator 120 and the wall member 141 is 0.750 inches.

In some embodiments, for example, while the first and second panels 100 are connected, it is desirable for the connection to be defeatable, such that, for example, the panels 100 may be transported to a different location and the panel assembly 10 may be installed at the different location, or that another panel can be connected to the first panel. In some embodiments, for example, it is also desirable for the connection between the first and second panels to be defeatable in a manner other than sliding one of the first panel and the second panel, relative to the other of the first panel and the second panel, in a direction along the length of the first and second panels (e.g. in a direction along the axis 2), as such sliding of one of the first panel and the second panel, relative to the other of the first panel and the second panel, to defeat the connection between the first and second panel, may require space that is not available (e.g. the length of the space needed is approximately the sum of the length of the first panel and the length of second panel), which may make the separation of the panels cumbersome.

In some embodiments, for example, while the first and second panels are connected via the first connection system counterpart configuration 30 of the first panel 100 and the second connection system counterpart configuration 50 of the second panel 100, to defeat the connection between connected panels, one of the first panel 100 and the second panel 100 is rotatable relative to the other of the first panel 100 and the second panel 100 to defeat the connection between the first connect system counterpart configuration 30 of the first panel 100 and the second connection system counterpart configuration 50 of the second panel 100. In some embodiments, for example, while the first panel 100 is secured to the wall 1, and the first and second panels are connected, the second panel 100 is rotatable, relative to the first panel 100, in a direction away from the wall, to defeat the connection between the first and second panels.

In some embodiments, for example, the first and second panels are co-operatively configured such that, while the connection of the first and second panels is defeated, via the rotation of one of the first panel 100 and the second panel 100, relative to the other one of the first panel 100 and the second panel 100, the first panel 100 and the second panel 100 are separable.

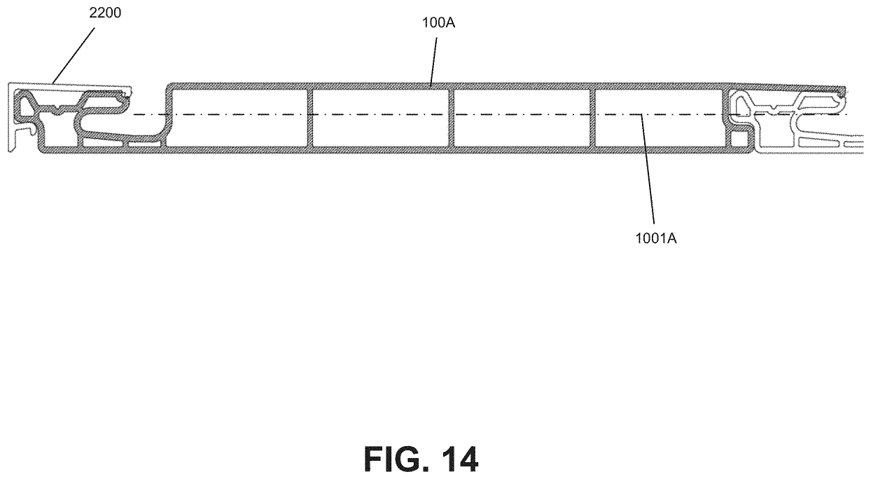

FIG. 14 depicts a panel 100A that is an alternate embodiment of the panel 100 depicted in FIG. 1. Panel 100A substantially corresponds to the panel 100, except the width of the panel 100A, measured along the central longitudinal axis 1001A of the panel 100A, is different from the width of the panel 100, measured along the central longitudinal axis 1001 of the panel 100. In some embodiments, for example, the number of ribs 108 of the panel increases as the length of the panel increases. In some embodiments, for example, the number of ribs 108 of the panel decreases as the length of the panel decreases.

In some embodiments, for example, the panel 100 includes a plurality of cavities 130. Each one of the plurality of cavities 130, independently, includes the features described herein. Each one of the plurality of cavities 130, independently, is configured for retaining a bracket 502 to the panel 100. In some embodiments, for example, the panel 100 includes two cavities 130. In some embodiments, for example, the panel 100 includes three cavities 130. In some embodiments, for example, the panel 100 includes four cavities 130. In some embodiments, for example, the panel 100 includes more than four cavities 130.

In this respect, in some embodiments, for example, for each one of the plurality of cavities 130, independently, the panel 100 includes: 1) a wall member 141 includes a wall portion 143 that has an arcuate wall surface 145, 2) a rear wall configuration 70 wherein the first wall 72 and the second wall 74 are disposed in a non-parallel relationship, and 3) a wall member 147, connecting the retaining surface-defining wall 123 of the retaining surface defining configuration 122 and the first wall 72 of the rear wall configuration 70, to improve the load bearing capacity of the cavity 130. In some embodiments, for example, for each one of the plurality of cavities 130, independently, the panel 100 includes a guiding surface 136 for guiding the rotation of the bracket connector 504 into the cavity 130 to effect the retained configuration.

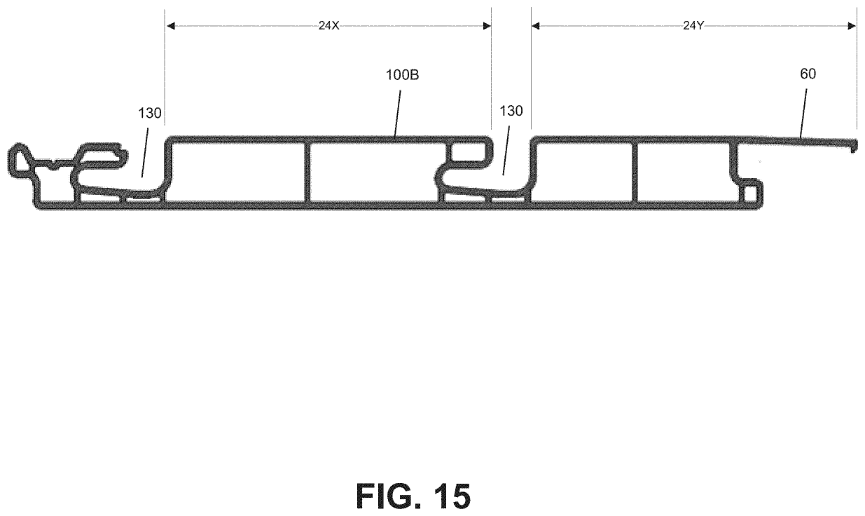

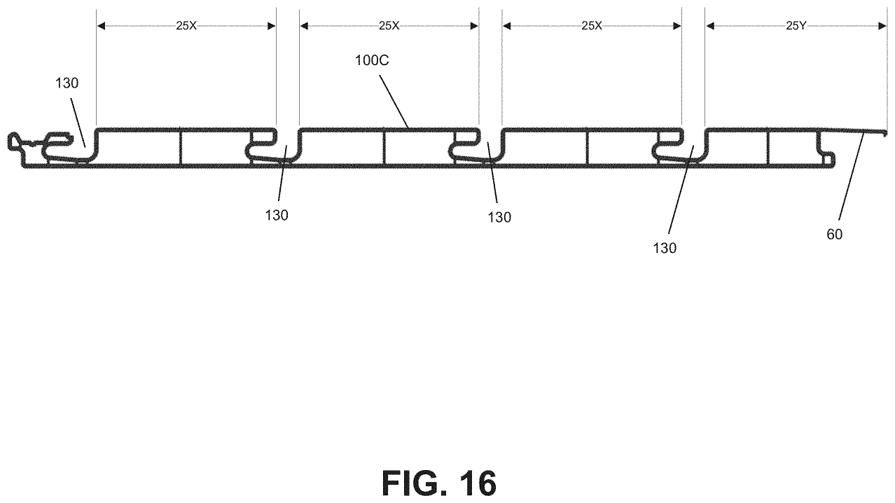

FIG. 15 depicts a panel 100B, and FIG. 16 depict a panel 100C. The panel 100B and the panel 100C are alternate embodiments of the panel 100 depicted in FIG. 1. Panel 100B and panel 100C substantially correspond to the panel 100, except the panel 100B the panel 100C include more than one cavity 130. As depicted, in some embodiments, for example, the panel 100B includes two cavities 130. As depicted, in some embodiments, for example, the panel 100C includes four cavities 130.

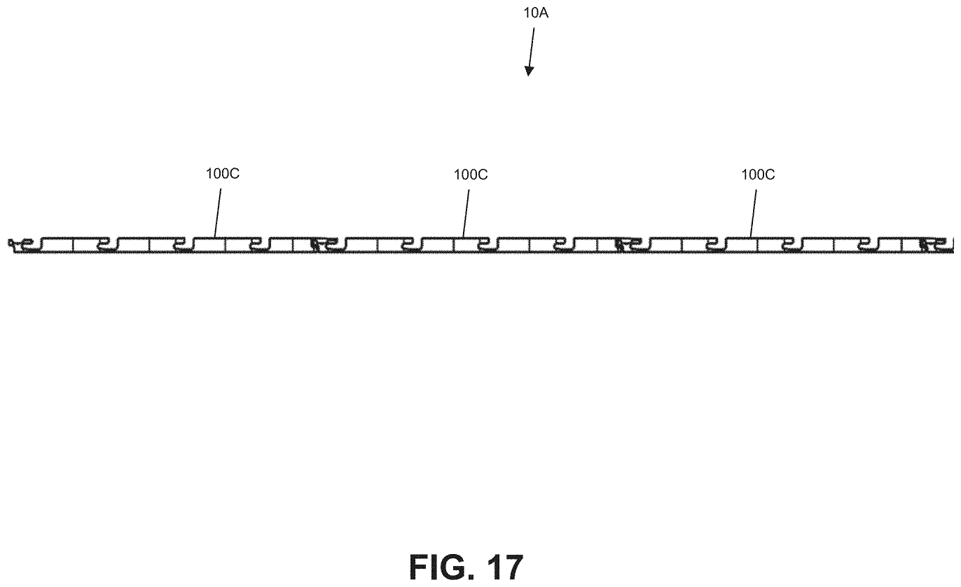

FIG. 17 depicts a wall panel assembly 10A comprising three panels 100C.

In some embodiments, for example, as depicted in FIG. 15, for a two-cavity panel having a width of approximately 6 inches, wherein the width of a panel is measured along the axis 1001, the minimum spacing distance 24X between the opening of a first cavity and the opening of a second cavity is approximately 2.5 inches. In some embodiments, for example, as depicted in FIG. 15, for a two-cavity panel having a width of approximately 6 inches, the minimum spacing distance 24Y between the opening of a cavity and the terminal end of the interacting portion 60 is approximately 2.5 inches.

In some embodiments, for example, as depicted in FIG. 15, for a two-cavity panel having a width of approximately 8 inches, the minimum spacing distance 24X between the opening of a first cavity and the opening of a second cavity is approximately 3.5 inches. In some embodiments, for example, as depicted in FIG. 15, for a two-cavity panel having a width of approximately 8 inches, the minimum spacing distance 24Y between the opening of a cavity and the terminal end of the interacting portion 60 is approximately 3.5 inches.

In some embodiments, for example, as depicted in FIG. 15, for a two-cavity panel having a width of approximately 12 inches, the minimum spacing distance 24X between the opening of a first cavity and the opening of a second cavity is approximately 5.5 inches. In some embodiments, for example, as depicted in FIG. 15, for a two-cavity panel having a width of approximately 12 inches, the minimum spacing distance 24Y between the opening of a cavity and the terminal end of the interacting portion 60 is approximately 5.5 inches.

In some embodiments, for example, for a three-cavity panel having a width of approximately 12 inches, the minimum spacing distance between the opening of a first cavity and the opening of a second cavity is approximately 3.5 inches. In some embodiments, for example, for a three-cavity panel having a width of approximately 12 inches, the minimum spacing distance between the opening of a cavity and the terminal end of the interacting portion 60 is approximately 3.5 inches.

In some embodiments, for example, as depicted in FIG. 16, for a four-cavity panel having a width of approximately 12 inches, the minimum spacing distance 25X between the opening of a first cavity and the opening of a second cavity is approximately 2.5 inches. In some embodiments, for example, as depicted in FIG. 16, for a four-cavity panel having a width of approximately 12 inches, the minimum spacing distance 25Y between the opening of a cavity and the terminal end of the interacting portion 60 is approximately 2.5 inches.

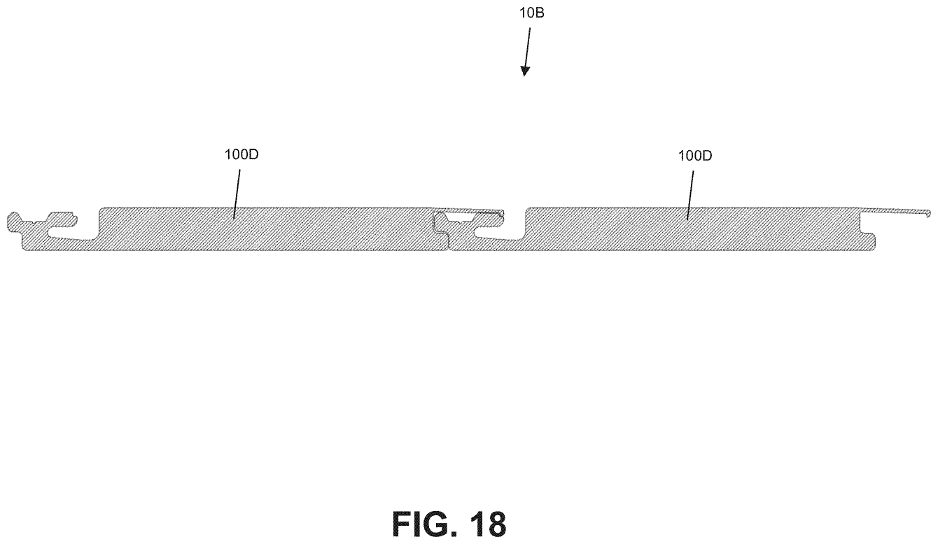

In some embodiments, for example, the material of the panel 100 includes plastic, for example, polyvinyl chloride (PVC), polypropylene, or recycled plastic. In some embodiments, for example, the material of the panel 100 includes a composite, such as, for example, wood fibre composite, recycled material, or cellular foam. In some embodiments, for example, the material of the panel 100 includes aluminum. In some embodiments, for example, the material of the panel 100 includes fibreglass. In some embodiments, for example, the material of the panel 100 includes wood. FIG. 18 depicts a wall panel assembly 10B comprising two panels 100D, the panel 100D being an alternate embodiment of the panel 100. The panel 100 and the panel 100D are substantially similar, except the panel 100D is solid wood. As depicted, in some embodiments, for example, where the panel 100D is solid wood, there is an absence of ribs 108 extending between the first side 103 and the second side 1031. As depicted, in some embodiments, for example, where the panel 100D is solid wood, there is an absence of hollow portions in the panel 100D.

In some embodiments, for example, the panel 100 is manufactured by extrusion. In such embodiments, for example, the panel 100 is an extruded lineal. In some embodiments, for example, the panel 100 is manufactured by molding. In some embodiments, for example, the panel 100 is manufactured by pultrusion. In some embodiments, for example, the panel 100 is manufactured by cutting a piece of wood.

In some embodiments, for example, the first panel 100 is connected to the second panel 100 that is the same as the first panel 100. For example, the first panel 100 and the second panel are both the panel 100 as depicted in FIG. 1. In some embodiments, for example, the first panel 100 is connected to the second panel that is different from the first panel 100. For example, the first panel 100 is the panel 100 depicted in FIG. 1, and the second panel is any one of the other panels described herein, for example, any one of the panel 100A to the panel 100F. In some embodiments, for example, a wall panel assembly 10 is assembled by connecting two of the same panels together, or connecting two different panels together. In some embodiments, for example, a first panel is connectible to a second panel, wherein the connection is effected by the first connection system counterpart configuration 30 of the first panel, and the second connection system counterpart configuration 50 of the second panel.

In some embodiments, for example, while the load bearing capacity of the cavity 130 is increased via structural changes to the cavity 130, it may be desirable to penetrate portions of the panel 100, in addition to the fastener receiving portion 116, to improve the securing of the panel 100 to the wall 1.

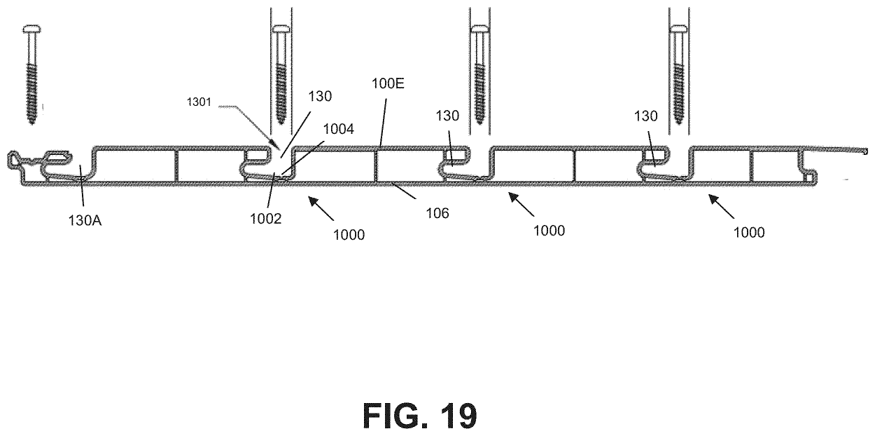

In this respect, in some embodiments, for example, FIG. 19 depicts a panel 100E that is an alternate embodiment of the panel 100. Panel 100E substantially corresponds to the panel 100, except the panel 100E includes more than one cavity 130, and further includes one or more fastener-receiving portions 1000. As depicted, the panel 100E includes three fastener-receiving portions 1000. In some embodiments, for example, the panel 100E is configured to be fastened to a wall 1 via a fastener that is received through a cavity 130 of the panel 100E. In some embodiments, for example, at least one of the cavities 130 of the panel 100E is configured to receive a fastener and engage the fastener for fastening the panel 100E to a wall 1.

In some embodiments, for example, the fastener-receiving portion 1000 of the panel 100E is configured to receive one or more mechanical fasteners, for example, screws, bolts, pins, and the like, to connect the panel 100E to a wall 1. In some embodiments, for example, the fastener-receiving portion 1000 is configured to co-operate with one or more mechanical fasteners, wherein at least a portion of the mechanical fastener is disposed in the cavity 130, to connect the panel 100E to a wall 1.

The fastener-receiving portion 1000 includes a fastener-engaging surface 1002. In some embodiments, for example, the fastener-engaging surface 1002 is defined by the outer surface 72A of the first wall 72 of the rear wall configuration 70. The fastener-engaging surface 1002 is configured to engage with a head of a fastener, and further configured to resist further displacement of the fastener through the panel 100E while the fastener-engaging surface 1002 is engaged to the head of the fastener. In some embodiments, for example, the cavity-defining surface 132 includes the fastener-engaging surface 1002.

In some embodiments, for example, the fastener-engaging surface 1002 is aligned with an opening 1301 of the cavity 130, such that the fastener is receivable through the opening 1301, and extending through the cavity 130, to engage the fastener-engaging surface 1002. In some embodiments, for example, the opening 1301 is sufficiently wide such that the head of the fastener is receivable in the opening 1301 and displaceable through the opening 1301.

In some embodiments, for example, the fastener-receiving portion 1000 includes a fastener locator 1004, similar to the fastener locator 120, for locating placement of a fastener in a fastener effective position, and for guiding the penetration of the panel 100 by the fastener. In some embodiments, for example, the fastener locator 1004 is defined by the first wall 72 of the rear wall configuration 70. In some embodiments, for example, the fastener locator 1004 includes a groove that is defined within the outer surface 72A of the first wall 72. In some embodiments, for example, the fastener locator 1004 is configured to receive the tip of a fastener. In some embodiments, for example, the fastener locator 1004 is sufficiently deep and wide to receive the tip of the fastener. In some embodiments, for example, the fastener locator 1004 and the tip of the fastener are co-operatively configured such that, while the tip of the fastener is received in the fastener locator 1004, the position of the fastener-receiving portion 1000 is identified for a user to fasten the panel 100E to a wall 1. In some embodiments, for example, the fastener locator 1004 and the tip of the fastener are co-operatively configured such that, while the tip of the fastener is received in the fastener locator 1004, the fastener is oriented such that the fastener is able to fasten the panel 100E to a wall 1. In some embodiments, for example, the fastener locator 1004 is defined on the fastener-engaging surface 1002.

To connect the panel 100E to a wall 1, the panel 100E is disposed against the wall 1, and the fastener is displaced relative to the panel 100E such that the fastener is received in the cavity 130, for example, the counterpart-receiving portion 144. At this point, the fastener continues to be displaced in the cavity 130 until the tip of the fastener is engaged with the fastener locator 1004, such that the fastener becomes oriented for fastening the panel 100E via the fastener locator 1004. At this point, the fastener is displaced through the fastener-engaging surface 1002 of the panel 100E and further displaced through the wall-opposing surface 106 until the fastener engages the wall 1, such that the panel 100E is coupled to the wall 1 via the fastener.

In some embodiments, for example, at least one of the cavities 130 of the panel 100E is configured to receive a fastener to fasten the panel 100E to the wall. In some embodiments, for example, for at least one of the cavities 130 of the panel 100E that is configured to receive a fastener to fasten the panel 100E to the wall, the cavity-defining surface 132 includes the fastener-engaging surface 1002. In some embodiments, for example, as depicted in FIG. 19, a fastener-engaging surface 1002 is absent from the cavity-defining surface 132 of a cavity 130A disposed at the first end 101 of the panel 100E, while the cavity-defining surface 132 of each other cavity 130 of the panel 100E includes a fastener-engaging surface 1002. In such embodiments, for example, the width of the opening of the cavity 130A is less than the width of the opening of the cavity 130, as the width of the opening of the cavity 130A does not have to be sufficient to provide clearance for receiving the head of the fastener.

In some embodiments, for example, a fastener, in addition to the fastener that connects the panel 100E to the wall 1 via the fastener-receiving portion 116, can connect the panel 100E to the wall 1 via the fastener-receiving portion 1000. The additional fasteners strengthens the connection of the panel 100E to the wall 1. Such additional connection strength is desirable if the load to be supported by a mounting bracket that is connected to the panel 100E is particularly heavy.

In some embodiments, for example, while the fastener is engaged with the fastener-engaging surface 1002 of the fastener-receiving portion 1000, the exposed portion of the head of the fastener is configured to guide the displacement of the bracket connector 504, for example, rotation of the bracket connector 504, for disposition of the bracket connector 504 further into the cavity 130. In some embodiments, for example, the exposed portion of the head of the fastener, which is configured to guide the displacement of the bracket connector 504 further into the cavity, includes a rounded portion.

In some embodiments, for example, while the fastener is engaged with the fastener-engaging surface 1002 of the fastener-receiving portion 1000, the bracket connector 504 can be received by the residual portion of the cavity 130 that is unobstructed by the head of the fastener that is securing the panel 100E to the wall 1, for effecting the retained configuration.

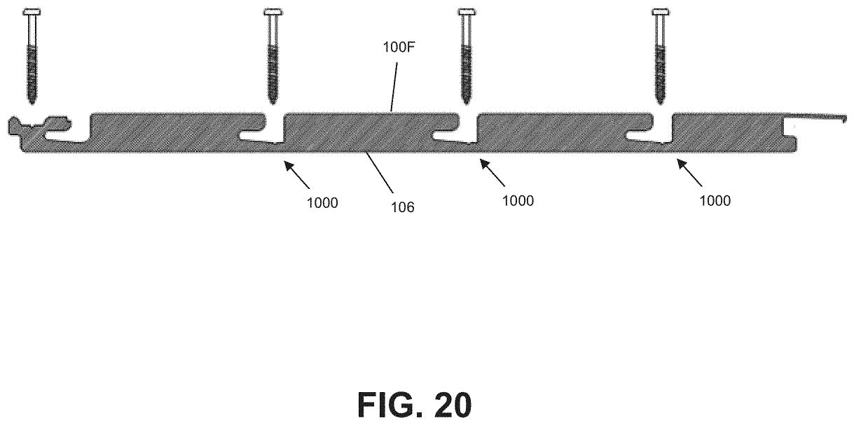

FIG. 20 depicts a panel 100F that is an alternate embodiment of the panel 100E. The panel 100F substantially corresponds to the panel 100E, except the panel 100F is solid wood.

In some embodiments, for example, a cavity 130 of a panel as described herein, for example, panel 100 to panel 100F, is configured to receive a fastener to fasten the panel to the wall 1. In some embodiments, for example, the cavity-defining surface 132 of said cavity 130 defines a fastener-engaging surface 1002 of a fastener-receiving portion to engage with a head of a fastener for connecting the panel to a wall 1.

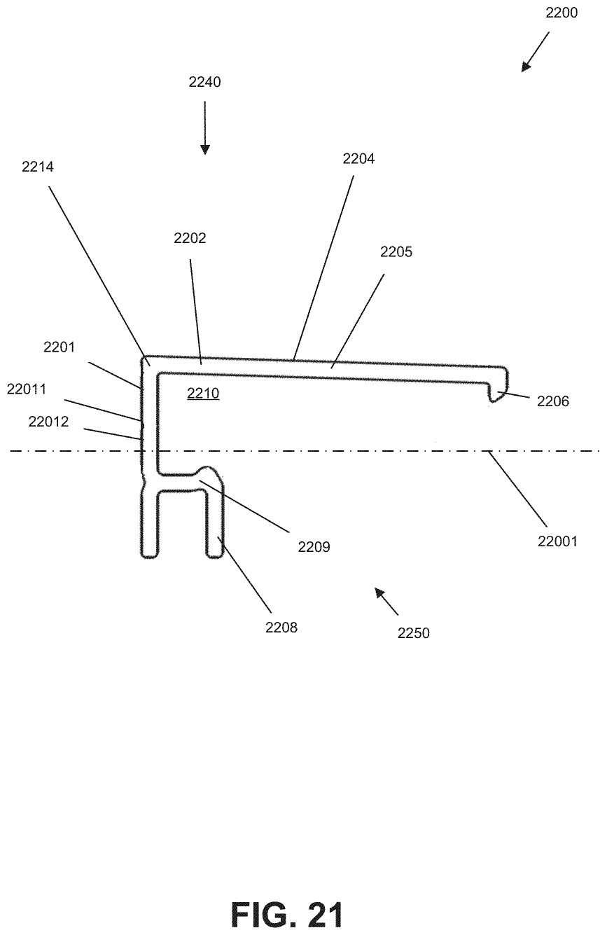

FIG. 21 depicts an example embodiment for a trim 2200. In some embodiments, for example, the trim 2200 is configured to connect to a panel described herein, for example, the panel 100 to 100F, to conceal the first connection system counterpart configuration 30 of the panel 100, and provide a clean and aesthetic finish to a connected trim 2200 and panel. In some embodiments, for example, the trim 2200 is connectible to the panel 100, that is the uppermost panel 100 of the wall panel assembly, for concealing the fastener that is connecting the uppermost panel 100 to the wall 1.

In some embodiments, for example, the trim 2200 is connectible to the panel 100, such that connected trim and panel are established, for example, to define a wall panel assembly 10.

The trim 2200 defines a central longitudinal axis 22001. The trim 2200 includes a trim defined configuration 2240 that substantially corresponds to the panel defined configuration 40 at the second end 102 of the panel 100. In particular, the trim defined configuration 2240 includes a trim-defined connection system counterpart configuration 2250 that substantially corresponds to the second connection system counterpart configuration 50 of the panel 100. The trim 2200 and the panel 100 are connectible via the trim-defined connection system counterpart configuration 2250 and the first connection system counterpart configuration 30 of the panel 100. The trim 2200 is connectible to a panel 100 in a manner substantially similar to the manner by which the connection between adjacent panels, in the wall panel assembly, is established, as described herein.

As depicted, the trim defined configuration 2240 includes the trim-defined connection system counterpart configuration 2250, which includes an interacting portion 2202, which substantially corresponds to the interacting portion 60 of the panel 100. The interacting portion 2202 includes a covering portion 2205, for effectuating the concealment of the fastener in like manner as the effectuating of the concealment of the fastener, by co-operation between adjacent panels in the wall panel assembly, by the covering portion 154 of the interacting portion 60 of the panel 100. The covering portion 2205 includes an outermost surface 2204 configured for being visible while the trim 2200 is connected to the panel 100, the outermost surface 2204 including a continuous surface that extends along the length of the covering portion 2205. The interacting portion 2202 further includes a trim defined second connection system counterpart 2206 (e.g. a rearward projection 2206) of the first connection system 32, substantially corresponding to the second connection system counterpart 158 of the first connection system 32, of the panel 100, that is configured to co-operate with the first connection system counterpart 110 (e.g. the notch 124) of the first connection system 32 of the panel 100 for snap fit engagement.

The trim-defined connection system counterpart configuration 2250 further includes a trim defined second connection system counterpart 2208 of the second connection system 34, including a wall member 2209, disposed rearwardly of the interacting portion 2202, substantially corresponding to the second connection system counterpart 160 of the second connection system 34, of the panel 100, and is configured to co-operate with the first connection system counterpart 114 (e.g. the projection 114) of the second connection system 34 to resist lifting of the trim 2200 away from the panel 100.

The trim defined configuration 2240 further includes a trim wall 2201, that defines an intermediate wall 22012 that extends between the interacting portion 2202 and the trim defined second connection system counterpart 2208.

In some embodiments, for example, the interacting portion 2202 is pivotable about a joint 2214, for transitioning between the pre-deformation configuration, the interference effective configuration, and the interference ineffective configuration. The interacting portion 2202 is connected to the trim wall 2201 at the joint 2214, as depicted in FIG. 21.

In some embodiments, for example, the trim wall 2201 includes an outermost end surface 22011 configured for being visible while the trim 2200 is connected to the panel 100, the outermost end surface 22011 including a continuous surface that extends along the length of the trim 2200. In some embodiments, for example, the outermost end surface 22011 has a minimum surface area of at least 0.375 inches squared. In some embodiments, for example, the visible surface of the outermost end surface 22011 has a minimum width or height of at least ⅛ inches. In some embodiments, for example, the visible surface of the outermost end surface 22011 has a minimum length of at least 3 inches.

The trim defined configuration further defines a recess 2210, substantially corresponding to the recess 164, between an inner surface of the interacting portion 2202, an inner surface of the trim defined second connection system counterpart 2208, and the intermediate wall 22012, for receiving the projection 114 of the panel.

The trim 2200 and the panel 100 are co-operatively configured such that, while the connection between the trim 2200 and the panel 100 is established, the covering portion 2205 is concealing the fastener that is connecting the panel 100 to the wall 1.

In some embodiments, for example, while the trim 2200 is connected to the panel 100, the covering portion 2205 of the trim conceals at least a portion of the first connection system counterpart configuration 30 of the panel 100. In some embodiments, for example, while the trim 2200 is connected to the panel 100, the covering portion 2205 of the trim 2200 conceals the entirety of the first connection system counterpart configuration 30 of the panel 100. In some embodiments, for example, while the trim 2200 is connected to the panel 100, the covering portion 2205 of the trim 2200 conceals the fastener-receiving portion 116 of the panel 100, such that a fastener extending through the fastener-receiving portion 116 is concealed by the covering portion 2205. Such concealment of the of the first connection system counterpart configuration 30, for example, the fastener-receiving portion 116, and a fastener extending through the fastener-receiving portion 116, provides an aesthetically pleasing appearance to the connected trim 2200 and the panel 100.

In some embodiments, for example, to defeat or release the connection between connected trim 2200 and panel 100, the interacting portion 2202 is transitioned from the interference effective configuration to the interference ineffective configuration. At this point, the trim 2200 is displaceable away from the panel 100 in a direction perpendicular to the surface 22011 (e.g. the trim 2200 can be pulled away from the panel 100).

In some embodiments, for example, to defeat or release the connection between connected trim 2200 and panel 100, one of the trim 2200 and the panel 100 is rotated relative to the other of the trim 2200 and the panel 100.

In some embodiments, for example, the material of the trim 2200 includes plastic, for example, PVC, polypropylene, or recycled plastic. In some embodiments, for example, the material of the trim 2200 includes a composite, such as, for example, wood fibre composite, recycled material, or cellular foam. In some embodiments, for example, the material of the trim 2200 includes aluminum. In some embodiments, for example, the material of the trim 2200 includes fibreglass. In some embodiments, for example, the material of the trim 2200 includes wood. In some embodiments, for example, the trim 2200 is solid wood.

In some embodiments, for example, the trim 2200 is manufactured by extrusion. In some embodiments, for example, the trim 2200 is manufactured by molding. In some embodiments, for example, the trim 2200 is manufactured by pultrusion. In some embodiments, for example, the trim 2200 is manufactured by cutting a piece of wood.

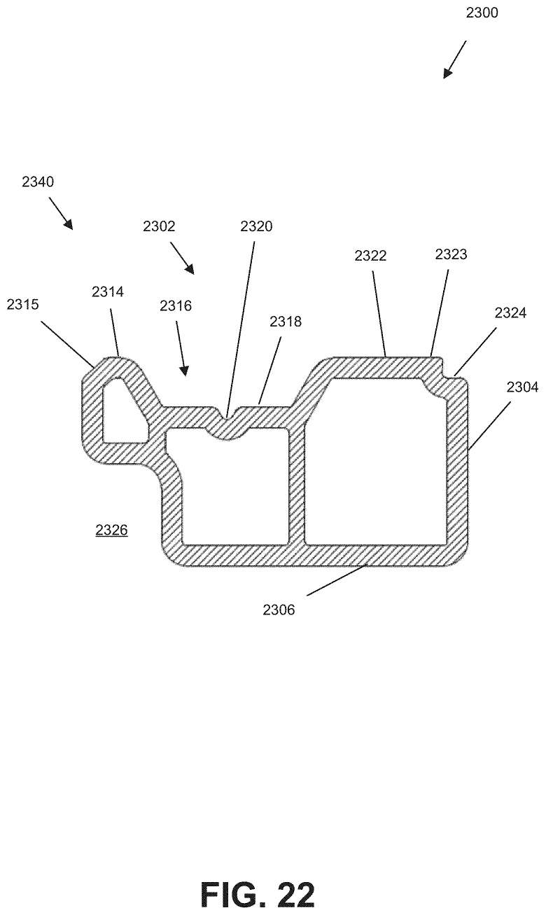

FIG. 22 depicts an example embodiment for a trim 2300. In some embodiments, for example, the trim 2300 is configured to connect to a panel described herein, for example, the panel 100 to 100F, to conceal the trim defined configuration 2340 of the trim 2300, and provide a clean and aesthetic finish to a connected trim 2300 and panel. In some embodiments, for example, the trim 2300 is connectible to the panel 100 that is the lowermost panel 100 of the wall panel assembly, for concealing the fastener that is connecting the trim 2300 to the wall 1.

In some embodiments, for example, the trim 2300 is connectible to the panel 100, such that connected trim and panel are established, for example, to define a wall panel assembly 10.

In some embodiments, for example, the trim 2300 includes a wall-opposing surface 2306 that is configured for opposing the wall while the trim 2300 is secured to the wall 1.

The trim 2300 includes a trim defined configuration 2340 that substantially corresponds to the panel defined configuration 20 at the first end 101 of the panel 100. In particular, the trim defined configuration 2340 includes a trim-defined connection system counterpart configuration 2302 that substantially corresponds to the first connection system counterpart configuration 30 of the panel 100. The trim 2300 and the panel 100 are connectible via the trim-defined connection system counterpart configuration 2302 and the second connection system counterpart configuration 50 of the panel 100. The trim 2300 is connectible to a panel 100 in a manner substantially similar to the manner by which the connection between adjacent panels, in the wall panel assembly, is established, as described herein.

As depicted, the trim-defined connection system counterpart configuration 2302 includes a trim defined first connection system counterpart 2324 (e.g. a notch 2324) of the first connection system 32, substantially corresponding to the first connection system counterpart 110 (e.g. the notch 124) of the first connection system counterpart 32, of the panel 100, and configured to co-operate with the second connection system counterpart 158 (e.g. the projection 158) of the first connection system 32 of the panel 100 for snap fit engagement.

The trim-defined connection system counterpart configuration 2302 further includes a trim defined first connection system counterpart 2314 (e.g. a projection 2314) substantially corresponding to the first connection system counterpart 114 (e.g. the projection 114) of the second connection system counterpart 34, of the panel 100. The trim defined first connection system counterpart 2314 includes an urging surface 2315, which substantially corresponds to the urging surface 115 of the projection 114 of the panel 100. The trim defined first connection system counterpart 2314 is configured to be received in the recess 164 of the panel 100, and further configured to co-operate with the second connection system counterpart 160 of the second connection system 34, of the panel 100, to resist lifting of the panel 100 away from the trim 2300.

The trim defined configuration 2340 further includes a fastener receiving portion 2316, including a fastener locator 2320 and a fastener-engaging surface 2318, substantially corresponding to the fastener receiving portion 116, for emplacing a fastener in the fastener effective position to secure the trim 2300 to the wall 1. To connect the trim 2300 to a wall 1, the trim 2300 is disposed in abutting engagement against the wall 1, the fastener is emplaced in the fastener effective position via the fastener locator 2320, and penetrated through the fastener-engaging surface 2318 of the trim 2300, and further penetrated through the wall-opposing surface 2306 until the fastener engages the wall, such that the trim 2300 is coupled to the wall via the fastener 1.

The trim defined configuration 2340 further defines a recess 2326, substantially corresponding to the recess 126, and defined between projection 2314 and the fastener receiving portion 2316, that is configured to receive second connection system counterpart 160 of the second connection system 34, of the panel 100.

The trim 2300 and the panel 100 are co-operatively configured such that, while the connection between the trim 2300 and the panel 100 is established, the covering portion 154 is concealing the fastener that is connecting the trim 2300 to the wall 1.

In some embodiments, for example, the trim 2300 includes an outermost end surface 2304 configured for being visible while the trim 2300 is connected to the panel 100. As depicted in FIG. 22, in some embodiments, for example, the outermost end surface 2304 is perpendicular relative to the wall-opposing surface 2306. In some embodiments, for example, the outermost end surface 2304 includes a continuous surface that extends along the length of the trim 2300. In some embodiments, for example, the outermost end surface 2304 has a minimum surface area of at least 0.375 inches squared. In some embodiments, for example, the visible surface of the outermost end surface 2304 has a minimum width or height of at least ⅛ inches. In some embodiments, for example, the visible surface of the outermost end surface 2304 has a minimum length of at least 3 inches.

In some embodiments, for example, the trim defined configuration 2340 includes a wall member 2322, substantially correspond to an outer wall member of the retaining surface defining configuration 122. The wall member 2322 defines an outer surface 2323. In some embodiments, for example, the wall member 2322 is configured to support the covering portion 154 of the interacting portion 60 of the second connection system counterpart configuration 50 of the panel 100 while the trim 2300 is connected to the panel 100.

In some embodiments, for example, as depicted in FIG. 22, the trim defined first connection system counterpart 2324 (e.g. a notch 2324) of the first connection system 32 is defined between the wall member 2322 and the outermost end surface 2304.

In some embodiments, for example, the outer surface 2323 and the end surface 2304 are disposed in a perpendicular relationship.

In some embodiments, for example, while the trim 2300 is connected to the panel 100, the covering portion 154 of the panel 100 conceals at least a portion of the trim-defined configuration 2340. In some embodiments, for example, while the trim 2300 is connected to the panel 100, the covering portion 154 of the panel 100 conceals the entirety of the trim-defined configuration 2340. In some embodiments, for example, while the trim 2300 is connected to the panel 100, the covering portion 154 of the panel 100 conceals the fastener-receiving portion 2316 of the trim 2300, such that a fastener extending through the fastener-receiving portion 2316 is concealed by the covering portion 154. Such concealment of the of the trim-defined configuration 2340, for example, the trim defined connection system counterpart configuration 2302, the fastener-receiving portion 2316, and a fastener extending through the fastener-receiving portion 2316, provides an aesthetically pleasing appearance to the connected trim 2300 and the panel 100.

In some embodiments, for example, to defeat or release the connection between connected trim 2300 and panel 100, the interacting portion 60 is transitioned from the interference effective configuration to the interference ineffective configuration. At this point, the panel 100 is displaceable away from the trim 2300 in a direction parallel to the front facing surface 104 (e.g. the panel 100 can be pulled away from the trim 2300).

In some embodiments, for example, to defeat or release the connection between connected trim 2300 and panel 100, one of the trim 2300 and the panel 100 is rotated relative to the other of the trim 2300 and the panel 100.

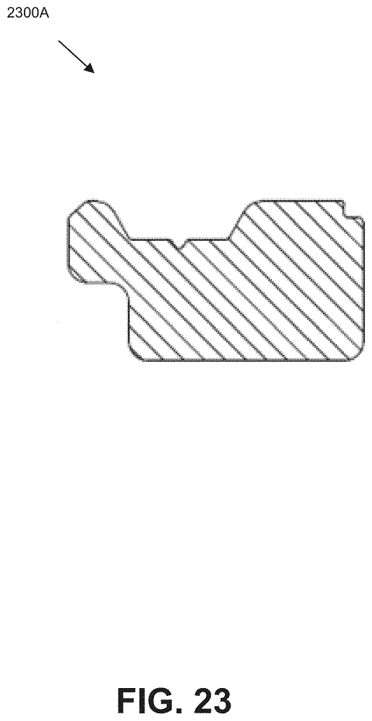

In some embodiments, for example, the material of the trim 2300 includes plastic, for example, PVC, polypropylene, or recycled plastic. In some embodiments, for example, the material of the trim 2300 includes a composite, such as, for example, wood fibre composite, recycled material, or cellular foam. In some embodiments, for example, the material of the trim 2300 includes aluminum. In some embodiments, for example, the material of the trim 2300 includes fibreglass. In some embodiments, for example, the material of the trim 2300 includes wood. In some embodiments, for example, the trim 2300 is solid wood. FIG. 23 depicts a trim 2300A that is an alternate embodiment of the trim 2300. The trim 2300 and the trim 2300A are substantially similar, except the panel 2300A is solid wood. As depicted, in some embodiments, for example, where the 2300A is solid wood, there is an absence of hollow portions in the trim 2300A.

In some embodiments, for example, the trim 2300 is manufactured by extrusion. In some embodiments, for example, the trim 2300 is manufactured by molding. In some embodiments, for example, the trim 2300 is manufactured by pultrusion. In some embodiments, for example, the trim 2300 is manufactured by cutting a piece of wood.

In some embodiments, for example, a kit fora wall panel assembly 10 includes one or more trims and one or more panels described herein, for example, one or more of the trim 2200 and the trim 2300, and one or more panels, for example, one or more of the panel 100 to the panel 100F. In some embodiments, for example, the kit for the wall panel assembly 10 includes a trim, a first panel (e.g. one of the panels 100 to 100F), and a second panel (e.g. one of the panels 100 to 100F). In some embodiments, for example, the first panel 100 and the second panel 100 are identical. In some embodiments, for example, the first panel 100 and the second panel 100 are different.

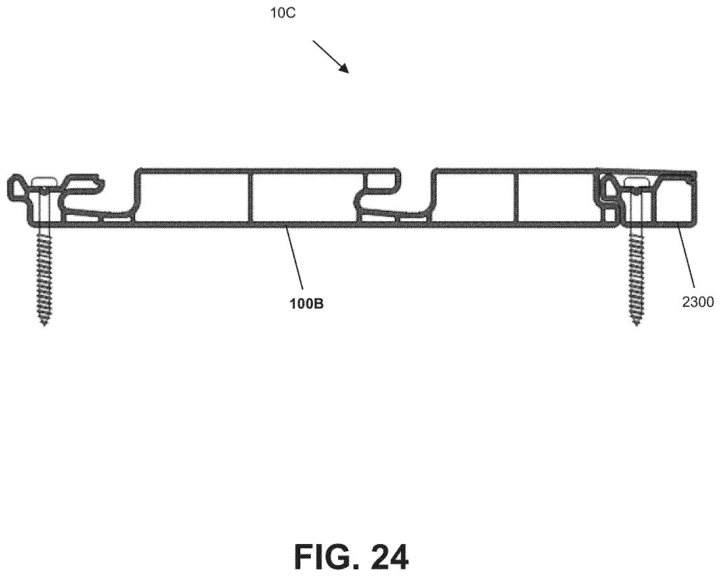

FIG. 24 depicts a wall panel assembly 10C, including a connected panel 100B and the trim 2300. As depicted, fasteners are extending through the fastener-receiving portion 116 of the panel 100B and the fastener-receiving portion 2316 of the trim 2300.

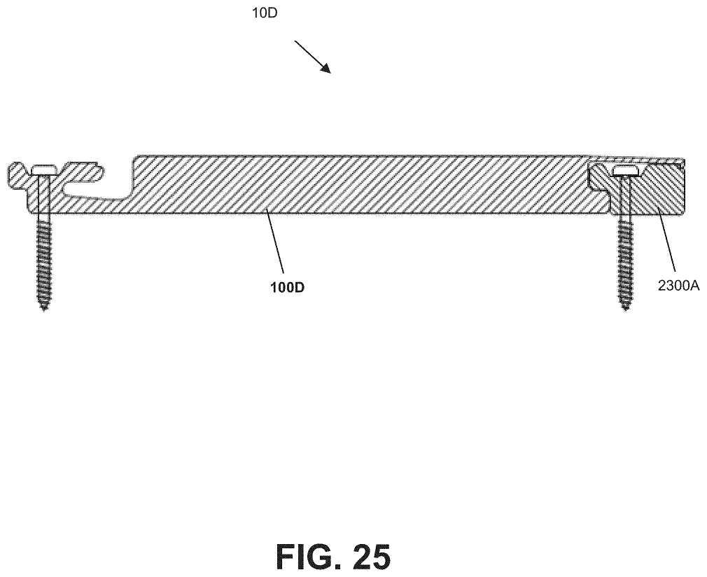

FIG. 25 depicts a wall panel assembly 10D, including a connected panel 100D and the trim 2300A. As depicted, fasteners are extending through the fastener-receiving portion 116 of the panel 100C and the fastener-receiving portion 2316 of the trim 2300A.

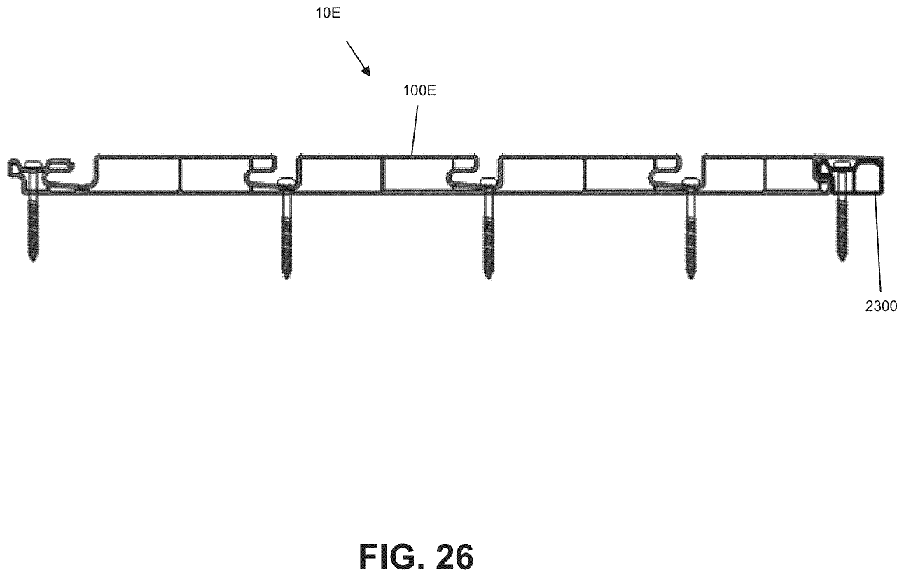

FIG. 26 depicts a wall panel assembly 10E, including a connected panel 100E and the trim 2300. As depicted, fasteners are extending through the fastener-receiving portion 116 of the panel 100E, the fastener-receiving portion 2316 of the trim 2300, and the fastener-receiving portions 1000 of the panel 100E.

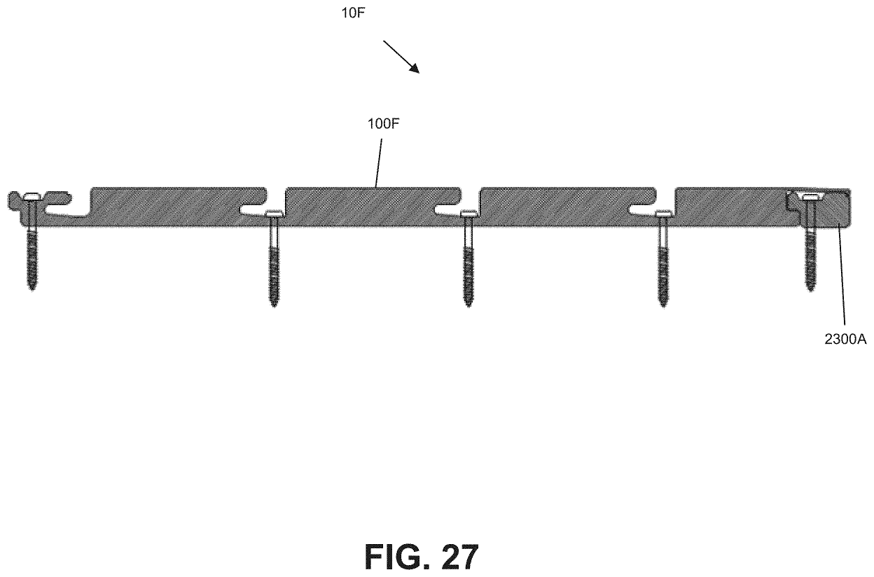

FIG. 27 depicts a wall panel assembly 10F, including a connected panel 100F and the trim 2300A. As depicted, fasteners are extending through the fastener-receiving portion 116 of the panel 100F and the fastener-receiving portion 2316 of the trim 2300A, and the fastener-receiving portions 1000 of the panel 100F.

FIG. 30 to FIG. 38 depicts an example embodiment of a bracket assembly or a mounting assembly 500. The assembly 500 is configured to be connected to a first wall surface configuration having a first pair of panel-defined connection counterparts 39 spaced apart by a first spacing distance, and further configured to be connected to a second wall surface configuration having a second pair of panel-defined connection counterparts 39 spaced apart by a second spacing distance.

In some embodiments, for example, the assembly 500 comprises a connector 504 or first connection counterpart 504, and further comprises a second connection counterpart 508. In some embodiments, for example, while the assembly 500 is disposed in an operating configuration, the first connection counterpart 504 is disposed above the second connection counterpart 508. In this respect, in some embodiments, for example, the first connection counterpart 504 is an upper connection counterpart 504, and the second connection counterpart 508 is a lower connection counterpart 508. In some embodiments, for example, as described herein, the first connection counterpart 504 is configured to co-operate with the cavity 130 of a panel 100 or a wall panel assembly 10 such that the assembly 500 is hangable from the panel or the wall panel assembly.

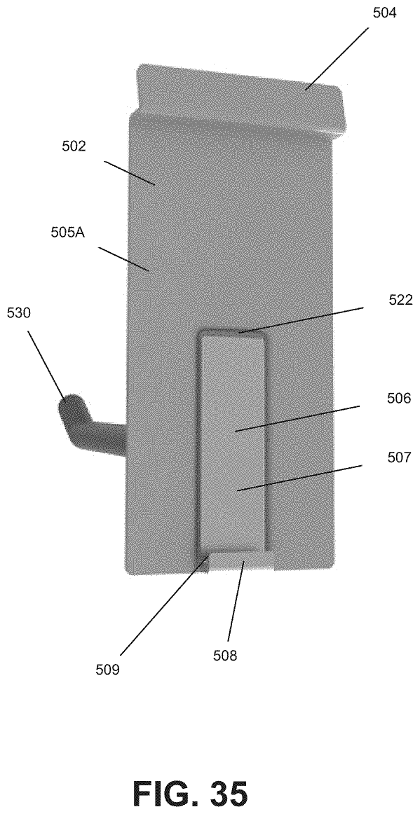

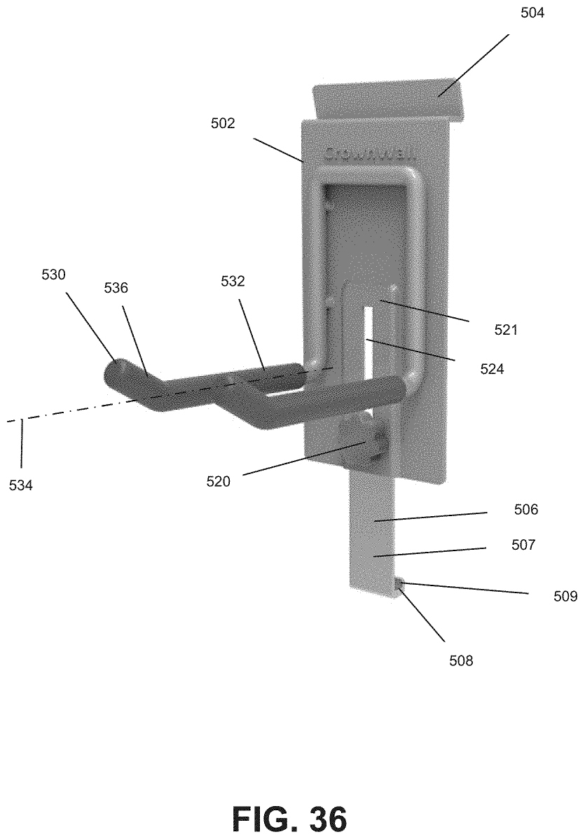

In some embodiments, for example, the second connection counterpart 508 includes a channel 509, as depicted in FIG. 35 and FIG. 36, to receive at least a portion of the counterpart 39 of the wall panel assembly 10 or wall panel 100, for example, at least a portion of the retaining surface defining configuration 122 or at least a portion of the interacting portion 60, for securing the assembly 500 to a wall panel assembly 10 or a panel 100. In some embodiments, for example, the second connection counterpart 508 is defined by a hook.

As depicted in FIG. 30, in some embodiments, for example, the first connection counterpart 504 and the second connection counterpart 508 are disposed at opposite ends of the assembly 500.

In some embodiments, for example, the assembly 500 is configurable in a fixed configuration and an adjustable configuration. In the fixed configuration, there is an absence of adjustability of the spacing between the first connection counterpart 504 and the second connection counterpart 508. In the adjustable configuration, spacing between the first connection counterpart 504 and the second connection counterpart 508 is adjustable between at least a first spacing and a second spacing. In the first spacing, the first connection counterpart 504 and the second connection counterpart 508 are disposed for connection to the first pair of panel-defined connection counterparts 39, and in the second spacing, the first connection counterpart 504 and the second connection counterpart 508 are disposed for connection to the second pair of panel-defined connection counterparts 39.

In some embodiments, for example, a first panel-defined connection counterpart 39 of the first pair of panel-defined connection counterparts 39 includes a cavity 130, for example, the cavity 130 of the panel 100, as depicted in FIG. 1, for receiving the first connection counterpart 504. In some embodiments, for example, a second panel-defined connection counterpart 39 of the first pair of panel-defined connection counterparts 39 includes a cavity 130, for example, a cavity 130 of the panel 100 or a cavity 130 of another panel 100, for receiving the second connection counterpart 508. In some embodiments, for example, a first panel-defined connection counterpart 39 of the second pair of panel-defined connection counterparts 39 includes a cavity 130, for example, the cavity 130 of the panel 100, for receiving the first connection counterpart 504. In some embodiments, for example, a second panel-defined connection counterparts 39 of the second pair of panel-defined connection counterparts 39 includes a cavity 130, for example, a cavity 130 of the panel 100 or a cavity 130 of another panel 100, for receiving the second connection counterpart 508.

In some embodiments, for example, the first spacing distance of the first pair of panel-defined connection counterparts 39 is different from the second spacing distance of the second pair of panel-defined connection counterparts 39. In some embodiments, for example, the first spacing distance of the first pair of panel-defined connection counterparts 39 is 1 inch. In some embodiments, for example, the second spacing distance of the second pair of panel-defined connection counterparts 39 is 4 inches. In some embodiments, for example, the first spacing distance of the first pair of panel-defined connection counterparts 39 is 3 inches. In some embodiments, for example, the second spacing distance of the second pair of panel-defined connection counterparts 39 is 9 inches. In some embodiments, for example, the first spacing distance of the first pair of panel-defined connection counterparts 39 is 6 inches. In some embodiments, for example, the second spacing distance of the second pair of panel-defined connection counterparts 39 is 8 inches. In some embodiments, for example, the first spacing distance of the first pair of panel-defined connection counterparts 39 is 10 inches. In some embodiments, for example, the second spacing distance of the second pair of panel-defined connection counterparts 39 is 12 inches.

In some embodiments, for example, adjusting of the spacing from the first spacing to the second spacing is effected by displacement of the second connection counterpart 508 towards the first connection counterpart 504. In some embodiments, for example, adjusting of the spacing from the second spacing to the first spacing is effected by displacement of the second connection counterpart 508 away from the first connection counterpart 504.

In some embodiments, for example, adjusting of the spacing from the first spacing to the second spacing is effected by displacement of the second connection counterpart 508 away from the first connection counterpart 504. In some embodiments, for example, adjusting of the spacing from the second spacing to the first spacing is effected by displacement of the second connection counterpart 508 towards the first connection counterpart 504.

In some embodiments, for example, the first wall surface configuration and the second wall surface configuration are defined on the same wall panel assembly 10.

In some embodiments, for example, wherein the first wall surface configuration and the second wall surface configuration are defined on the same wall panel assembly 10, the first pair of panel-defined connection counterparts 39 is defined by a first panel-defined connection counterpart 39 and a second panel-defined connection counterpart 39, and the second pair of panel-defined connection counterpart 39 is defined by a third panel-defined connection counterpart 39 and a fourth panel-defined connection counterpart 39.

In some embodiments, for example, wherein the first wall surface configuration and the second wall surface configuration are defined on the same wall panel assembly 10, the first pair of panel-defined connection counterparts 39 is defined by a first panel-defined connection counterpart 39 and a second panel-defined connection counterpart 39, and the second pair of panel-defined connection counterpart 39 is defined by the first panel-defined connection counterpart 39 and a third panel-defined connection counterpart 39. In some embodiments, for example, wherein the first wall surface configuration and the second wall surface configuration are defined on the same wall panel assembly 10, the first pair of panel-defined connection counterparts 39 is defined by a first panel-defined connection counterpart 39 and a second panel-defined connection counterpart 39, and the second pair of panel-defined connection counterpart 39 is defined by the second panel-defined connection counterpart 39 and a third panel-defined connection counterpart 39.

In some embodiments, for example, the first wall surface configuration is defined on a first wall panel assembly 10, and the second wall surface configuration is defined on a second wall panel assembly 10 that is different from the first wall panel assembly 10.

In some embodiments, for example, the assembly 500 includes a mounting bracket 502. In some embodiments, for example, the first connection counterpart 504 is defined by the bracket 502. In this respect, in some embodiments, for example, the first connection counterpart 504 is a bracket connector 504 or a first bracket-defined connection counterpart 504.

In some embodiments, for example, the bracket 502 comprises a flange 503, as depicted in FIG. 30, to which a load supporter 530 of the assembly is connected. In some embodiments, for example, the flange 503 defines a front surface 505 and a rear surface 505A that is disposed on an opposite side of the flange 503 relative to the front surface 505. In some embodiments, for example, the front surface 505 defines a surface configured for being visible while the mounting assembly 500 is connected to the wall panel assembly 10 or panel 100. In some embodiments, for example, the rear surface 505A defines a panel-opposing surface configured for opposing the front facing surface 104 while the mounting assembly 500 is connected to the wall panel assembly 10 or panel 100. In some embodiments, for example, the front surface 505 is the front surface 505 of the bracket 502.

In some embodiments, for example, the flange 503 and the first connection counterpart 504 are connected. In some embodiments, for example, the bracket 502, comprising the flange 503 and the first connection counterpart 504, is of unitary one piece construction. In some embodiments, for example, the first connection counterpart 504 comprises: 1) a retaining member 510, defining a retaining surface 512, 2) a connecting member 514 defining a connecting member surface 516 and a seating surface 515, wherein the seating surface 515 is disposed on an opposite side of the connecting member 514, relative to the connecting member surface 516, and 3) an intermediate member 511, extending between the retaining member 510 and the connecting member 514, the intermediate member 511 having a member portion that defines an arcuate surface 513, wherein the connecting member 514 connects the retaining member 510 and the intermediate member 511 to the flange 503.

In some embodiments, for example, the retaining member 510 is configured to co-operate with one of the panel-defined connection counterparts 39 of the pair of first panel-defined connection counterparts 39 such that, while the bracket 502 is connected to the wall panel assembly configuration (e.g. while the retained configuration is established), the retaining surface 512 is disposed in opposing relationship with a retaining surface of the one of the panel-defined connection counterparts 39, for example, the retaining surface 134 of the cavity 130, of the pair of panel-defined connection counterparts 39, such that displacement of the mounting bracket 502, away from the wall surface configuration, is resisted.

In some embodiments, for example, as depicted in FIG. 32 and FIG. 34, while the retained configuration is established, the retaining surface 512 is disposed in engagement, for example, abutting engagement, with the retaining surface 134. In some embodiments, for example, as depicted in FIG. 32 and FIG. 34, while the retained configuration is established, the arcuate surface 513 is disposed in engagement, for example, abutting engagement, with the guide surface 136. In some embodiments, for example, while the retained configuration is established, the arcuate surface 513 is disposed in engagement, for example, abutting engagement, with the outer surface 72A of the first wall 72 of the rear wall configuration 70. In some embodiments, for example, as depicted in FIG. 32 and FIG. 34, while the retained configuration is established, the seating surface 515 is disposed in engagement, for example, abutting engagement, with the support surface 142.

In some embodiments, for example, as depicted in FIG. 32 and FIG. 34, while the retained configuration is established, the retaining surface 512 is bearing against the retaining surface 134. In some embodiments, for example, as depicted in FIG. 32 and FIG. 34, while the retained configuration is established, the arcuate surface 513 is bearing against the guide surface 136. In some embodiments, for example, while the retained configuration is established, the arcuate surface 513 is bearing against the outer surface 72A of the first wall 72 of the rear wall configuration 70. In some embodiments, for example, as depicted in FIG. 32 and FIG. 34, while the retained configuration is established, the seating surface 515 is bearing against the support surface 142.

In this respect, while the retained configuration is established, the fit of the first connection counterpart 504 in the cavity 130 is a friction fit. In some embodiments, for example, while the retained configuration is established, the fit of the first connection counterpart 504 in the cavity 130 is an interference fit.

In some embodiments, for example, the tight fit or snug fit of the first connection counterpart 504 in the cavity 130 is to interfere with displacement of the first connection counterpart 504, relative to the cavity 130, and therefore, interfere with displacement of the bracket 502, relative to the cavity 130, such that displacement of the bracket 502, relative to the cavity 130, while a load that is mounted to the load supporter 530, is resisted.

In some embodiments, for example, the retaining surface 512, the retaining surface 134, the arcuate surface 513, and the guide surface 136 are co-operatively configured such that, while the retained configuration is established, forwardly or rearwardly displacement of the bracket 502, relative to the panel 100, in a direction that is parallel to a perpendicular axis of the front facing surface 104 (e.g. parallel to a perpendicular axis of the front facing surface 105 of the residual front facing wall portion 15), is resisted.

In some embodiments, for example, the arcuate surface 513 and the guide surface 136 are co-operatively configured such that, while the retained configuration is established, rotation of the bracket 502, relative to the panel 100, about a rotation axis that is parallel to a perpendicular axis of the front facing surface 104 (e.g. parallel to a perpendicular axis of the front facing surface 105 of the residual front facing wall portion 15), is resisted.

In some embodiments, for example, the seating surface 515 and the supporting surface 142 are co-operatively configured such that, while the retained configuration is established, rotation of the bracket 502, relative to the panel 100, about a rotation axis that is parallel to a perpendicular axis of the front facing surface 104 (e.g. parallel to a perpendicular axis of the front facing surface 105 of the residual front facing wall portion 15), is resisted.

In some embodiments, for example, the arcuate surface 513, the guide surface 136, the seating surface 515, and the supporting surface 142 are co-operatively configured such that, while the retained configuration is established, rotation of the bracket 502, relative to the panel 100, about a rotation axis that is parallel to a perpendicular axis of the front facing surface 104 (e.g. parallel to a perpendicular axis of the front facing surface 105 of the residual front facing wall portion 15), is resisted.

In some embodiments, for example, as depicted in FIG. 32 and FIG. 34, while the retained configuration is established, the flange 503 and the front facing wall 14 are disposed in opposing relationship. In some embodiments, for example, as depicted in FIG. 32 and FIG. 34, while the retained configuration is established, the flange 503 and the front facing wall 14 are disposed in abutting engagement. In some embodiments, for example, as depicted in FIG. 32 and FIG. 34, while the retained configuration is established, the flange 503 is bearing against the front facing wall 14.

In some embodiments, for example, the retaining surface 512 defines a perpendicular axis, the connecting member surface 516 defines a perpendicular axis, and an acute angle defined between the perpendicular axis of the retaining surface 512 and the perpendicular axis of the connecting member surface 516 has a maximum value of 85 degrees.

In some embodiments, for example, the first connection counterpart 504 is an L-shaped first connection counterpart 504. In some embodiments, for example, the retaining member 510 and the connecting member 514 are disposed in a non-perpendicular relationship.

In some embodiments, for example, the assembly comprises a connection counterpart-defining configuration 506. In some embodiments, for example, the bracket 502 is releasably couplable to the connection counterpart-defining configuration 506. In some embodiments, for example, while the bracket 502 is releasably coupled to the connection counterpart-defining configuration 506, the mounting assembly 500 is defined. In some embodiments, for example, the releasable coupling of the bracket 502 and the connection counterpart-defining configuration 506 is such that the connection counterpart-defining configuration 506 slidably coupled to the bracket 502.

As depicted in FIG. 30, the second connection counterpart 508 is defined by the connection counterpart-defining configuration 506. As depicted in FIG. 30 and FIG. 35 to FIG. 38, in some embodiments, for example, the connection counterpart-defining configuration 506 includes an intermediate member 507. In some embodiments, for example, the second connection counterpart 508 is connected to the intermediate member 507. In some embodiments, for example, the connection counterpart-defining configuration 506, which includes the second connection counterpart 508 and the intermediate member 507, is of unitary one piece construction.

The bracket 502, for example, the flange 503, is releasably couplable to the connection counterpart-defining configuration 506, such that, while the bracket 502 and the connection counterpart-defining configuration 506 are releasably coupled, the relative displacement is effectible between the bracket 502 and the connection counterpart-defining configuration 506. In some embodiments, for example, adjusting of the spacing between the first and second connection counterparts 504 and 508 is effectible by relative displacement between the bracket 502 and the connection counterpart-defining configuration 506. In some embodiments, for example, the relative displacement effectible between the bracket 502 and the connection counterpart-defining configuration 506 includes sliding displacement.

In some embodiments, for example, the assembly 500 includes a locking mechanism 520. In some embodiments, for example, the locking mechanism 520 includes a rotatable head 520A, and a threaded rod or stud that is releasably couplable to the rotatable head 520A via the threading at a first end, and that is also connected to the connection counterpart-defining configuration 506, for example, the intermediate member 507, via welding, at the second end. As depicted in FIG. 30 and FIG. 35, the intermediate member 507 is disposed on a first side of the flange 503 (e.g. rear side of the flange 503), and the rotatable head 520A is disposed on a second side of the flange 503 that is opposite the first side (e.g. front side of the flange 503). In some embodiments, for example, the locking mechanism 520 is configured to effect frictional engagement between the bracket 502, for example, the flange 503, and the intermediate member 507, and further configured to defeat the frictional engagement between the bracket 502, for example, the flange 503, and the intermediate member 507.

The bracket 502, the connection counterpart-defining configuration 506, and the locking mechanism 520 are co-operatively configured to transition between a displacement-effective configuration and a displacement ineffective configuration. In the displacement effective configuration, the bracket 502, the connection counterpart-defining configuration 506, and the locking mechanism 520 are co-operatively configured such that there is an absence of frictional engagement of the flange 503 and the intermediate member 507 by the locking mechanism 520, such that the assembly 500 is disposed in the adjustable configuration, wherein the connection counterpart-defining configuration 506 is displaceable relative to the bracket 502. In the displacement ineffective configuration, the bracket 502, the connection counterpart-defining configuration 506, and the locking mechanism 520 are co-operatively configured such that frictional engagement of the flange 503 and the intermediate member 507 is effected by the locking mechanism 520, such that the assembly 500 is disposed in the fixed configuration, wherein relative displacement between the connection counterpart-defining configuration 506 and the bracket 502 is resisted.

In some embodiments, for example, the bracket 502, the connection counterpart-defining configuration 506, and the locking mechanism 520 are transitionable from the displacement effective configuration to the displacement-ineffective configuration in response to actuation of the locking mechanism 520, for example, by rotation of the head 520A in a first direction, for example, a clockwise direction. In some embodiments, for example, in response to actuation of the locking mechanism 520 in the first direction, a force is applied by the locking mechanism 520 to the connection counterpart-defining configuration 506 to displace the connection counterpart-defining configuration 506 towards the bracket 502, such that at the intermediate member 507 becomes disposed in frictional engagement with the flange 503, with effect that the assembly 500 becomes disposed in the fixed configuration.

In some embodiments, for example, the bracket 502, the connection counterpart-defining configuration 506, and the locking mechanism 520 are transitionable from the displacement ineffective configuration to the displacement effective configuration in response to actuation of the locking mechanism 520, for example, by rotation of the head 520A in a second direction that is opposite the first direction, for example, a counter clockwise direction. In some embodiments, for example, in response to actuation of the locking mechanism 520 in the second direction, a force is applied by the locking mechanism 520 to the connection counterpart-defining configuration 506 to displace the connection counterpart-defining configuration 506 away from the bracket 502, such that frictional engagement between the flange 503 and the intermediate member 507 is defeated, with effect that the assembly 500 becomes disposed in the fixed configuration.

In some embodiments, for example, the bracket 502 includes a slot 524. As depicted, in some embodiments, for example, the slot 524 is a linear slot. As depicted, the slot 524 is defined by the flange 503. The slot 524 extends from a bottom end of the flange 503. As depicted in FIG. 30, the slot 524 extends from the bottom end of the flange 503 to the middle of the flange 503. In some embodiments, for example, the length of the slot 524 is generally half the length of the flange 503. The slot 524 is configured to receive at least a portion of the threaded stud of the locking mechanism 520, such that the threaded stud extends through the slot 524, such that, while the rotatable head 520A is releasably coupled to the threaded stud via the threading, the bracket 502 and the connection counterpart-defining configuration 506 are releasably coupled, and the intermediate member 507 is disposed on the first side of the flange 503 (e.g. rear side of the flange 503), and the rotatable head 520A is disposed on the second side of the flange 503 that is opposite the first side (e.g. front side of the flange 503). In some embodiments, for example, the slot 524 limits displacement of the threaded stud of the locking mechanism 520, and therefore, limits the displacement of the connection counterpart-defining configuration 506, relative to the bracket 502. In some embodiments, for example, the slot 524 defines an upper terminal end that limits further upward displacement of the threaded stud of the locking mechanism 520 and therefore, limits further upward displacement of the connection counterpart-defining configuration 506, relative to the bracket 502. In some embodiments, for example, the slot 524 defines a lower terminal end that limits further downward displacement of the threaded stud of the locking mechanism 520 and therefore, limits further downward displacement of the connection counterpart-defining configuration 506, relative to the bracket 502.

In some embodiments, for example, the flange 503 includes a raised portion 521 that defines a recess 522 for receiving at least a portion of the connection counterpart-defining configuration 506, in particular, for receiving at least a portion of the intermediate member 507. While the bracket 502 and the connection counterpart-defining configuration 506 are releasably coupled, at least a portion of the intermediate member 507 is received in the recess 522.

In some embodiments, for example, the flange 503 includes the recess 522 for receiving at least a portion of the intermediate member 507, while the bracket 502 and the connection counterpart-defining configuration 506 are releasably coupled, such that, while the bracket 502 and the connection counterpart-defining configuration 506 are releasably coupled, the intermediate member 507 is not disposed rearwardly of the rear surface 505A of the flange 503. In some embodiments, for example, it is desirable for the intermediate member 507 to not be disposed rearwardly of the rear surface 505A of the flange 503, while the bracket 502 and the connection counterpart-defining configuration 506 are releasably coupled, as disposition of the intermediate member 507 rearwardly of the rear surface 505A, while the bracket 502 and the connection counterpart-defining configuration 506 are releasably coupled, interferes with the securing of the mounting assembly 500 to the wall panel assembly 10 or the panel 100.

In some embodiments, for example, the recess 522 and the connection counterpart-defining configuration 506 are co-operatively configured such that the connection counterpart-defining configuration 506 is slidable, relative to the bracket 502, while the at least a portion of the connection counterpart-defining configuration 506, for example, the intermediate member 507, is received in the recess 522.

As depicted, in some embodiments, for example, the slot 524 is defined by the raised portion 521.

In some embodiments, for example, the assembly 500 is configurable in a retracted configuration, an extended configuration, and an intermediate configuration. In the retracted configuration, the spacing distance between the first connection counterpart 504 and the second connection counterpart 508 is a minimum spacing distance, as depicted in FIG. 30 and FIG. 35. In some embodiments, for example, the bracket 502, the locking mechanism 520, and the connection counterpart-defining configuration 506 are co-operatively configured such that, while the locking mechanism 520, for example, the threaded stud, is disposed at the upper terminal end of the slot 524, the assembly 500 is disposed in the retracted configuration. In some embodiments, for example, while the assembly 500 is disposed in the retracted configuration, the intermediate member 507 is entirely disposed in the recess 522, for example, as depicted in FIG. 35. In the extended configuration, the spacing distance between the first connection counterpart 504 and the second connection counterpart 508 is a maximum spacing distance, as depicted in FIG. 36. In some embodiments, for example, the bracket 502, the locking mechanism 520, and the connection counterpart-defining configuration 506 are co-operatively configured such that, while the locking mechanism 520, for example, the threaded stud, is disposed at the lower terminal end of the slot 524, the assembly 500 is disposed in the extended configuration. In the intermediate configuration, the spacing distance between the first connection counterpart 504 and the second connection counterpart 508 is between the minimum spacing distance and the maximum spacing distance. In some embodiments, for example, the bracket 502, the locking mechanism 520, and the connection counterpart-defining configuration 506 are co-operatively configured such that, while the locking mechanism 520, for example, the threaded stud, is disposed between the upper terminal end and the lower terminal end of the slot 524, the assembly 500 is disposed in the intermediate configuration.

In some embodiments, for example, the minimum and maximum spacing distances between the first connection counterpart 504 and the second connection counterpart 508 is defined based on: 1) the length of the slot 524, 2) the position of the slot 524 on the flange 503, and 2) the length of the intermediate member 507.

In some embodiments, for example, the bracket 502 and the connection counterpart-defining configuration 506 are co-operatively configured such that the minimum spacing distance between the first connection counterpart 504 and the second connection counterpart 508 is 1 inch, and the maximum spacing distance between the first connection counterpart 504 and the second connection counterpart 508 is 12 inches.

In some embodiments, for example, for a given length of the slot 524, a decrease in length of the intermediate member 507 decreases the minimum and maximum spacing distances between the first connection counterpart 504 and the second connection counterpart 508, and an increase in length of the intermediate member 507 increases the minimum and maximum spacing distances between the first connection counterpart 504 and the second connection counterpart 508.

In some embodiments, for example, for a given length of the intermediate member 507, and for a slot 524 that extends from the bottom of the flange 503 in an upward direction, a decrease in length of the slot 524 increases the minimum spacing distance between the first connection counterpart 504 and the second connection counterpart 508, but does not increase the maximum spacing distance between the first connection counterpart 504 and the second connection counterpart 508, and an increase in length of the slot 524 decreases the minimum spacing distance between the first connection counterpart 504 and the second connection counterpart 508, but does not decrease the maximum spacing distance between the first connection counterpart 504 and the second connection counterpart 508.

In some embodiments, for example, the mounting assembly 500 includes a load supporter 530. In some embodiments, for example, the load supporter 530 is connected to the bracket 502, for example, the flange 530, for example, by welding, mechanical fasteners, adhesives, and the like. The load supporter 530 includes a load-supporting portion 532, the load-supporting portion configured to support a load, such as tires, storage boxes and bins, tools, sports equipment, outdoor equipment, lumber, clothes, appliances, pool accessories and toys, and the like. As depicted in FIG. 30, in some embodiments, for example the load supporter 530 includes two hooks. In some embodiments, for example, the load supporter includes 530 one hook. In some embodiments, for example, the load supporter includes 530 a ring from which a load is hung. In some embodiments, for example, the load supporter includes 530 a ring from which a load is received. In some embodiments, for example, the load supporter 300 includes a basket in which a load is received. In some embodiments, for example, the load supporter 300 includes a rod on which a load is supported, for example, a rod to hang clothes.

In some embodiments, for example, as depicted in FIG. 30, FIG. 32, and FIG. 36, the load-supporting portion 532 extends outwardly, relative to the front surface 505 of the flange 503. In some embodiments, for example, the load-supporting portion 532 extends outwardly, relative to the front surface 505 of the flange 503, along a plane that is perpendicular to a plane defined by the front surface 505 of the flange 503. In some embodiments, for example, the load-supporting portion 532 extends in a direction along an axis 534 that traverses a plane defined by the front surface 505 of the flange 503. In some embodiments, for example, the traversing of the plane defined by the front surface 505 of the flange 503 by the extension axis of the load-supporting portion 532 is such that the axis 534 is normal to the plane defined by the front surface 505 of the flange 503. In some embodiments, for example, the traversing of the plane defined by the front surface 505 of the flange 503 by the extension axis 534 of the load-supporting portion 532 is such that the axis 534 is angled relative to the plane defined by the front surface 505 of the flange 503, the axis 534 and the plane defining an acute angle (e.g. the load supporting portion 532 extends from the flange 503 in a direction to the left or to the right). In some embodiments, for example, the acute angle defined between the axis 534 and the plane defined by the front surface 505 of the flange 503 has a minimum value of at least 60 degrees.

In some embodiments, for example, as depicted in FIG. 32, the load-supporting portion 532 extends outwardly and in an upward direction, relative to the front surface 505 of the flange 503. In this respect, in some embodiments, for example, the axis 534 is angled upwardly relative to a normal axis of the plane defined by the front surface 505 of the flange 503, the axis 534 and the normal axis defining an acute angle therebetween. In some embodiments, for example, the acute angle defined between the axis 534 and the normal axis of the plane defined by the front surface 505 of the flange 503 has a minimum value of at least 1 degree.

In some embodiments, for example, the load-supporting portion 532 extends outwardly and in a downward direction, relative to the front surface 505 of the flange 503. In this respect, in some embodiments, for example, the axis 534 is angled downwardly relative to a normal axis of the plane defined by the front surface 505 of the flange 503, the axis 534 and the normal axis defining an acute angle therebetween. In some embodiments, for example, the acute angle defined between the axis 534 and the normal axis of the plane defined by the front surface 505 of the flange 503 has a maximum value of 5 degrees.

In some embodiments, for example, the load supporter 530 includes a load-retaining portion 536, configured to resist removal of a load that is supported by the load-supporting portion 532. As depicted in FIG. 30 and FIG. 32, the load-retaining portion 536 is angled relative to the load-supporting portion 532. In some embodiments, for example, the acute angle defined between load supporting portion 532 and the load-retaining portion 536 has a minimum value of at least 5 degrees. Due to the angled disposition of the load-retaining portion 536, relative to the load-supporting portion 532, while a load is supported by the load-supporting portion 532, if the load is displaced in a direction that is parallel to the axis 534, the load will engage the load-retaining portion 536, which will resist further displacement of the load in the direction that is parallel to the axis 534. To remove the load, the direction of displacement of the load is to be changed, in particular, to a direction along an axis of extension of the load-retaining portion 536, which is angled relative to the axis 534.

In some embodiments, for example, the mounting assembly 500 includes one bracket 502, and a load supporter 530, for example, one or more hooks, baskets, hanging rods, and the like, that is connected to the bracket 502, and further includes one connection counterpart-defining configuration 506 that is releasably coupled to the bracket 502. In such embodiments, for example, while the mounting assembly 500 is secured to a wall panel assembly 10 or panel 100, the load that is supported by the load supporter 530 is distributed to the wall panel assembly 10 or panel 100 via the bracket 502.

In some embodiments, for example, the mounting assembly 500 includes one bracket 502, and a load supporter 530, for example, one or more hooks, baskets, hanging rods, and the like, that is connected to the bracket 502, and further includes more than one connection counterpart-defining configuration 506 that is releasably coupled to the bracket 502. In such embodiments, for example, for each one of the plurality of connection counterpart-defining configuration 506, the flange 503 defines a recess 522 for receiving the intermediate member 507, and further defines a slot 524 for receiving the threaded stud of the connection counterpart-defining configuration 506 and defining the minimum and maximum spacing distances between the first connection system counterpart 504 and the second connection system counterpart 508 of the connection counterpart-defining configuration 506. In such embodiments, for example, while the mounting assembly 500 is secured to a wall panel assembly 10 or panel 100, the load that is supported by the load supporter 530 is distributed to the wall panel assembly 10 or panel 100 via the bracket 502.

In some embodiments, for example, the mounting assembly 500 includes more than one bracket 502, and a load supporter 530, for example, one or more hooks, baskets, hanging rods, and the like, that is connected to the brackets 502, and, for each one of the brackets 502, independently, the assembly 500 further includes a connection counterpart-defining configuration 506 that is connected to the bracket 502. In such embodiments, for example, while the mounting assembly 500 is secured to a wall panel assembly 10 or panel 100, the load that is supported by the load supporter 530 is distributed to the wall panel assembly 10 or panel 100 via the plurality of brackets 502.

To connect the assembly 500 to a wall panel assembly 10, as depicted in FIG. 32, the spacing of the first connection counterpart 504 and the second connection counterpart 508 is adjusted to correspond to the spacing distance between a pair of cavities 130, the pair of cavities 130 including an upper cavity 130 and a lower cavity 130, wherein the upper cavity 130 is disposed above the lower cavity 130 while the wall panel assembly 10 is connected to a wall. As depicted, the upper cavity 130 is the cavity 130 of a panel 100 (e.g. an upper panel 100), and the lower cavity 130 is the cavity 130 of an adjacent panel 100 (e.g. a lower panel 100). Then, the first connection counterpart 504 is inserted into the upper cavity 130 and rotated, relative to the wall panel assembly 10, to retain the bracket 502 to the wall panel assembly 10, as described herein. At this point, the bracket 502 is hanging from the wall panel assembly 10, wherein the bracket 502 is vertically supported by the wall panel assembly 10, and displacement of the bracket 502, relative to the wall panel assembly 10, in a direction that is normal to the outermost surface of the wall panel assembly 10, is opposed. At the same time, the second connection counterpart 508 is disposed into the lower cavity 130, as depicted in FIG. 32. To secure the bracket 502 to the wall panel assembly 10, the spacing of the first connection counterpart 504 and the second connection counterpart 508, while the first connector counterpart 504 is disposed in the upper cavity 130 and the second connection counterpart 508 is disposed in the lower cavity 130, is adjusted, for example, decreased, such that the mounting assembly 500 is gripping the wall panel assembly 10. In some embodiments, for example, the adjusting of the spacing between the first connection counterpart 504 and the second connection counterpart 508 to grip the wall panel assembly 10 is with effect that: 1) at least a portion of the retaining surface defining configuration 122 of the lower panel 100, and 2) at least a portion of the interacting portion 60 of the upper panel 100, are disposed in the channel 509 of the second connection counterpart 508. In this respect, in some embodiments, for example, the panel-defined connection counterpart 39 includes the retaining surface defining configuration 122 of the lower panel 100, and, in some embodiments, for example, the panel-defined connection counterpart 39 includes the interacting portion 60 of the upper panel 100. In some embodiments, for example, while the first connection counterpart 504 is disposed in the upper cavity 130, such that the retained configuration is established, the first connection counterpart 504, the guiding surface 136, and the retaining surface 134 of the upper panel 100 are co-operatively configured to resist forwardly or rearwardly displacement of the first connection counterpart 504, in a direction parallel to the front facing surface 104, while the spacing between the first connection counterpart 504 and the second connection counterpart 508 is being adjusted. In some embodiments, for example, while the second connection counterpart 508 is disposed in the lower cavity 130, and while the retaining surface defining configuration 122 of the lower panel is disposed in the channel 509, the second connection counterpart 508 and the retaining surface defining configuration 122 of the lower panel 100 co-operate to oppose forwardly or rearwardly displacement of the second connection counterpart 508, in a direction parallel to the front facing surface 104. In some embodiments, for example, while the second connection counterpart 508 is disposed in the lower cavity 130, and while the retaining surface defining configuration 122 of the lower panel is disposed in the channel 509, the second connection counterpart 508 and the retaining surface 134 of the lower panel 100 co-operate to oppose rotation of the bracket 502, relative to the wall panel assembly 10, in the direction away from the wall panel assembly 10. At this point, while the bracket 502 is gripping the wall panel assembly 10, the assembly 500 is transitioned from the adjustable configuration to the fixed configuration, for example, via actuation of the locking mechanism 520, to secure the assembly 500 to the wall panel assembly 10. In some embodiments, for example, while the assembly 500 is secured to the wall panel assembly 10, a load that is supported by the load supporter 530 is supported by the wall panel assembly 10 via the assembly 500 that is secured to the wall panel assembly 10. In some embodiments, for example, while the assembly 500 is secured to the wall panel assembly 10, rotation of the assembly 500, for example, the bracket 502, relative to the wall panel assembly 10, is resisted. In some embodiments, for example, by resisting rotation of the assembly 500, for example, the bracket 502 relative to the wall panel assembly 10, the securing of the assembly 500 to the wall panel assembly 10 secures the retention of the assembly 500 to the wall panel assembly 10, and resists disconnection, for example, accidental disconnection, of the assembly 500 from the wall panel assembly 10.

In some embodiments, for example, while the spacing between the first connection counterpart 504 and the second connection counterpart 508 are gripping the wall panel assembly 10, the assembly 500 is disposed in the intermediate configuration.

In some embodiments, for example, the hanging and securing of the assembly 500 to the wall panel assembly 10 or the panel 100 is effectible without the use of fasteners, for example, mechanical fasteners.

In some embodiments, for example, to release the assembly 500 from the wall panel assembly 10, the assembly 500 is transitioned from the fixed configuration to the adjustable configuration, for example, via actuation of the locking mechanism 520, and the spacing between the first connection counterpart 504 and the second connection counterpart 508 is adjusted, for example, increased, such that the assembly 500 is no longer gripping the wall panel assembly 10, and is rotatable relative to the wall panel assembly 10. At this point, the assembly 500 is released from retention from the wall panel assembly 10, for example, by rotating the bracket connector 504 via rotation of the bracket 502 away from the wall panel assembly 10, and displacing the assembly 500 from the upper cavity 130 of the wall panel assembly 10. In some embodiments, for example, while the assembly 500 is released from the wall panel assembly 10, the assembly 500 is repositionable to another part of the wall panel assembly 10 and connectible to the wall panel assembly 10 at said another part of the wall panel assembly 10, or is repositionable to another wall panel assembly 10 and connectible to said another wall panel assembly 10.

The assembly 500 can be hung, retained, and secured to a panel 100 that includes more than one cavity 130, and can be released from the panel 100, similar to the manner in which the mounting assembly 500 is hung, retained, secured, and released from the wall panel assembly 10.

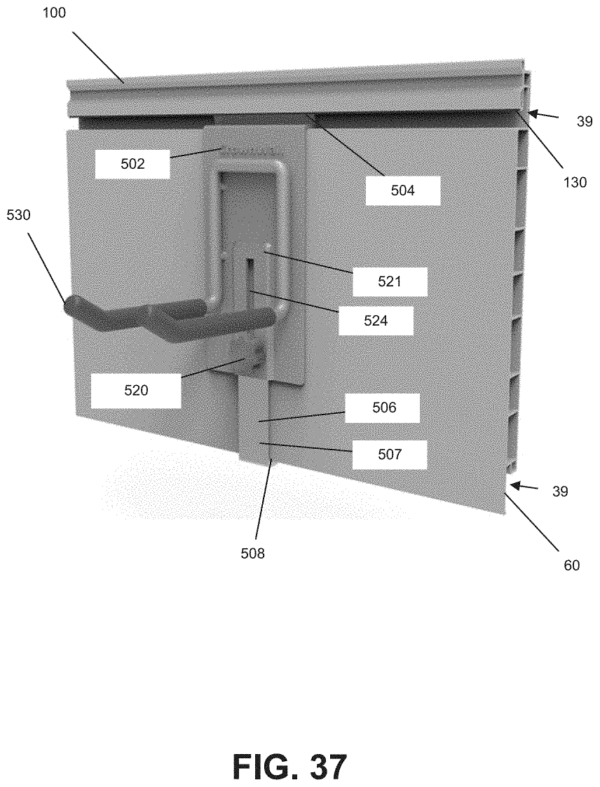

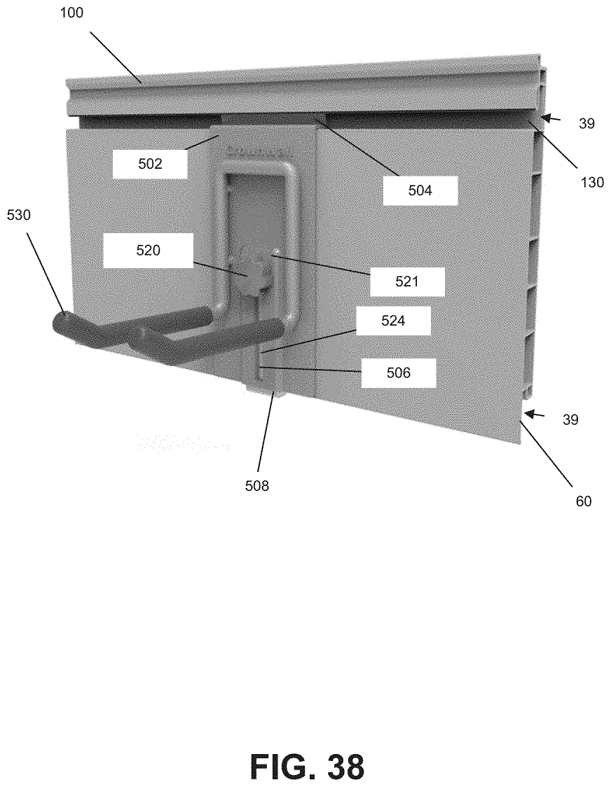

As depicted in FIG. 37 and FIG. 38, the assembly 500 can be hung, retained, and secured to a panel 100, and can be released from the panel 100, similar to the manner in which the assembly 500 is hung, retained, secured, and released from the wall panel assembly 10. In some embodiments, for example, the assembly 500 is connectible to a panel described herein, for example, the panels 100 to 100F. In such embodiments for example, the first connection counterpart 504 is connectible to the cavity 130 of the panel, and the second connection counterpart 508 is connectible to the interacting portion 60 of the panel 100. In this respect, the pair of panel-defined connection counterparts 39 includes the cavity 130 and the space disposed rearwardly of the interacting portion 60 of the panel 100. In some embodiments, for example, the assembly 500 is secured to the panel in a manner similar to securing the assembly 500 to the wall panel assembly 10, except, in some embodiments, for example, the adjusting of the spacing between the first connection counterpart 504 and the second connection counterpart 508 to grip the panel 100 is with effect that at least a portion of the interacting portion 60, for example, the second connection system counterpart 158 (e.g. the projection 158) of the second connection system 34, and at least a portion of the covering portion 154, are disposed in the channel 509 of the second connection counterpart 508.

Accordingly, the spacing distance between the first connection counterpart 504 and the second connection counterpart 508 is adjustable such that the assembly 500 is connectible and securable to the first wall surface configuration having the first pair of panel-defined connection counterparts 39 spaced apart by the first spacing distance, for example, as depicted in FIG. 37, and such that the assembly 500 is also connectible and securable to the second wall surface configuration having the second pair of panel-defined connection counterparts 39 spaced apart by the second spacing distance, for example, as depicted in FIG. 38. As depicted, the first spacing distance and the second spacing distance are different.

In some embodiments, for example, the material of the bracket 502 includes steel.

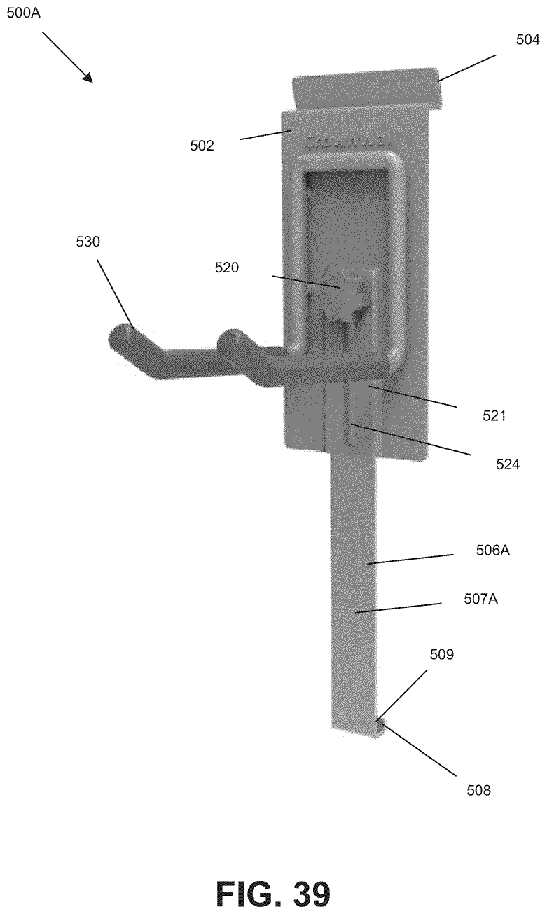

FIG. 39 to FIG. 41 depict a mounting assembly 500A that is an embodiment of the mounting assembly 500 as depicted in FIG. 30 to FIG. 38. The mounting assembly 500A substantially corresponds to the mounting assembly 500, except the intermediate member 507A of the connection counterpart-defining configuration 506A of the mounting assembly 500A is longer than the intermediate member 507 of the connection counterpart-defining configuration 506 of the mounting assembly 500, such that the mounting assembly 500A is connectible to a pair of panel-defined connection counterparts 39 that are spaced relatively far apart. In some embodiments, for example, the intermediate member 507A is shorter than the intermediate member 507. In some embodiments, for example, the length of the intermediate member 507A of the connection counterpart-defining configuration 506A is based on the spacing between the pairs of panel-defined connection counterparts 39 to which the mounting assembly 500A is to be connected.

The mounting assembly 500A can be connected to, and secured to, a wall panel assembly 10 or a panel 100, similar to the manner by which the connection and securing between the mounting assembly 500 to the wall panel assembly 10 or the panel 100, is established.

In some embodiments, for example, the mounting assembly 500A can be assembled from the mounting assembly 500. In such embodiments, for example, the connection counterpart-defining configuration 506 is disconnected from the bracket 502, by decoupling the rotatable head 520A of the locking mechanism 520 from the threaded stud that is connected to the connection counterpart-defining configuration 506 of the mounting assembly 500. At this point, the connection between the bracket 502 and the connection counterpart-defining configuration 506 is defeated, and the connection counterpart-defining configuration 506 is separated from the bracket 502. Then, the connection counterpart-defining configuration 506A is connected to the bracket 502. To connect the connection counterpart-defining configuration 506A to the bracket 502, the threaded stud is received through the slot 524 of the bracket, and the rotatable head 520A is connected to the threaded stud of the connection counterpart-defining configuration 506A. At this point, the bracket 502 and the connection counterpart-defining configuration 506A are releasably coupled, and the assembly 500A is defined.

Accordingly, the bracket 502 is releasably couplable to the connection counterpart-defining configuration 506, and also releasably couplable to the connection counterpart-defining configuration 506A, for defining the assembly 500 and the assembly 500A, respectively.

While the bracket 502 is releasably coupled to the connection counterpart-defining configuration 506A, the mounting assembly 500A is defined, wherein the mounting assembly 500A is configurable in a fixed configuration and an adjustable configuration, similar to the mounting assembly 500.

In the fixed configuration, the releasably coupling between the bracket 502 and the connection counterpart-defining configuration 506A is such that there is an absence of displaceability of the connection counterpart-defining configuration 508 of the connection counterpart-defining configuration 506A, relative to the bracket 502, such that there is an absence of adjustability of the spacing between the connection counterparts 504 and 508.

In the adjustable configuration, the releasably coupling between the bracket 502 and the connection counterpart-defining configuration 506A is such that the connection counterpart-defining configuration 506A is displaceable, relative to the bracket 502, such that spacing between the connection counterparts 504 and 508 is adjustable between at least a third spacing and a fourth spacing, wherein:

in the third spacing, the connection counterparts 504 and 508 are disposed for connection to a third wall surface configuration having a third pair of panel-defined connection counterparts 39 spaced apart by a third spacing distance;

in the fourth spacing, the connection counterparts 504 and 508 are disposed for connection to a fourth wall surface configuration having a fourth pair of panel-defined connection counterparts 39 spaced apart by a fourth spacing distance.

In some embodiments, for example, the third spacing distance of the third pair of panel-defined connection counterparts 39 is different from the fourth spacing distance of the fourth pair of panel-defined connection counterparts 39.

In some embodiments, for example, adjusting of the spacing from the third spacing to the fourth spacing is effected by displacement of the second connection counterpart 508 towards the first connection counterpart 504. In some embodiments, for example, adjusting of the spacing from the fourth spacing to the third spacing is effected by displacement of the second connection counterpart 508 away from the first connection counterpart 504.

In some embodiments, for example, adjusting of the spacing from the third spacing to the fourth spacing is effected by displacement of the second connection counterpart 508 away from the first connection counterpart 504. In some embodiments, for example, adjusting of the spacing from the fourth spacing to the third spacing is effected by displacement of the second connection counterpart 508 towards the first connection counterpart 504.

In some embodiments, for example, the first spacing distance of the first pair of panel-defined connection counterparts 39, to which the mounting assembly 500 is connectible, is different from the third spacing distance of the third pair of panel-defined connection counterparts 39, to which the mounting assembly 500A is connectible.

In some embodiments, for example, the second spacing distance of the second pair of panel-defined connection counterparts 39, to which the mounting assembly 500 is connectible, is different from the third spacing distance of the third pair of panel-defined connection counterparts 39, to which the mounting assembly 500A is connectible.

In some embodiments, for example, the first spacing distance of the first pair of panel-defined connection counterparts 39, to which the mounting assembly 500 is connectible, is different from the fourth spacing distance of the fourth pair of panel-defined connection counterparts 39, to which the mounting assembly 500A is connectible.

In some embodiments, for example, the second spacing distance of the second pair of panel-defined connection counterparts 39, to which the mounting assembly 500 is connectible, is different from the fourth spacing distance of the fourth pair of panel-defined connection counterparts 39, to which the mounting assembly 500A is connectible.

In some embodiments, for example, each one of the first wall surface configuration, the second wall surface configuration, the third wall surface configuration, and the fourth wall surface configuration is defined on the same wall panel assembly 10.

In some embodiments, for example, wherein each one of the first wall surface configuration, the second wall surface configuration, the third wall surface configuration, and the fourth wall surface configuration is defined on the same wall panel assembly 10, the first pair of panel-defined connection counterparts 39 is defined by a first panel-defined connection counterpart 39 and a second panel-defined connection counterpart 39, the second pair of panel-defined connection counterpart 39 is defined by a third panel-defined connection counterpart 39 and a fourth panel-defined connection counterpart 120, the third pair of panel-defined connection counterpart 39 is defined by a fifth panel-defined connection counterpart 39 and a sixth panel-defined connection counterpart 39, and the fourth pair of panel-defined connection counterpart 39 is defined by a seventh panel-defined connection counterpart 39 and a eighth panel-defined connection counterpart 120.

In some embodiments, for example, wherein each one of the first wall surface configuration, the second wall surface configuration, the third wall surface configuration, and the fourth wall surface configuration is defined on the same wall panel assembly 10, the first pair of panel-defined connection counterparts 39 is defined by a first panel-defined connection counterpart 39 and a second panel-defined connection counterpart 39, the second pair of panel-defined connection counterpart 39 is defined by the first panel-defined connection counterpart 39 and a third panel-defined connection counterpart 120, the third pair of panel-defined connection counterpart 39 is defined by the first panel-defined connection counterpart 39 and a fourth panel-defined connection counterpart 39, and the fourth pair of panel-defined connection counterpart 39 is defined by the first panel-defined connection counterpart 39 and a fifth panel-defined connection counterpart 120.

In some embodiments, for example, at least one of the first, second, third, and fourth wall configuration is defined on a first wall panel assembly 10, and at least one of the other of the first, second, third, and fourth wall configuration is defined on a second wall panel assembly 10.

In some embodiments, for example, the first wall surface configuration is defined on a first wall panel assembly 10, and each one of the second wall surface configuration, the third wall surface configuration, and the fourth wall surface configuration is on a second wall panel assembly 10.

In some embodiments, for example, each one of the first wall surface configuration, the second wall surface configuration, and the third wall surface configuration are defined on a first wall panel assembly 10, and the fourth wall surface configuration is on a second wall panel assembly 10.

In some embodiments, for example, each one of the first wall surface configuration and the second wall surface configuration is defined on a first wall panel assembly 10, and each one of the third wall surface configuration and the fourth wall surface configuration is on a second wall panel assembly 10.

In some embodiments, for example, the first wall surface configuration is defined on a first wall panel assembly 10, the second wall surface configuration is defined on a second wall panel assembly 10, and each one of the third wall surface configuration and the fourth wall surface configuration is on a third wall panel assembly 10.

In some embodiments, for example, each one of the first wall surface configuration and the third wall surface configuration is defined on a first wall panel assembly 10, and each one of the second wall surface configuration and the fourth wall surface configuration is on a second wall panel assembly 10.

In some embodiments, for example, the first wall surface configuration is defined on a first wall panel assembly 10, the second wall surface configuration is defined on a second wall panel assembly 10, the third wall surface configuration is defined on a third wall panel assembly 10, and the fourth wall surface configuration is defined on a fourth wall panel assembly 10.

In some embodiments, for example, the first wall surface configuration is defined on a first wall panel assembly 10, the second wall surface configuration and the third wall surface configuration are defined on a second wall panel assembly 10, and the fourth wall surface configuration is defined on a third wall panel assembly 10.

In some embodiments, for example, wherein at least two of the first, second, third, and fourth wall surface configurations are defined on the same panel, two of the at least two of the first, second, third, and fourth wall surface configurations share a common panel-defined connection counterpart 39. In some embodiments, for example, wherein the third wall surface configuration and the fourth wall surface configuration are defined on the same wall panel assembly 10, the third pair of panel-defined connection counterparts 39 is defined by a first panel-defined connection counterpart 39 and a second panel-defined connection counterpart 39, and the fourth pair of panel-defined connection counterpart 39 is defined by the first panel-defined connection counterpart 39 and a third panel-defined connection counterpart 39. In some embodiments, for example, wherein the third wall surface configuration and the fourth wall surface configuration are defined on the same wall panel assembly 10, the third pair of panel-defined connection counterparts 39 is defined by a first panel-defined connection counterpart 39 and a second panel-defined connection counterpart 39, and the fourth pair of panel-defined connection counterpart 39 is defined by the second panel-defined connection counterpart 39 and a third panel-defined connection counterpart 39.

Accordingly, if it is desirable to connect and secure the mounting assembly 500 to a wall surface configuration having a first pair of panel-defined connection counterparts 39 spaced apart by a first spacing distance, and also having a second pair of panel-defined connection counterparts 39 spaced apart by a second spacing distance but the spacing between the first connection counterpart 504 and the second connection counterpart 508 is not adjustable to correspond to the first and second spacing distances between the first and second pairs of panel-defined connection counterparts 39, the connection counterpart-defining configuration 506 can be decoupled from the bracket 502, and the connection counterpart-defining configuration 506A can be coupled to the bracket 502, to define the assembly 500A, such that the spacing between the connection counterparts 504 and 508 can be adjusted to correspond to the spacing distances between the first and second pair of panel-defined connection counterparts 39, for connecting and securing the assembly 500A to the first and pairs of panel-defined connection counterparts 39. In this respect, the same bracket 502 and locking mechanism 520 (e.g. rotatable head 520A and threaded stud) are used, and different embodiments of the connection counterpart-defining configuration 506, having different lengths of the intermediate member 507, can be connected to the bracket 502 via the locking mechanism 520 to connect to the desired pair of panel-defined connection counterparts 39.

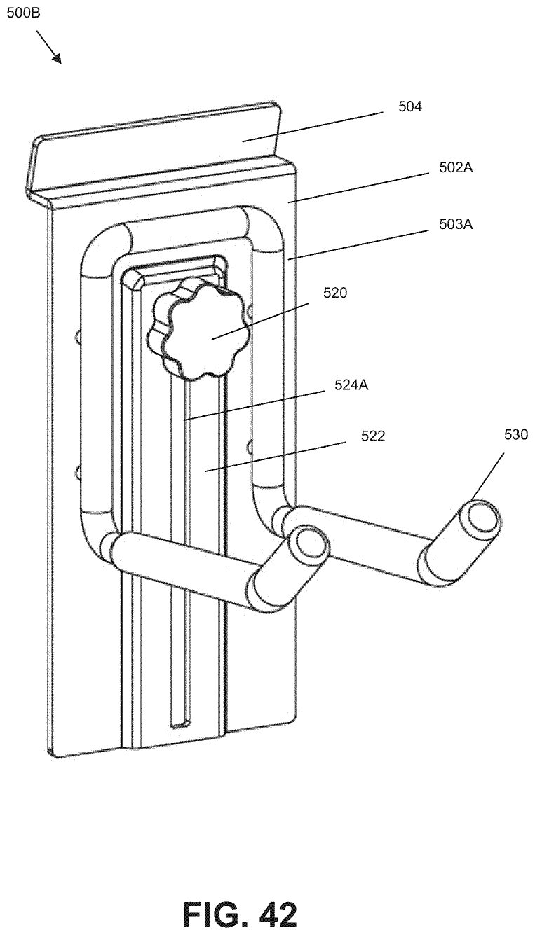

FIG. 42 to FIG. 45 depict a mounting assembly 500B that is an alternate embodiment of the mounting assembly 500 and mounting assembly 500A. The mounting assembly 500B substantially corresponds to the mounting assembly 500 and mounting assembly 500A, except: 1) the bracket 502A of the mounting assembly 500B includes a slot 524A that is longer than the slot 524 of the mounting assembly 500 and mounting assembly 500A, and 2) the intermediate member 507B of the connection counterpart-defining configuration 506B is shorter than the intermediate member 507 of the connection counterpart-defining configuration 506 of the mounting assembly 500, and also shorter than the intermediate member 507A of the connection counterpart-defining configuration 506A of the mounting assembly 500A.

As depicted, the slot 524A is longer than the slot 524 of the mounting assembly 500 and mounting assembly 500A. The slot 524A extends from the bottom of the flange 503A to substantially the top of the flange 503A. In some embodiments, for example, the length of the slot 524A is generally the length of the flange 503A.

As depicted, the intermediate member 507B of the connection counterpart-defining configuration 506B is relatively short. In some embodiments, for example, the length of the intermediate member is 0.75 inches.

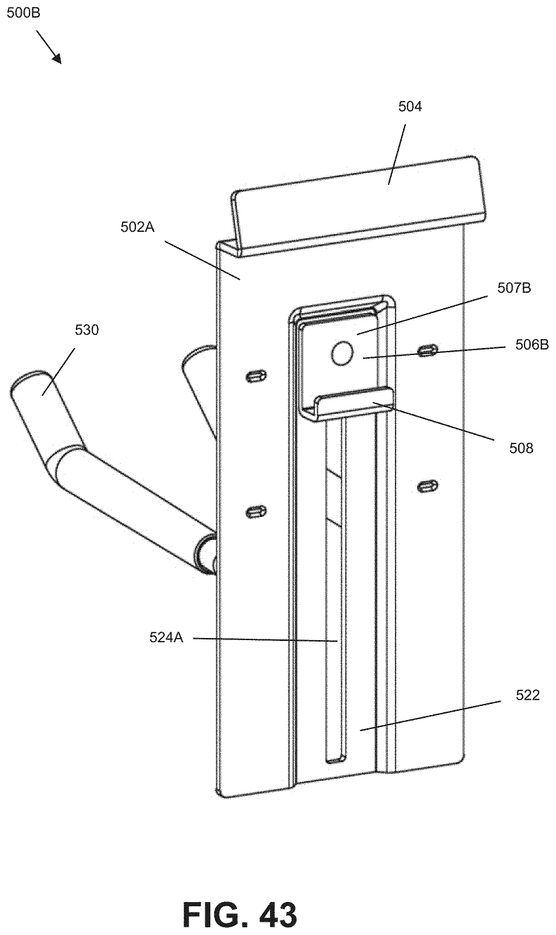

The increase in length of the slot 524A, and the decrease in length of the intermediate member 507B, is with effect that the minimum spacing distance between the first connection counterpart 504 and the second connection counterpart 508, of the mounting assembly 500B, is reduced, relative to the minimum spacing distance between the first connection counterpart 504 and the second connection counterpart 508, of the mounting assembly 500, and also of the mounting assembly 500A. In some embodiments, for example, the minimum spacing distance between the first connection counterpart 504 and the second connection counterpart 508 is defined while the assembly 500B is disposed in the retracted configuration, as depicted in FIG. 42 and FIG. 43. In some embodiments, for example, the minimum spacing distance between the first connection counterpart 504 and the second connection counterpart 508 has a minimum value of 1 inch.

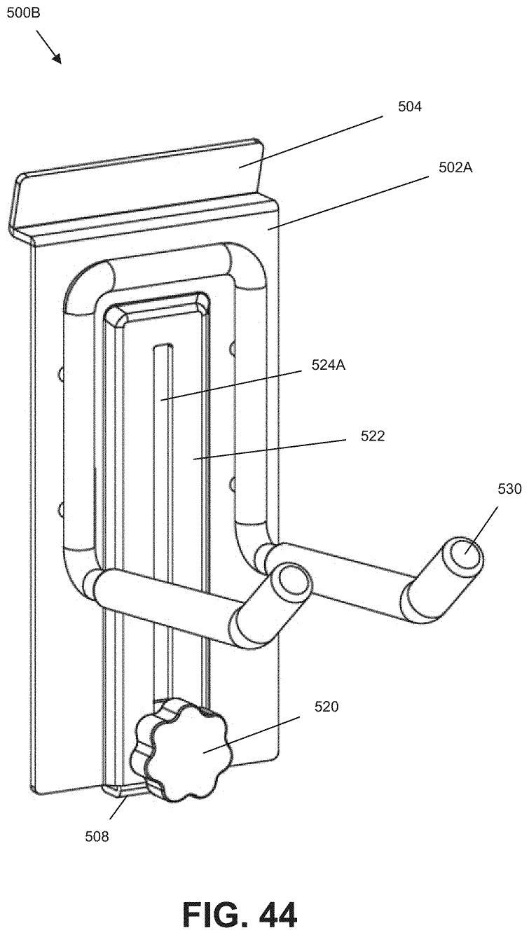

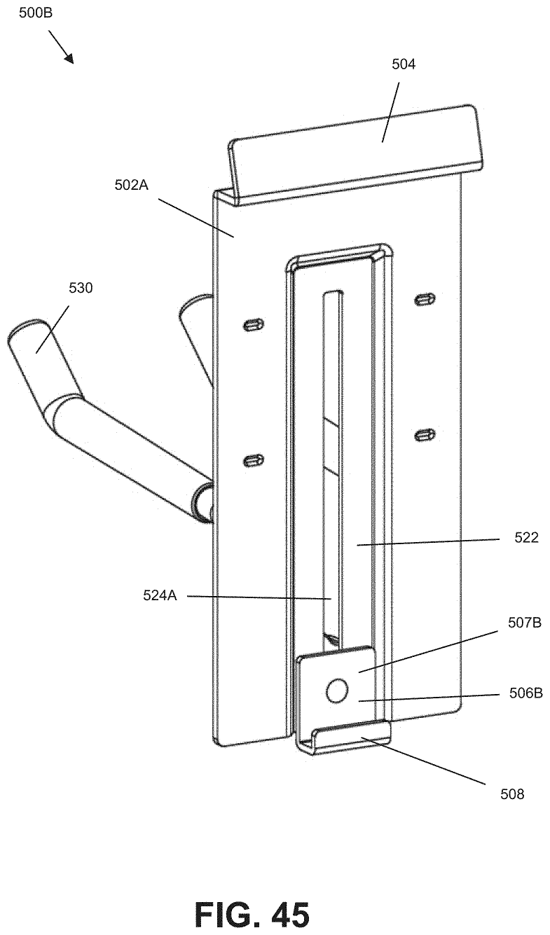

The decrease in length of the intermediate member 507B, is with effect that the maximum spacing distance between the first connection counterpart 504 and the second connection counterpart 508, of the mounting assembly 500B, is reduced, relative to the maximum spacing distance between the first connection counterpart 504 and the second connection counterpart 508, of the mounting assembly 500, and also of the mounting assembly 500A. In some embodiments, for example, the maximum spacing distance between the first connection counterpart 504 and the second connection counterpart 508 is defined while the assembly 500B is disposed in the extended configuration, as depicted in FIG. 44 and FIG. 45. In some embodiments, for example, the maximum spacing distance between the first connection counterpart 504 and the second connection counterpart 508 has a maximum value of 6 inches.

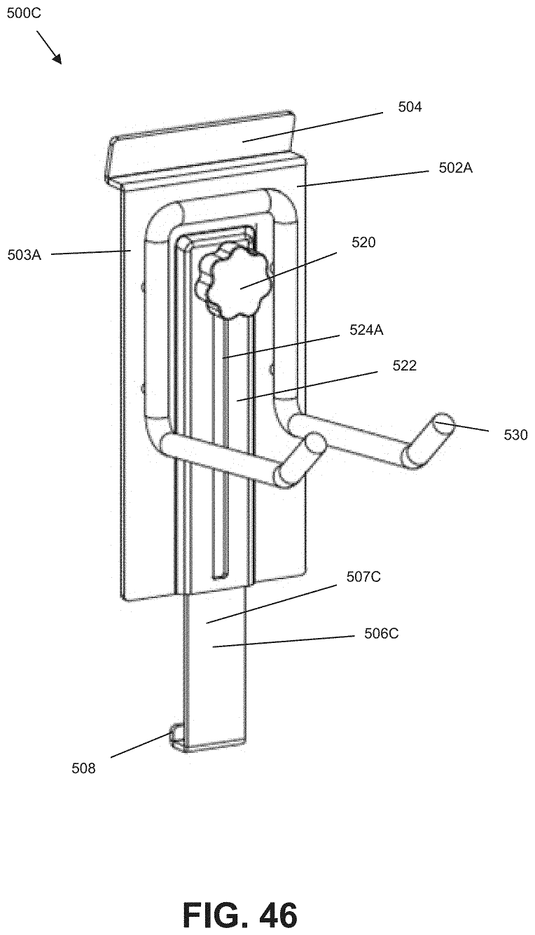

FIG. 46 to FIG. 49 depict a mounting assembly 500C that is an alternate embodiment of the mounting assembly 500B. The mounting assembly 500B substantially corresponds to the mounting assembly 500B, except the intermediate member 507C of the connection counterpart-defining configuration 506C is longer than the intermediate member 507B of the connection counterpart-defining configuration 506B of the mounting assembly 500B.

As depicted, the intermediate member 507C of the connection counterpart-defining configuration 506C is relatively long. In some embodiments, for example, the length of the intermediate member is 7 inches.

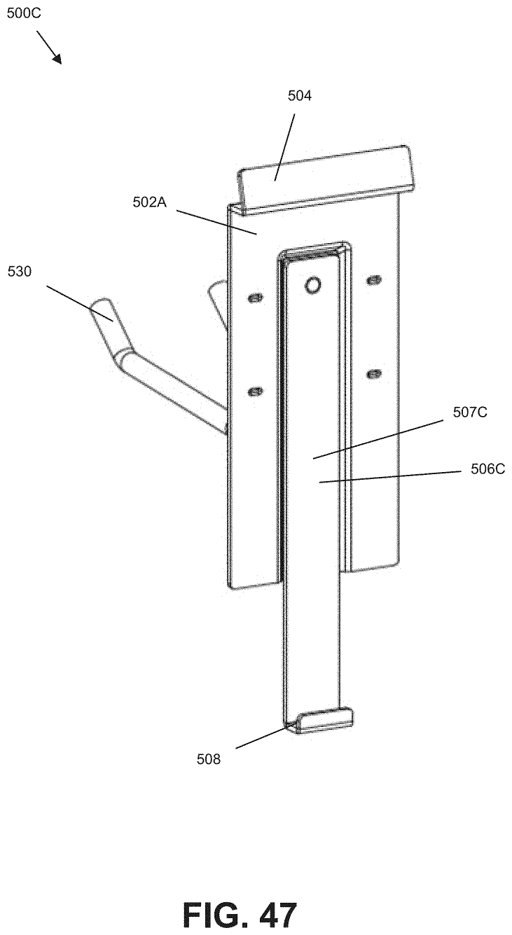

The increase in length of the intermediate member 507C, is with effect that the minimum spacing distance between the first connection counterpart 504 and the second connection counterpart 508, of the mounting assembly 500C, is increased, relative to the maximum spacing distance between the first connection counterpart 504 and the second connection counterpart 508, of the mounting assembly 500B. In some embodiments, for example, the minimum spacing distance between the first connection counterpart 504 and the second connection counterpart 508 is defined while the assembly 500C is disposed in the retracted configuration, as depicted in FIG. 46 and FIG. 47. In some embodiments, for example, the minimum spacing distance between the first connection counterpart 504 and the second connection counterpart 508 has a minimum value of 8 inches.

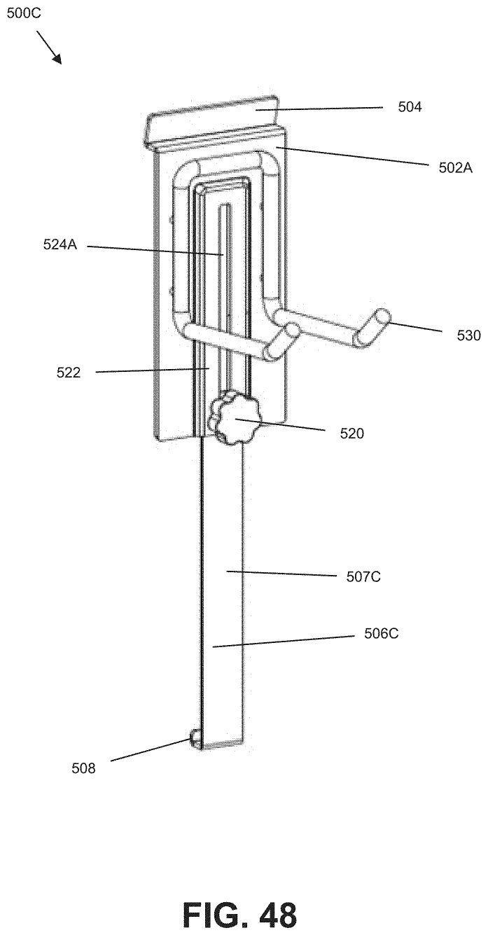

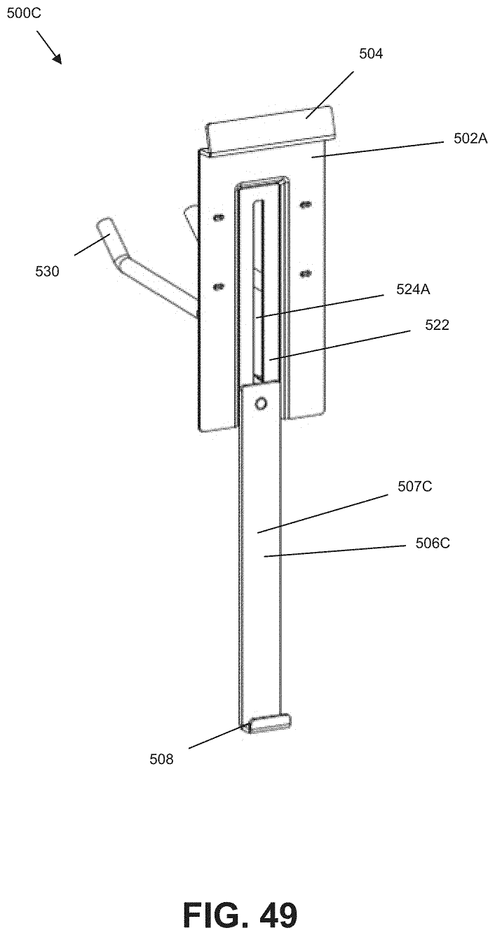

The increase in length of the intermediate member 507C, is with effect that the maximum spacing distance between the first connection counterpart 504 and the second connection counterpart 508, of the mounting assembly 500C, is increased, relative to the maximum spacing distance between the first connection counterpart 504 and the second connection counterpart 508, of the mounting assembly 500B. In some embodiments, for example, the maximum spacing distance between the first connection counterpart 504 and the second connection counterpart 508 is defined while the assembly 500C is disposed in the extended configuration, as depicted in FIG. 48 and FIG. 49. In some embodiments, for example, the maximum spacing distance between the first connection counterpart 504 and the second connection counterpart 508 has a maximum value of 12 inches.

In some embodiments, for example, the mounting assembly 500C can be assembled from the mounting assembly 500B by decoupling the connection counterpart-defining configuration 506B from the bracket 502A, and coupling the connection counterpart-defining configuration 506C to the bracket 502A, similar to the manner by which the mounting assembly 500A can be assembled from the mounting assembly 500.

In some embodiments, for example, a kit for a mounting assembly configured to be connected to a first wall surface configuration having a first pair of panel-defined connection counterparts 39 spaced apart by a first spacing distance, and further configured to be connected to a second wall surface configuration having a second pair of panel-defined connection counterparts 39 spaced apart by a second spacing distance includes a bracket described herein, for example, the bracket 502 or the bracket 502A, and further includes one of the connection counterpart-defining configurations described herein, for example, one of the connection counterpart-defining configuration 506, the connection counterpart-defining configuration 506A, connection counterpart-defining configuration 506B, and connection counterpart-defining configuration 506C.

In some embodiments, for example, a kit for a mounting assembly configured to be connected to: 1) a first wall surface configuration having a first pair of panel-defined connection counterparts spaced apart by a first spacing distance, 2) a second wall surface configuration having a second pair of panel-defined connection counterparts spaced apart by a second spacing distance, 3) a third wall surface configuration having a third pair of panel-defined connection counterparts spaced apart by a third spacing distance, and 4) a fourth wall surface configuration having a fourth pair of panel-defined connection counterparts spaced apart by a fourth spacing distance, includes a bracket described herein, for example, the bracket 502 or the bracket 502A, and further includes two or more of the connection counterpart-defining configurations described herein, for example, two or more of the connection counterpart-defining configuration 506, the connection counterpart-defining configuration 506A, connection counterpart-defining configuration 506B, and connection counterpart-defining configuration 506C.

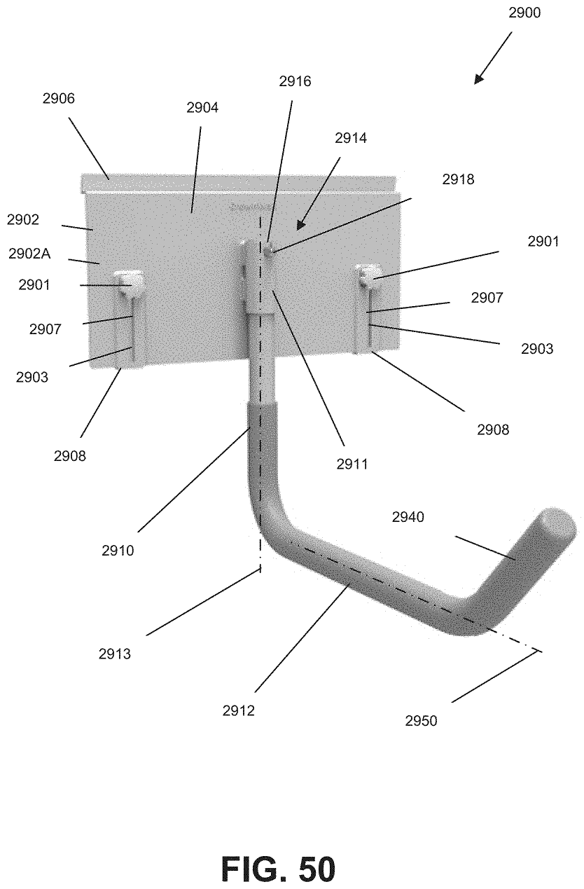

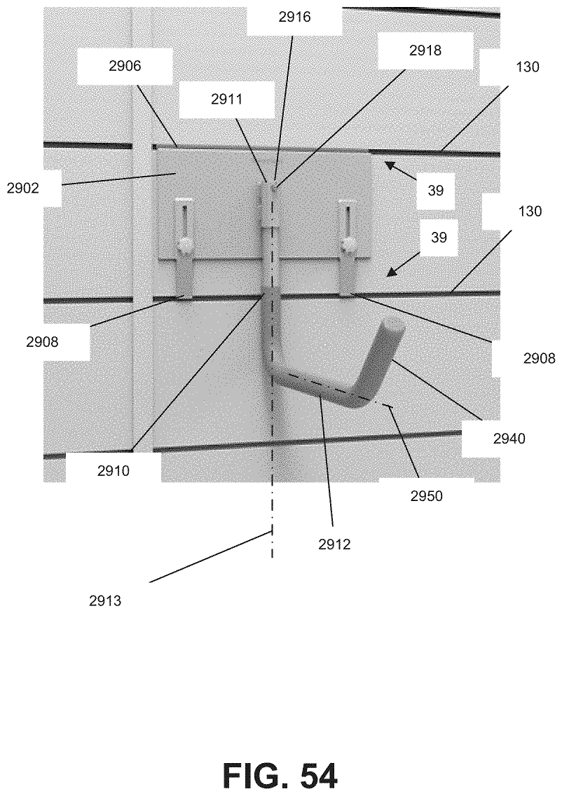

FIG. 50 to FIG. 56 depict an embodiment of a mounting assembly 2900. The mounting assembly 2900 is configured to be connected to a wall panel assembly 10, for example, hung from the wall panel assembly 10. In some embodiments, for example, the mounting assembly 2900 is configured to be hung from a recess defined within the wall panel assembly 10. In some embodiments, for example, the recess includes the cavity 130. The wall panel assembly 10 comprises a pair of spaced-apart panel-defined connection counterparts 39. In some embodiments, for example, the panel-defined connection counterpart 39 includes the cavity 130, as depicted in FIG. 54.

Similar to the mounting assembly 500, the assembly 2900 is configured to be connected to a first wall surface configuration having a first pair of panel-defined connection counterparts 39 spaced apart by a first spacing distance, and further configured to be connected to a second wall surface configuration having a second pair of panel-defined connection counterparts 39 spaced apart by a second spacing distance.

In some embodiments, for example, the assembly 2900 comprises a first connection counterpart 2906. The first connection counterpart 2906 substantially corresponds to the first connection counterpart 504 of the assembly 500. The assembly 2900 further comprises a second connection counterpart 2908 that includes a channel 2909. The second connection counterpart 2908 substantially corresponds to the second connection counterpart 508 of the assembly 500. In some embodiments, for example, while the assembly 2900 is disposed in an operating configuration, the first connection counterpart 2906 is disposed above the second connection counterpart 2908. In this respect, in some embodiments, for example, the first connection counterpart 2906 is an upper connection counterpart 2906, and the second connection counterpart 2908 is a lower connection counterpart 2908. In some embodiments, for example, the first connection counterpart 2906 is configured to co-operate with the cavity 130 of a panel 100 or a wall panel assembly 10 such that the assembly 2900 is hangable from the panel or the wall panel assembly, similar to the manner by which the assembly 500 is hangable from the panel or the wall panel assembly via the connection counterpart 504. In some embodiments, for example, the first connection counterpart 2906 is configured to co-operate with the cavity 130 of a panel 100 or a wall panel assembly 10 to establish the retained configuration.

In some embodiments, for example, similar to the assembly 500, the assembly 2900 is configurable in the fixed configurable and the adjustable configuration, wherein, in the fixed configuration, there is an absence of adjustability of the spacing between the first connection counterpart 2906 and the second connection counterpart 2908, and, in the adjustable configuration, spacing between the first connection counterpart 2906 and the second connection counterpart 2908 is adjustable between at least a first spacing and a second spacing.

In some embodiments, for example, the assembly 2900 includes a mounting bracket 2902. As depicted, the mounting bracket 2902 substantially corresponds to the mounting bracket 502 of the assembly 500, except the mounting bracket 2902 is longer (e.g. measured between the top and bottom ends of the bracket 2902) and wider (e.g. measured between the left and right ends of the bracket 2902) than the bracket 502. In some embodiments, for example, the first connection counterpart 2906 is defined by the bracket 2902. In this respect, in some embodiments, for example, the first connection counterpart 2906 is a bracket connector 2906 or a first bracket-defined connection counterpart 2906.

In some embodiments, for example, the bracket 2902 comprises a flange 2902A, substantially corresponding to the flange 503, as depicted in FIG. 50, to which a load supporter 2910 of the assembly 2900 is connectible. In some embodiments, for example, the flange 2902A defines a front surface 2904 and a rear surface 2904A that is disposed on an opposite side of the flange 2902A relative to the front surface 2904. In some embodiments, for example, the front surface 2904 defines a surface configured for being visible while the mounting assembly 2900 is connected to the wall panel assembly 10 or panel 100. In some embodiments, for example, the rear surface 2904A defines a panel-opposing surface configured for opposing the front facing surface 104 while the mounting assembly 2900 is connected to the wall panel assembly 10 or panel 100. In some embodiments, for example, the front surface 2904 is the front surface 2904 of the bracket 2902.

In some embodiments, for example, the flange 2902A and the first connection counterpart 2906 are connected. In some embodiments, for example, the bracket 2902, comprising the flange 2902A and the first connection counterpart 2906, is of unitary one piece construction.

In some embodiments, for example, the assembly 2900 comprises a connection counterpart-defining configuration 2903. The connection counterpart-defining configuration 2903 substantially corresponds to the connection counterpart-defining configuration 506 of the assembly 500. In some embodiments, for example, the bracket 2902 is releasably couplable to the connection counterpart-defining configuration 2903. In some embodiments, for example, while the bracket 2902 is releasably coupled to the connection counterpart-defining configuration 2903, the mounting assembly 2900 is defined. In some embodiments, for example, the releasable coupling of the bracket 2902 and the connection counterpart-defining configuration 2903 is such that the connection counterpart-defining configuration 2903 slidably coupled to the bracket 2903.

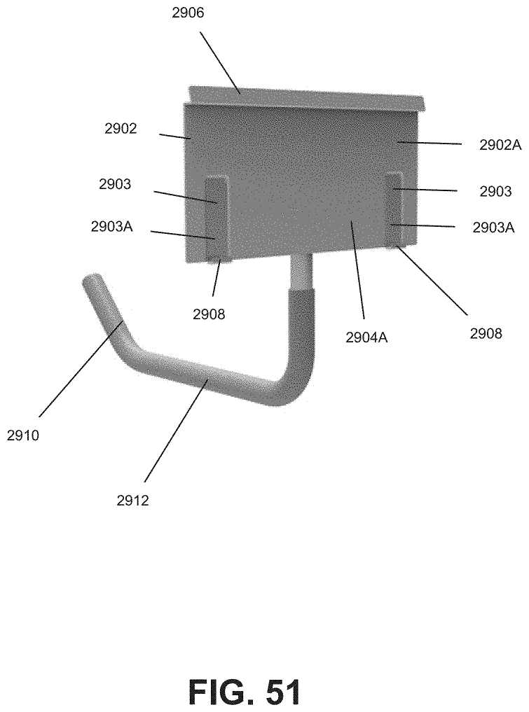

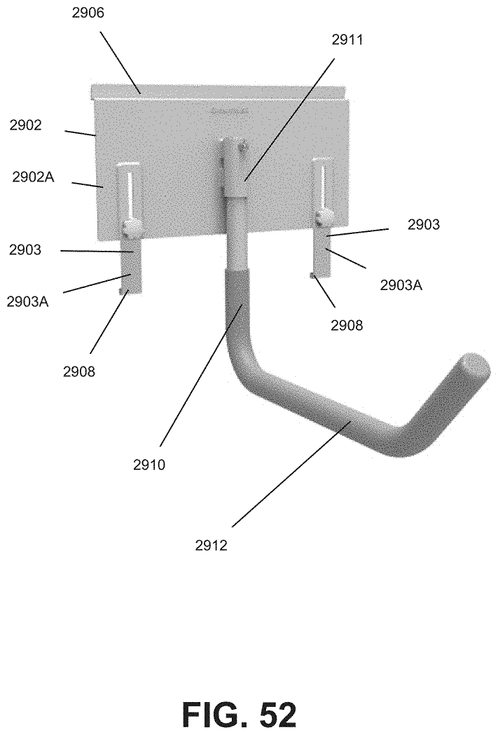

As depicted in FIG. 50 to FIG. 53, the second connection counterpart 2908 is defined by the connection counterpart-defining configuration 2903. As depicted in FIG. 51 and FIG. 52, in some embodiments, for example, the connection counterpart-defining configuration 2903 includes an intermediate member 2903A. In some embodiments, for example, the second connection counterpart 2908 is connected to the intermediate member 2903A. In some embodiments, for example, the connection counterpart-defining configuration 2903, which includes the second connection counterpart 2908 and the intermediate member 2903A, is of unitary one piece construction.

The bracket 2902, for example, the flange 2902A, is releasably couplable to the connection counterpart-defining configuration 2903, such that, while the bracket 2902 and the connection counterpart-defining configuration 2903 are releasably coupled, the relative displacement is effectible between the bracket 2902 and the connection counterpart-defining configuration 2903. In some embodiments, for example, adjusting of the spacing between the first and second connection counterparts 2906 and 2908 is effectible by relative displacement between the bracket 2902 and the connection counterpart-defining configuration 2903. In some embodiments, for example, the relative displacement effectible between the bracket 2902 and the connection counterpart-defining configuration 2903 includes sliding displacement.

In some embodiments, for example, the assembly 2900 includes a locking mechanism 2901 (e.g. a rotatable head, threaded rod or stud) and a slot 2907, defined by the bracket 2902, for releasably coupling the bracket 2902 and connection counterpart defining configuration 2903. The locking mechanism 2901 substantially corresponds to the locking mechanism 520 of the mounting assembly 500, and the slot 2907 substantially corresponds to the slot 524 of the assembly 500.

In some embodiments, for example, the flange 2902A includes a raised portion that defines a recess 2905, substantially similar to the recess 522 of the flange 503 of the mounting assembly 500, for receiving at least a portion of the connection counterpart-defining configuration 2903, in particular, for receiving at least a portion of the intermediate member 2903A. While the bracket 2902 and the connection counterpart-defining configuration 2903 are releasably coupled, at least a portion of the intermediate member 2903A is received in the recess 2905.

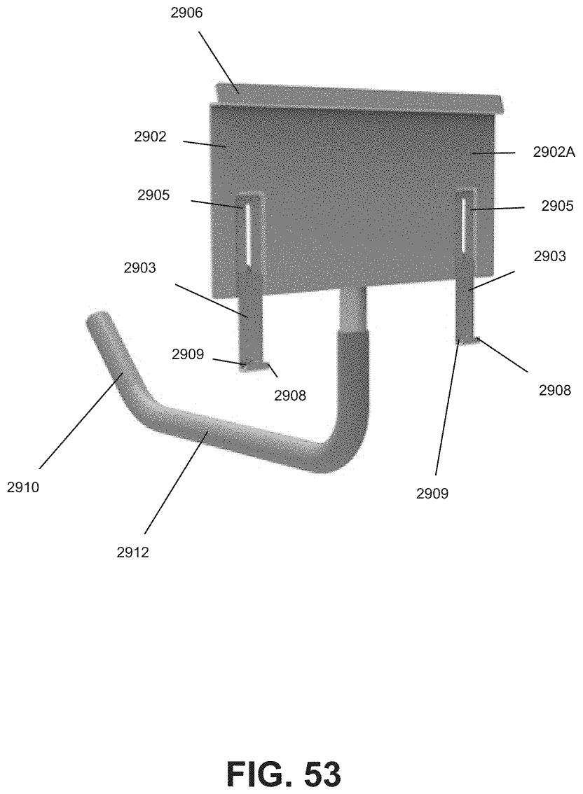

In some embodiments, for example, substantially similar to the assembly 500, the assembly 2900 is configurable in a retracted configuration, an extended configuration, and an intermediate configuration. In the retracted configuration, the spacing distance between the first connection counterpart 2906 and the second connection counterpart 2906 is a minimum spacing distance, as depicted in FIG. 50 and FIG. 51. In the extended configuration, the spacing distance between the first connection counterpart 2906 and the second connection counterpart 2908 is a maximum spacing distance, as depicted in FIG. 52 and FIG. 53. In the intermediate configuration, the spacing distance between the first connection counterpart 2906 and the second connection counterpart 2908 is between the minimum spacing distance and the maximum spacing distance.

In some embodiments, for example, the mounting assembly 2900 includes more than one connection counterpart 2908, to improve the gripping and securing of the bracket 2902 to the panel 100 or the wall panel assembly 10, for example, if the load to be supported by the mounting assembly 2900 is particularly heavy.

In this respect, in some embodiments, for example, the mounting assembly 2900 includes a plurality of connection counterpart defining configurations 2903, wherein each one of the connection counterpart defining configurations 2903, independently, defines a connection counterpart 2908, and includes an intermediate member 2903A. As depicted in FIGS. 50 to 55, the mounting assembly 2900 includes two connection counterpart defining configurations 2903. In some embodiments, for example, for each one of the two connection counterpart 2908, the first connection counterpart 2906 and the connection counterpart 2908 is disposed on opposite ends of the bracket 2902. In some embodiments, for example, the two connection counterparts 2908 are disposed on the same end (e.g. bottom end) of the bracket 2902, as depicted in FIG. 50.

For each one of the plurality of connection counterpart defining configurations 2903, independently, spacing between the first connection counterpart 2906 and the second defined connection counterpart 2908 is adjustable so as to connect with different pairs of spaced apart panel-defined connection counterparts 39 having different spacing therebetween, and to grip and secure the mounting assembly 2900 to the panel 100 or wall panel assembly 10, similar to the manner by which the spacing between the connection counterparts 504 and 508 of the mounting assembly 500 is adjustable, for gripping and securing the mounting assembly 500 to the panel 100 or wall panel assembly 10.

For each one of the plurality of connection counterpart defining configurations 2903, independently, the assembly 2900 includes a locking mechanism 2901 (e.g. a rotatable head, threaded rod or stud) and a slot 2907, defined by the bracket 2902, for releasably coupling the bracket 2902 and connection counterpart defining configuration 2903.

For each one of the plurality of connection counterpart defining configurations 2903, independently, the flange 2902A includes a raised portion that defines a recess 2905, substantially similar to the recess 522 of the flange 503 of the mounting assembly 500, for receiving at least a portion of the connection counterpart-defining configuration 2903, in particular, for receiving at least a portion of the intermediate member 2903A.

In some embodiments, for example, the mounting assembly 2900 is hangable, connectible, and securable to a wall panel assembly 10 or a panel 100, similar to the manner by which the mounting assembly 500 is hangable, connectible, and securable to a wall panel assembly 10 or a panel 100.

In some embodiments, for example, the first connection counterpart 2906, the second connection counterparts 2908 are co-operatively configured for connection to a first wall surface configuration having a first pair of panel-defined connection counterparts 39 spaced apart by a first spacing distance, and further configured to be connected to a second wall surface configuration having a second pair of panel-defined connection counterparts 39 spaced apart by a second spacing distance.

FIG. 54 to FIG. 56 depict the assembly 2900 secured to the wall panel assembly 10 via the co-operative configuration of the first connection counterpart 2906 and the second connection counterparts 2908, and a pair of spaced apart panel-defined connection counterparts 39 of the wall panel assembly 10.

Similar to the mounting assembly 500, for each one of the connection counterpart defining configurations 2903, independently, the connection between the bracket 2902 and the connection counterpart defining configuration 2903 is defeatable, for example, by defeating the connection between the rotatable head and the treaded stud of the locking mechanism 2901, and another connection counterpart defining configuration 2903 having an intermediate member 2903A of different length, is releasably couplable to the bracket 2902, to change the minimum and maximum spacing distances between the first connection counterpart 2906 and the second connection counterparts 2908, based on the spacing distance between a pair of panel-defined connection counterparts 39 of the wall panel assembly 10, or the panel 100, to which the mounting assembly 2900 is to be connected and secured.

In some embodiments, for example, the mounting assembly 2900 further includes a load supporter 2910. The load supporter 2910 includes a load-supporting portion 2912 that is configured to support a load 3400. In some embodiments, for example, the load supporter 2910 is coupled to the bracket 2902, such that the load supporter 2910 is rotatable, relative to the bracket 2902, about a rotation axis 2913. In some embodiments, for example, the axis 2913 is parallel to a plane defined by the front surface 2904 of the bracket 2902. In some embodiments, for example, the axis 2913 is offset from the front surface 2904 of the bracket 2902. In some embodiments, for example, the axis 2913 is parallel to a plane defined by the front surface of the wall panel assembly 10 on which the bracket 2902 is hung. In some embodiments, for example, the axis 2913 is a vertical axis.

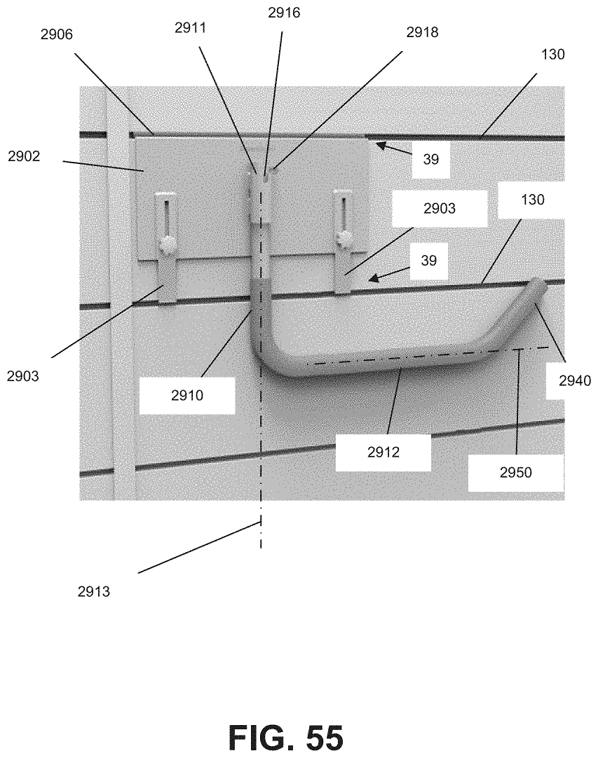

In some embodiments, for example, the mounting assembly 2900 is transitionable between a support-ready configuration, as depicted in FIG. 50 to FIG. 54, and a storage configuration, as depicted in FIG. 55. In some embodiments, for example, the transition is effected by rotation of the load supporter 2910 relative to the bracket 2902.

As depicted in FIG. 50 to FIG. 54, in some embodiments, for example, in the support-ready configuration, the load-supporting portion 2912 extends outwardly, relative to the front surface of the wall panel assembly 10. In some embodiments, for example, in the support-ready configuration, the load-supporting portion 2912 extends in a direction along an axis 2950 that traverses a plane defined by the front surface of the wall panel assembly 10. In some embodiments, for example, in the support-ready configuration, the traversing of the plane defined by the front surface of the wall panel assembly 10 by the extension axis 2950 of the load-supporting portion 2912 is such that the axis 2950 is normal to the plane defined by the front surface of the wall panel assembly 10. In some embodiments, for example, in the support-ready configuration, the traversing of the plane defined by the front surface of the wall panel assembly 10 by the extension axis 2950 of the load-supporting portion 2912 is such that the axis 2950 is angled relative to the plane defined by the front surface of the wall panel assembly 10 (e.g. extending to the left or to the right), and that the axis 2950 and the plane define an acute angle therebetween. In some embodiments, for example, in the support-ready configuration, the acute angle defined between the axis 2950 and the plane defined by the front surface of the wall panel assembly has a minimum value of at least 60 degrees.

In some embodiments, for example, in the support-ready configuration, the load-supporting portion 2912 extends outwardly and in an upward direction, relative to the front surface of the wall panel assembly 10. In this respect, in some embodiments, for example, the axis 2950 is angled relative to a normal axis of the plane defined by the front surface of the wall panel assembly 10, the axis 2950 and the normal axis defining an acute angle. In some embodiments, for example, in the support-ready configuration, the acute angle defined between the axis 2950 and the normal axis of the plane defined by the front surface of the wall panel assembly has a minimum value of at least 1 degree.

In some embodiments, for example, in the support-ready configuration, the load-supporting portion 2912 extends outwardly and in a downward direction, relative to the front surface of the wall panel assembly 10. In this respect, in some embodiments, for example, the axis 2950 is angled relative to a normal axis of the plane defined by the front surface of the wall panel assembly 10, the axis 2950 and the normal axis defining an acute angle. In some embodiments, for example, in the support-ready configuration, the acute angle defined between the axis 2950 and the normal axis of the plane defined by the front surface of the wall panel assembly has a maximum value of 5 degrees.

In some embodiments, for example, in the support-ready configuration, the load-supporting portion 2912 extends outwardly, relative to the front surface 2904 of the bracket 2902. In some embodiments, for example, in the support-ready configuration, the load-supporting portion 2912 extends in a direction along an axis 2950 that traverses a plane defined by the front surface 2904 of the bracket 2902. In some embodiments, for example, in the support-ready configuration, the traversing of the plane defined by the front surface 2904 of the bracket 2902 by the extension axis of the load-supporting portion 2912 is such that the axis 2950 is normal to the plane defined by the front surface 2904 of the bracket 2902. In some embodiments, for example, in the support-ready configuration, the traversing of the plane defined by the front surface 2904 of the bracket 2902 by the extension axis of the load-supporting portion 2912 is such that the axis 2950 is angled relative to the plane defined by the front surface 2904 of the bracket 2902 (e.g. extending to the left or to the right), and that the axis 2950 and the plane define an acute angle therebetween. In some embodiments, for example, in the support-ready configuration, the acute angle defined between the axis 2950 and the plane defined by the front surface 2904 of the bracket 2902 has a minimum value of at least 60 degrees.

In some embodiments, for example, in the support-ready configuration, the load-supporting portion 2912 extends outwardly and in an upward direction, relative to the front surface 2904 of the bracket 2902. In this respect, in some embodiments, for example, the axis 2950 is angled relative to a normal axis of the plane defined by the front surface 2904 of the bracket 2902, the axis 2950 and the normal axis defining an acute angle. In some embodiments, for example, in the support-ready configuration, the acute angle defined between the axis 2950 and the normal axis of the plane defined by the front surface 2904 of the bracket 2902 has a minimum value of at least 1 degree.

In some embodiments, for example, in the support-ready configuration, the load-supporting portion 2912 extends outwardly and in a downward direction, relative to the front surface 2904 of the bracket 2902. In this respect, in some embodiments, for example, the axis 2950 is angled relative to a normal axis of the plane defined by the front surface 2904 of the bracket 2902, the axis 2950 and the normal axis defining an acute angle. In some embodiments, for example, in the support-ready configuration, the acute angle defined between the axis 2950 and the normal axis of the plane defined by the front surface 2904 of the bracket 2902 has a maximum value of 5 degrees.

In some embodiments, for example, the bracket 2902 and the wall panel assembly 10 are co-operatively configured such that while the bracket 2902 is hung from the wall panel assembly 10, and the load supporter is disposed in the support-ready configuration, the load supporting portion 2912 is disposed a minimum distance of at least 1/32 inch from the wall panel assembly 10.

As depicted in FIG. 55, in some embodiments, for example, in the storage configuration, the load-supporting portion 2912 extends in a lateral direction, for example, a left direction or right direction. FIG. 55 depicts the load-supporting portion 2912 extending in the left direction. In some embodiments, for example, in the storage configuration, the load-supporting portion 2912 is flush with the front surface of the wall panel assembly 10. In some embodiments, for example, in the storage configuration, the load-supporting portion 2912 extends in a direction along an axis that is parallel to the plane defined by the front surface of the wall panel assembly 10. In some embodiments, for example, in the storage configuration, the load-supporting portion 2912 extends in a direction along an axis that is disposed at an acute angle, relative to the plane defined by the front surface of the wall panel assembly 10, wherein the acute angle has a maximum value of 10 degrees.

In some embodiments, for example, in the storage configuration, the load-supporting portion 2912 is flush with the front surface 2904 of the bracket 2902. In some embodiments, for example, in the storage configuration, the load-supporting portion 2912 extends in a direction along an axis that is parallel to the plane defined by the front surface 2904 of the bracket 2902. In some embodiments, for example, in the storage configuration, the load-supporting portion 2912 extends in a direction along an axis that is disposed at an acute angle, relative to the plane defined by the front surface 2904 of the bracket 2902, wherein the acute angle has a maximum value of 10 degrees.

In some embodiments, for example, in the support-ready configuration, the load-supporting portion 2910 extends in a direction along a first axis, and, in the storage configuration, the load-supporting portion 2910 extends in a direction along a second axis, and an acute angle defined between the first axis and the second axis has a minimum value of at least 50 degrees.

In some embodiments, for example, the load supporter 2910 includes a load-retaining portion 2940, configured to resist removal of a load that is supported by the load-supporting portion 2912. As depicted in FIG. 50 to FIG. 55, the load-retaining portion 2940 is angled relative to the load-supporting portion 2912. In some embodiments, for example, the acute angle defined between load supporting portion 2912 and the load-retaining portion 2940 has a minimum value of at least 5 degrees. Due to the angled disposition of the load-retaining portion 2940, relative to the load-supporting portion 2912, while a load is supported by the load-supporting portion 2912, if the load is displaced in a direction that is parallel to the axis 2950, the load will engage the load-retaining portion 2940, which will resist further displacement of the load in the direction that is parallel to the axis 2950. To remove the load, the direction of displacement of the load is to be changed, in particular, to a direction along an axis of extension of the load-retaining portion 2940, which is angled relative to the axis 2950.

In some embodiments, for example, the mounting assembly 2900 further includes a sleeve support 2911 that is connected to the bracket 2902, for example, to the front surface 2904 of the bracket 2902, by welding, or by fasteners. In some embodiments, for example, the load supporter 2910 is rotatably coupled to the sleeve support 2911, such that the coupling of the load supporter 2910 to the bracket 2902 is effected by the rotatable coupling of the load supporter 2910 to the sleeve support 2911.

In some embodiments, for example, the mounting assembly 2900 further comprises a locking mechanism 2914. In some embodiments, for example, the sleeve support 2911, the load supporter 2910, and the locking mechanism 2914 are co-operatively configured to releasably lock the load supporter 2914 in at least the support-ready configuration, such that transition to the storage configuration is prevented.

In some embodiments, for example, the locking mechanism 2914 comprises a sleeve-defined locking counterpart and a load supporter-defined locking counterpart. In some embodiments, for example, the sleeve-defined locking counterpart includes a slot 2916 defined by the sleeve support 2911. In some embodiments, for example, the slot 2916 is a vertical slot. In some embodiments, for example, the slot 2916 extends in a direction that is parallel to the central longitudinal axis of the sleeve support 2911.

In some embodiments, for example, the load supporter-defined locking counterpart includes a guide pin 2918 that extends from the load supporter 2910. The sleeve-defined locking counterpart and the load supporter-defined locking counterpart are co-operatively configured to releasably lock the load supporter 2910 in the support-ready configuration, such that transition to the storage configuration is prevented. In some embodiments, for example, the guide pin 2918, the slot 2916, the sleeve support 2911, and the load supporter 2910 are co-operatively configured such that, while the guide pin 2918 is disposed in the slot 2916, the load supporter 2910 is releasably locked in the support-ready configuration.

In some embodiments, for example, the guide pin 2918, the slot 2916, the sleeve support 2911, and the load supporter 2910 are co-operatively configured such that, while the guide pin 2918 is disposed in the slot 2916, the load supporter 2910 is releasably locked in the support-ready configuration, wherein transition to the storage configuration is prevented.

In some embodiments, for example, the guide pin 2918, the slot 2916, the sleeve support 2911, and the load supporter 2910 are co-operatively configured such that, while the pin 2918 is disposed above the slot 2916, the load supporter 2910 is displaced, relative to the sleeve support 2911, in a downwardly direction, such that the guide pin 2918 is slidably received in the slot 2916 for disposition of the guide pin 2918 in the slot 2916 to effect releasable locking of the load supporter 2910 in the support-ready configuration. While the load supporter 2910 is releasably locked in the support-ready configuration, rotational displacement of the load supporter 2910, relative to the bracket 2902, to transition to the storage configuration, is prevented.

In some embodiments, for example, it is desirable to releasably lock the load supporter 2910 in the support-ready configuration such that there is an absence of displacement of the load supporter 2910 while the load is being displaced, relative to the load supporter 2910, to dispose the load, relative to the load supporter 2910, such that the load is supported by the load supporter 2910, particularly if the load is heavy. This reduces the risk of unintentionally displacing the load supporter 2910, for example, by the load or by the user, while the load is being displaced, which would require adjustment of the load supporter 2910 to return to the support-ready configuration. In some embodiments, for example, it is desirable to releasably lock the load supporter 2910 in the support-ready configuration such that, while a load is supported by the load supporter 2910 in the support-ready configuration, there is an absence of displacement of the load due to displacement of the load supporter 2910. This reduces the risk of the load being unintentionally displaced, while being supported by the load supporter 2910 in the support-ready configuration, which may result in the load knocking into a user or an object.

In some embodiments, for example, the guide pin 2918, the slot 2916, the sleeve support 2911, and the load supporter 2910 are co-operatively configured such that, while the load supporter 2910 is releasably locked in the support-ready configuration, the load supporter 2910 is releasable from the locking in the support-ready configuration via displacement of the load supporter 2910, relative to the sleeve support 2911, in an upwardly direction, with effect that the guide pin 2918 is displaced, relative to the slot 2916, in an upwardly direction, such that the guide pin 2918 becomes disposed out of the slot 2916 and above the sleeve support 2911, with effect that the load supporter 2910 is released from the releasable locking, and is rotatable, relative to the bracket 2902, to transition to the storage configuration.

In some embodiments, for example, the sleeve support 2911 vertically supports the load supporter 2910. In some embodiments, for example, in the support-ready configuration, the vertical support of the load supporter 2910 by the sleeve support 2911 is effected by the vertical support of the guide pin 2918 by a surface of the sleeve support 2911, wherein the surface is a surface that defines the slot 2916. In some embodiments, for example, in the storage configuration, the vertical support of the load supporter 2910 by the sleeve support 2911 is effected by the vertical support of the guide pin 2918 by an end surface, for example, an upper end surface, of the sleeve support 2911.

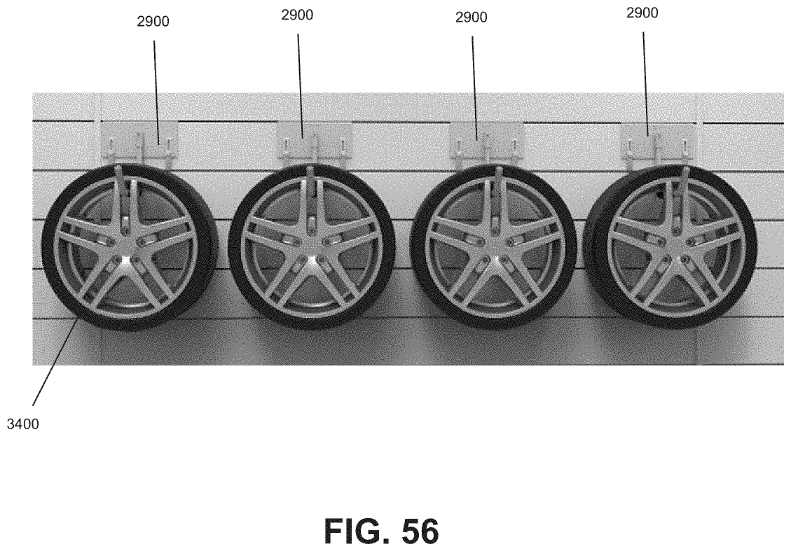

In some embodiments, for example, the load-supporting portion 2912 of the load supporter 2910 is configured to be received by an aperture of a load 3400 for extension through the aperture, such that, while the load 3400 is being supported by the load-supporting portion 2912, the load-supporting portion 2912 extends through the aperture of the load 3400. FIG. 56 depicts an example embodiment of the load 3400 being supported by the mounting assembly 2900. As depicted, in some embodiments, for example, the load 3400 is a wheel. In some embodiments, for example, the load 3400 is a wheel of a bicycle. In some embodiments, for example, the load 3400 is a wheel of an automobile. In some embodiments, for example, the load 3400 is a wheel and a rim of the wheel. In some embodiments, for example, the aperture of the load 3400 is defined by the rim of the wheel. In some embodiments, for example, the load-supporting portion 2912 has a minimum length of at least 1 inch for extending through the aperture of the load 3400.

To support a load 3400 via the wall panel assembly 10 with the mounting assembly 2900, the mounting assembly 2900 is first hung from, and then secured to the wall panel assembly 10 via the first connection counterpart 2906 and the second connection counterparts 2908, as depicted in FIG. 54, similar to the manner by which the mounting assembly 500 is hung and secured to the wall panel assembly 10. Then, the mounting assembly 2900 is transitioned from the storage configuration, as depicted in FIG. 55, to the support-ready configuration, as depicted in FIG. 54. To transition from the storage configuration to the support-ready configuration storage, a force is applied to the load supporter 2910 to rotate the load supporter 2910 relative to the bracket 2902, until the load supporter 2910 is disposed in the support-ready configuration. At this point, the guide pin 2918 is disposed in alignment with the slot 2916. To lock the load supporter 2910 in the support-ready configuration, the load supporter 2910 is lowered, such that the guide pin 2916 becomes disposed in the slot 2916, with effect that the load supporter 2910 is releasably locked in the support-ready configuration. With the load supporter 2910 releasably locked in the support-ready configuration the load 3400 is displaced, relative to the load supporter, such that the load 3400 becomes supported by the load-supporting portion 2912 of the load supporter 2910. At this point, with the load supporter 2910 releasably locked in the support-ready configuration and the load 3400 supported by the load-supporting portion 2912, displacement of the load 3400, for example, rotation of the load 3400, relative to the bracket 2902, is resisted. While the mounting assembly 2900 is secured to the wall panel assembly 10 and the load 3400 is supported by the load-supporting portion 2912, the load 3400 is supported by the wall panel assembly 10 via the connection between the mounting assembly 2900 and the wall panel assembly 10.

To transition the load supporter 2910 to the storage configuration while the load supporter 2910 is releasably locked in the support-ready configuration and supporting the load 3400, the load 3400 is first removed from the load supporter 2910, for example, by a user. Then, the load supporter 2910 is displaced upward, relative to the bracket 2902, such that the guide pin 2918 is disposed outside of the slot 2916. At this point, a force is applied to the load supporter 2910 to rotate the load supporter 2910 from the support-ready configuration to the storage configuration.

In some embodiments, for example, it is desirable for the assembly 2900 to be able to transition between the support-ready configuration and the storage configuration. While a load is to be supported by the assembly 2900, the assembly 2900 is transitionable to the support-ready configuration. While a load does not need to be supported by the assembly 2900, the assembly 2900 is transitionable to the storage configuration. Since the load supporter 2910 extends in a lateral direction while the assembly 2900 is disposed in the storage configuration, less space is taken up by the assembly 2900 while disposed in the storage configuration, relative to the support-ready configuration. This allows more space for users to safely walk by the wall panel assembly 10, or to work around the wall panel assembly 10, on which the assembly 2900 is hung and secured.

In some embodiments, for example, the mounting assembly 2900 is released from retention from the wall panel assembly 10, for example, by rotating the first connection counterpart 2906 via rotation of the assembly 2900 and displacing the assembly 2900 from the wall panel assembly 10, as described herein with respect to bracket connector 504 and the cavity 130. In some embodiments, for example, while the assembly 2900 is released from the wall panel assembly 10, the assembly 2900 is repositionable to another part of the wall panel assembly 10 and hangable, connectible, and securable to the wall panel assembly 10 at said another part of the wall panel assembly 10, or is repositionable to another wall panel assembly 10 and hangable, connectible, and securable to said another wall panel assembly 10.

In some embodiments, for example, a kit for the mounting assembly 2900 includes the bracket 2902, the load supporter 2910 configured for coupling to the bracket 2902, such that the load supporter 2910 is rotatable, relative to the bracket 2902, about a rotation axis 2913. While the load supporter 2910 is coupled to the bracket 2902, the load supporter 2902 is transitionable between the support-ready configuration, as depicted in FIG. 54, and the storage configuration, as depicted in FIG. 55, via rotation of the load supporter 2910, relative to the bracket 2902, about the rotation axis 2913, as described herein. In some embodiments, for example, the kit for the mounting assembly 2900 further includes the sleeve support 2911. In some embodiments, for example, the kit for the mounting assembly 2900 further includes the locking mechanism 2914.

In some embodiments, for example, to assemble the mounting assembly 2900, the load supporter 2910 is inserted through the sleeve support 2911 until a port for receiving the load supporter-defined locking counterpart 2918 is exposed. At this point, the guide pin is inserted into said port, which restricts displacement of the load supporter 2910, relative to the sleeve support 2911, in a direction away from the sleeve support 2911, such that removal of the load supporter 2910, from the sleeve support 2911, is resisted.

In some embodiments, for example, the material of the bracket 2902 includes steel. In some embodiments, for example, the material of the bracket 2902 includes plastic. In some embodiments, for example, the material of the sleeve support 2911 includes steel. In some embodiments, for example, the material of the sleeve support 2911 includes plastic. In some embodiments, for example, the material of the load supporter 2910 includes steel. In some embodiments, for example, the material of the load supporter 2910 includes plastic.

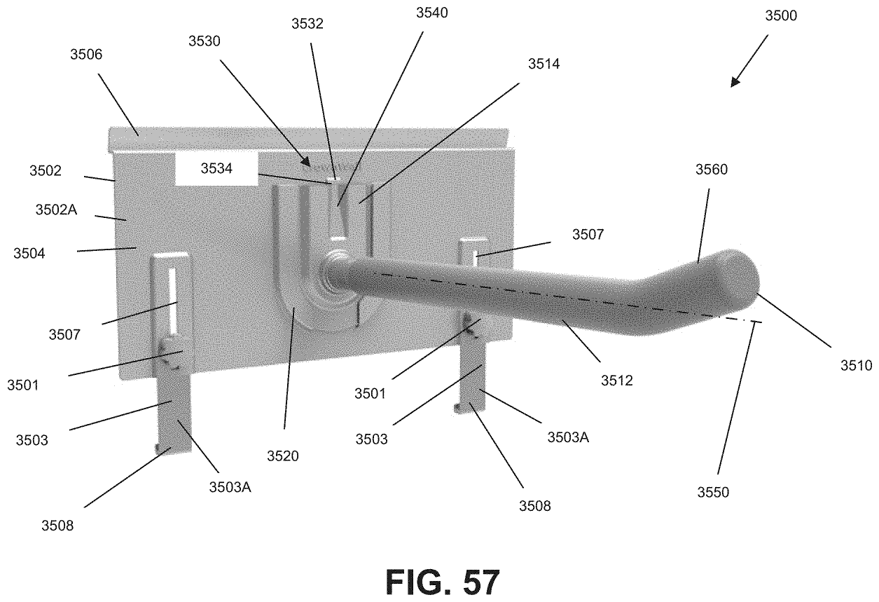

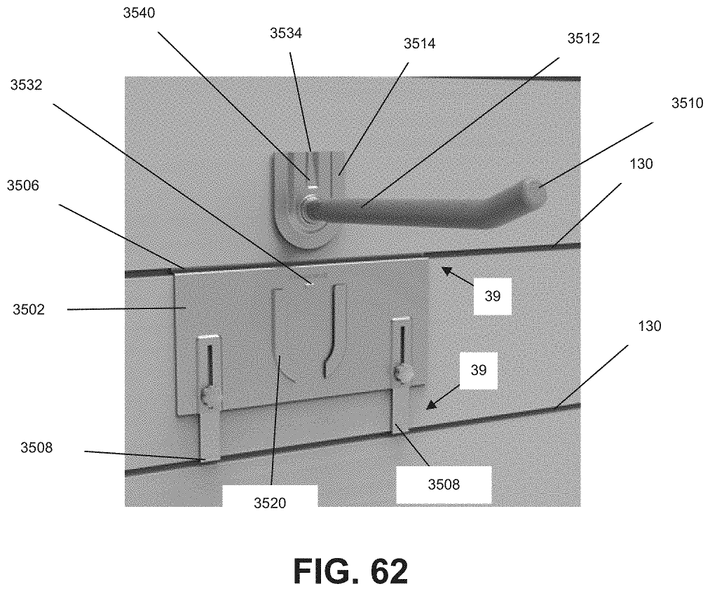

FIG. 57 to FIG. 63 depict an embodiment of a mounting assembly 3500. Similar to the mounting assembly 2900, the mounting assembly 3500 is configured to be connected to a wall panel assembly 10, for example, hung from the wall panel assembly 10. In some embodiments, for example, the mounting assembly 3500 is configured to be hung from a recess defined within the wall panel assembly 10. In some embodiments, for example, the recess includes the cavity 130. The wall panel assembly 10 comprises a pair of spaced-apart panel-defined connection counterparts 39. In some embodiments, for example, the panel-defined connection counterpart 39 includes the cavity 130, as depicted in FIG. 62.

Similar to the mounting assembly 500, the assembly 3500 is configured to be connected to a first wall surface configuration having a first pair of panel-defined connection counterparts 39 spaced apart by a first spacing distance, and further configured to be connected to a second wall surface configuration having a second pair of panel-defined connection counterparts 39 spaced apart by a second spacing distance.

In some embodiments, for example, the assembly 3500 comprises a first connection counterpart 3506. The first connection counterpart 3506 substantially corresponds to the first connection counterpart 504 of the assembly 500. The assembly 3500 further comprises a second connection counterpart 3508 that includes a channel 3509. The second connection counterpart 3508 substantially corresponds to the second connection counterpart 508 of the assembly 500. In some embodiments, for example, while the assembly 3500 is disposed in an operating configuration, the first connection counterpart 3506 is disposed above the second connection counterpart 3508. In this respect, in some embodiments, for example, the first connection counterpart 3506 is an upper connection counterpart 3506, and the second connection counterpart 3508 is a lower connection counterpart 3508. In some embodiments, for example, the first connection counterpart 3506 is configured to co-operate with the cavity 130 of a panel 100 or a wall panel assembly 10 such that the assembly 3500 is hangable from the panel or the wall panel assembly, similar to the manner by which the assembly 500 is hangable from the panel or the wall panel assembly via the connection counterpart 504. In some embodiments, for example, the first connection counterpart 3506 is configured to co-operate with the cavity 130 of a panel 100 or a wall panel assembly 10 to establish the retained configuration.

In some embodiments, for example, similar to the assembly 500 and the assembly 2900, the assembly 3500 is configurable in the fixed configurable and the adjustable configuration, wherein, in the fixed configuration, there is an absence of adjustability of the spacing between the first connection counterpart 3506 and the second connection counterpart 3508, and, in the adjustable configuration, spacing between the first connection counterpart 3506 and the second connection counterpart 3508 is adjustable between at least a first spacing and a second spacing.

In some embodiments, for example, the assembly 3500 includes a mounting bracket 3502. As depicted, the mounting bracket 3502 substantially corresponds to the mounting bracket 502 of the assembly 500, except the mounting bracket 3502 is longer (e.g. measured between the top and bottom ends of the bracket 3502) and wider (e.g. measured between the left and right ends of the bracket 3502) than the bracket 502. In some embodiments, for example, the first connection counterpart 3506 is defined by the bracket 3502. In this respect, in some embodiments, for example, the first connection counterpart 3506 is a bracket connector 3506 or a first bracket-defined connection counterpart 3506.

In some embodiments, for example, the bracket 3502 comprises a flange 3502A, substantially corresponding to the flange 503, as depicted in FIG. 57, to which a load supporter 3510 of the assembly 3500 is connectible. In some embodiments, for example, the flange 3502A defines a front surface 3504 and a rear surface 3504A that is disposed on an opposite side of the flange 3502A relative to the front surface 3504. In some embodiments, for example, the front surface 3504 defines a surface configured for being visible while the mounting assembly 3500 is connected to the wall panel assembly 10 or panel 100. In some embodiments, for example, the rear surface 3504A defines a panel-opposing surface configured for opposing the front facing surface 104 while the mounting assembly 3500 is connected to the wall panel assembly 10 or panel 100. In some embodiments, for example, the front surface 3504 is the front surface 3504 of the bracket 3502.

In some embodiments, for example, the flange 3502A and the first connection counterpart 3506 are connected. In some embodiments, for example, the bracket 3502, comprising the flange 3502A and the first connection counterpart 3506, is of unitary one piece construction.

In some embodiments, for example, the assembly 3500 comprises a connection counterpart-defining configuration 3503. The connection counterpart-defining configuration 3503 substantially corresponds to the connection counterpart-defining configuration 506 of the assembly 500. In some embodiments, for example, the bracket 3502 is releasably couplable to the connection counterpart-defining configuration 3503. In some embodiments, for example, while the bracket 3502 is releasably coupled to the connection counterpart-defining configuration 3503, the mounting assembly 3500 is defined. In some embodiments, for example, the releasable coupling of the bracket 3502 and the connection counterpart-defining configuration 3503 is such that the connection counterpart-defining configuration 3503 slidably coupled to the bracket 3503.

As depicted in FIG. 57, the second connection counterpart 3508 is defined by the connection counterpart-defining configuration 3503. As depicted in FIG. 57, in some embodiments, for example, the connection counterpart-defining configuration 3503 includes an intermediate member 3503A. In some embodiments, for example, the second connection counterpart 3508 is connected to the intermediate member 3503A. In some embodiments, for example, the connection counterpart-defining configuration 3503, which includes the second connection counterpart 3508 and the intermediate member 3503A, is of unitary one piece construction.

The bracket 3502, for example, the flange 3502A, is releasably couplable to the connection counterpart-defining configuration 3503, such that, while the bracket 3502 and the connection counterpart-defining configuration 3503 are releasably coupled, the relative displacement is effectible between the bracket 3502 and the connection counterpart-defining configuration 3503. In some embodiments, for example, adjusting of the spacing between the first and second connection counterparts 3506 and 3508 is effectible by relative displacement between the bracket 3502 and the connection counterpart-defining configuration 3503. In some embodiments, for example, the relative displacement effectible between the bracket 3502 and the connection counterpart-defining configuration 3503 includes sliding displacement.

In some embodiments, for example, the assembly 3500 includes a locking mechanism 3501 (e.g. a rotatable head, threaded rod or stud) and a slot 3507, defined by the bracket 3502, for releasably coupling the bracket 3502 and connection counterpart defining configuration 3503. The locking mechanism 3501 substantially corresponds to the locking mechanism 520 of the mounting assembly 500, and the slot 3507 substantially corresponds to the slot 524 of the assembly 500.

In some embodiments, for example, the flange 3502A includes a raised portion that defines a recess 3505, substantially similar to the recess 522 of the flange 503 of the mounting assembly 500, for receiving at least a portion of the connection counterpart-defining configuration 3503, in particular, for receiving at least a portion of the intermediate member 3503A. While the bracket 3502 and the connection counterpart-defining configuration 3503 are releasably coupled, at least a portion of the intermediate member 3503A is received in the recess 3505.

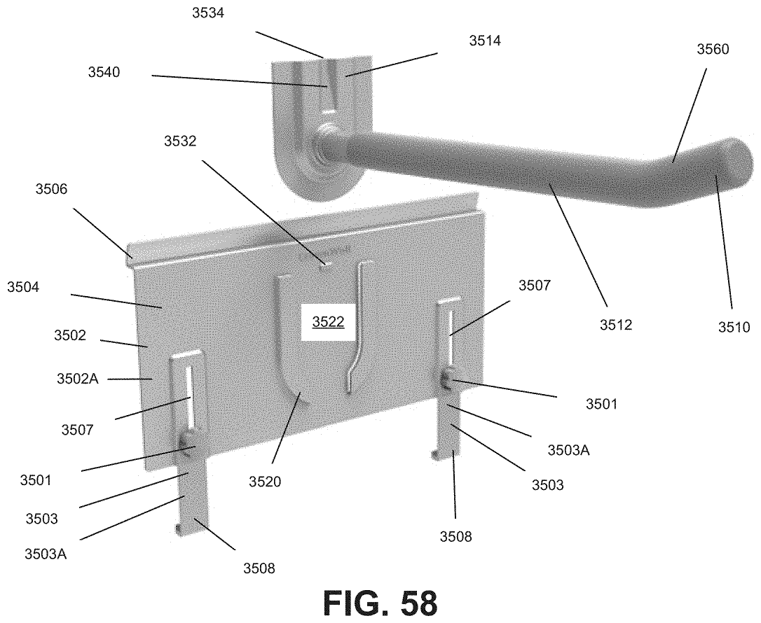

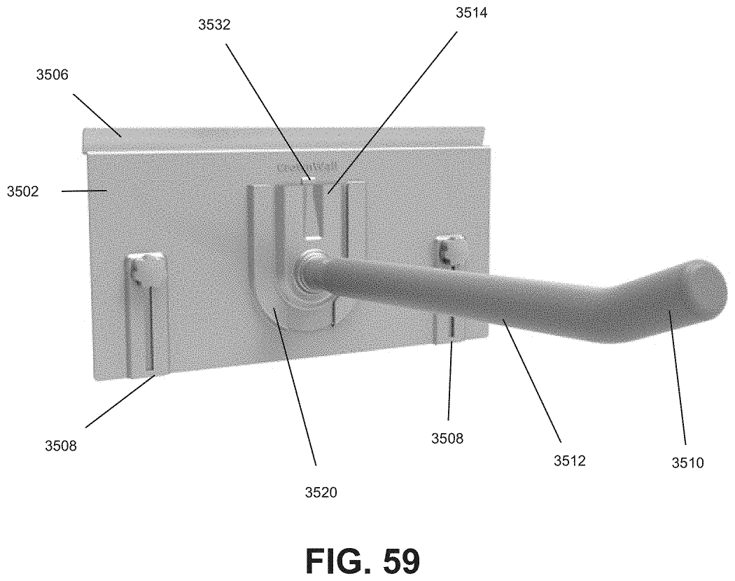

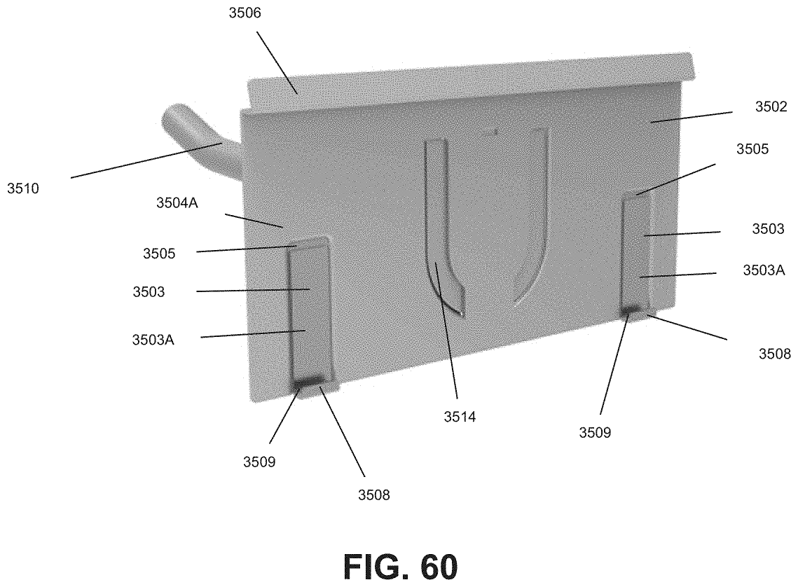

In some embodiments, for example, substantially similar to the assembly 500, the assembly 3500 is configurable in a retracted configuration, an extended configuration, and an intermediate configuration. In the retracted configuration, the spacing distance between the first connection counterpart 3506 and the second connection counterpart 3506 is a minimum spacing distance, as depicted in FIG. 59 and FIG. 60. In the extended configuration, the spacing distance between the first connection counterpart 3506 and the second connection counterpart 3508 is a maximum spacing distance, as depicted in FIG. 57 and FIG. 58. In the intermediate configuration, the spacing distance between the first connection counterpart 3506 and the second connection counterpart 3508 is between the minimum spacing distance and the maximum spacing distance.

In some embodiments, for example, the mounting assembly 3500 includes more than one connection counterpart 3508, to improve the gripping and securing of the bracket 3502 to the panel 100 or the wall panel assembly 10, for example, if the load to be supported by the mounting assembly 3500 is particularly heavy.

In this respect, in some embodiments, for example, the mounting assembly 3500 includes a plurality of connection counterpart defining configurations 3503, wherein each one of the connection counterpart defining configurations 3503, independently, defines a connection counterpart 3508, and includes an intermediate member 3503A. As depicted in FIG. 57 to FIG. 63, the mounting assembly 3500 includes two connection counterpart defining configurations 3503. In some embodiments, for example, for each one of the two connection counterpart 3508, the first connection counterpart 3506 and the connection counterpart 3508 is disposed on opposite ends of the bracket 3502. In some embodiments, for example, the two connection counterparts 3508 are disposed on the same end (e.g. bottom end) of the bracket 3502, as depicted in FIG. 57.

For each one of the plurality of connection counterpart defining configurations 3503, independently, spacing between the first connection counterpart 3506 and the second defined connection counterpart 3508 is adjustable so as to connect with different pairs of spaced apart panel-defined connection counterparts 39 having different spacing therebetween, and to grip and secure the mounting assembly 3500 to the panel 100 or wall panel assembly 10, similar to the manner by which the spacing between the connection counterparts 504 and 508 of the mounting assembly 500 is adjustable, for gripping and securing the mounting assembly 500 to the panel 100 or wall panel assembly 10.

For each one of the plurality of connection counterpart defining configurations 3503, independently, the assembly 3500 includes a locking mechanism 3501 (e.g. a rotatable head, threaded rod or stud) and a slot 3507, defined by the bracket 3502, for releasably coupling the bracket 3502 and connection counterpart defining configuration 3503.

For each one of the plurality of connection counterpart defining configurations 3503, independently, the flange 3502A includes a raised portion that defines a recess 3505, substantially similar to the recess 522 of the flange 503 of the mounting assembly 500, for receiving at least a portion of the connection counterpart-defining configuration 3503, in particular, for receiving at least a portion of the intermediate member 3503A.

In some embodiments, for example, the mounting assembly 3500 is hangable, connectible, and securable to a wall panel assembly 10 or a panel 100, similar to the manner by which the mounting assembly 500 is hangable, connectible, and securable to a wall panel assembly 10 or a panel 100.

In some embodiments, for example, the first connection counterpart 3506, the second connection counterparts 3508 are co-operatively configured for connection to a first wall surface configuration having a first pair of panel-defined connection counterparts 39 spaced apart by a first spacing distance, and further configured to be connected to a second wall surface configuration having a second pair of panel-defined connection counterparts 39 spaced apart by a second spacing distance.

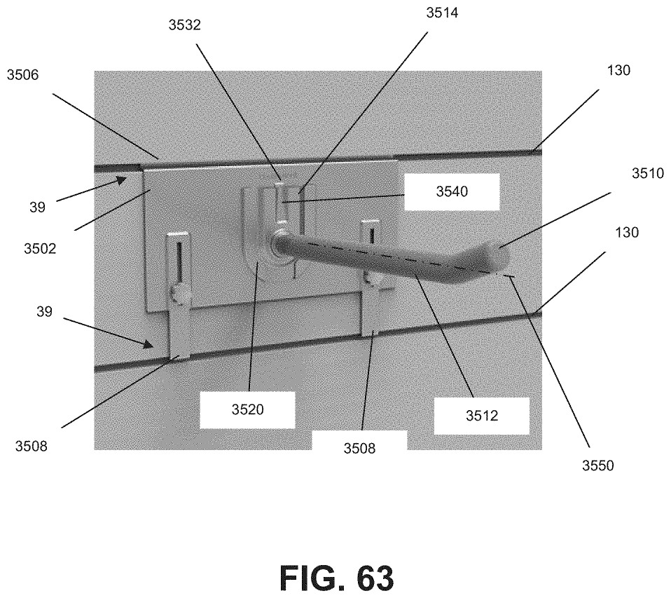

FIG. 62 depicts the bracket 3502 secured to the wall panel assembly 10 via the co-operative configuration of the first connection counterpart 3506 and the second connection counterparts 3508, and a pair of spaced apart panel-defined connection counterparts 130 of the wall panel assembly 10. FIG. 63 depicts the assembly 3500 secured to the wall panel assembly 10 via the co-operative configuration of the first connection counterpart 3506 and the second connection counterparts 3508, and a pair of spaced apart panel-defined connection counterparts 39 of the wall panel assembly 10.

Similar to the mounting assembly 500, for each one of the connection counterpart defining configurations 3503, independently, the connection between the bracket 3502 and the connection counterpart defining configuration 3503 is defeatable, for example, by defeating the connection between the rotatable head and the treaded stud of the locking mechanism 3501, and another connection counterpart defining configuration 3503 having an intermediate member 3503A of different length, is releasably couplable to the bracket 3502, to change the minimum and maximum spacing distances between the first connection counterpart 3506 and the second connection counterparts 35 08, based on the spacing distance between a pair of panel-defined connection counterparts 39 of the wall panel assembly 10, or the panel 100, to which the mounting assembly 3500 is to be connected and secured.

In some embodiments, for example, the mounting assembly 3500 further includes a load supporter 3510. The load supporter 3510 includes a load-supporting portion 3512, substantially similar to the load supporting portion 2912, that is configured to support a load 3400.

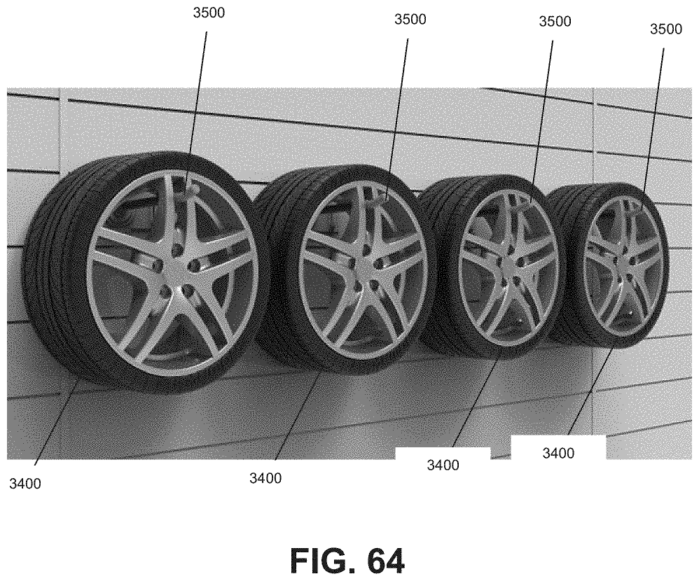

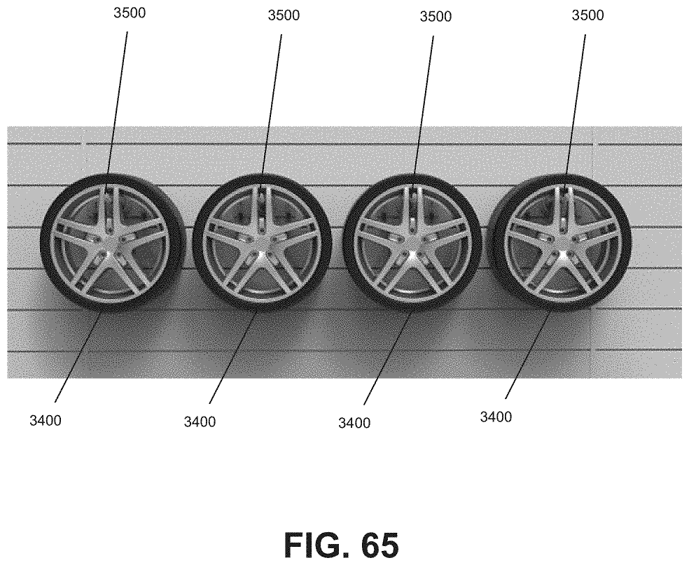

In some embodiments, for example, the load-supporting portion 3512 has a minimum length of at least 1 inch for extending through the aperture of the load 3400, for example, a wheel, such as a wheel of a bicycle or a wheel of an automobile, as depicted in FIG. 64 and FIG. 65.

In some embodiments, for example, while the assembly 3500 is hung from the wall panel assembly 10, and the load supporter 3510 is received in the cavity 3522, such that the retained configuration is established, the load supporting portion 3512 is disposed a minimum distance of at least 1/32 inch from the wall panel assembly 10.

In some embodiments, for example, the load supporter 3510 includes a load-retaining portion 3560, substantially similar to the load retaining portion 2940, configured to resist removal of a load that is supported by the load-supporting portion 3512. As depicted in FIG. 57 to FIG. 63, the load-retaining portion 3560 is angled relative to the load-supporting portion 3512. In some embodiments, for example, the acute angle defined between load supporting portion 3512 and the load-retaining portion 3560 has a minimum value of at least 5 degrees. Due to the angled disposition of the load-retaining portion 3560, relative to the load-supporting portion 3512, while a load is supported by the load-supporting portion 3512, if the load is displaced in a direction that is parallel to the axis 3550, the load will engage the load-retaining portion 3560, which will resist further displacement of the load in the direction that is parallel to the axis 3550. To remove the load, the direction of displacement of the load is to be changed, in particular, to a direction along an axis of extension of the load-retaining portion 3560, which is angled relative to the axis 3550.

In some embodiments, for example, the mounting assembly 3500 further comprises a retainer 3520. The front surface 3504 of the bracket 3502 and the retainer 3520 are co-operatively configured to define a cavity 3522 that is disposed between the front surface 3504 and the retainer 3520. In some embodiments, for example, the cavity 3522 is a pocket.

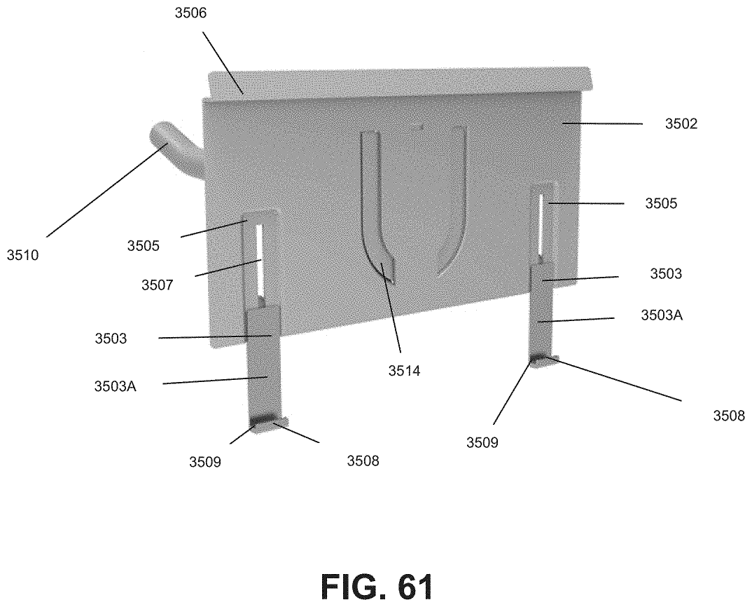

In some embodiments, for example, as depicted in FIG. 57 to FIG. 63, the retainer 3520 and the bracket 3502 are manufactured from the same piece of material. In this respect, in some embodiments, for example, the retainer 3520 and the bracket 3502 is of unitary one piece construction. In such embodiments, for example, the retainer 3520 is manufactured by punching a portion of the bracket 3502. The punching process cuts a portion of the bracket 3502 such that the cavity 3522 is defined between the retainer 3520 and the bracket 3502. In some embodiment, for example, the cavity 3522 is defined between the retainer 3520 and the front surface 3504 of the bracket 3502. As depicted in FIG. 60 and FIG. 61, while viewing the bracket 3502 from the rear, an aperture, due to the punching of the bracket 3502, is visible.

In some embodiments, for example, the bracket 3502 includes the retainer 3522.

In some embodiments, for example, the front surface 3504 of the bracket 3502, the retainer 3520, and the load supporter 3510 are co-operatively configured such that downwardly insertion of the load supporter 3510 into the cavity 3522 is with effect that the load supporter 3510 becomes disposed in a retained configuration.

In some embodiments, for example, in the retained configuration, the retainer 3520 is vertically supporting the load supporter 3510, and opposing displacement of the load supporter 3510, relative to the bracket 3502, in an outwardly direction relative to the front surface of the wall panel assembly 10, for example, in a direction that is normal to the front surface of the wall panel assembly 10. In some embodiments, for example, in the retained configuration, the retainer 3520 is vertically supporting the load supporter 3510, and opposing displacement of the load supporter 3510, relative to the bracket 3502, in an outwardly direction relative to the front surface 3504 of the bracket 3502, for example, in a direction that is normal to the front surface 3504 of the bracket 3502. In some embodiments, for example, in the retained configuration, the retainer 3520 is opposing displacement of the load supporter 3510, relative to the bracket 3502, in a lateral direction, for example, left and right directions. In some embodiments, for example, in the retained configuration, the retainer 3520 is opposing displacement of the load supporter 3510, in a lateral direction, for example, left and right directions, relative to the front surface of the wall panel assembly 10.

As depicted in FIG. 57 and FIG. 59, in some embodiments, for example, in the retained configuration, the load supporter 3510 is disposed, relative to the bracket 3502, such that the load-supporting portion 3512 extends outwardly, relative to the front surface of the wall panel assembly 10. In some embodiments, for example, in the retained configuration, the load supporter 3510 is disposed, relative to the bracket 3502, such that the load-supporting portion 3512 extends in a direction along an axis 3550 that traverses a plane defined by the front surface of the wall panel assembly 10. In some embodiments, for example, in the retained configuration, the traversing of the plane defined by the front surface of the wall panel assembly 10 by the extension axis of the load-supporting portion 3512 is such that the axis 3550 is normal to the plane defined by the front surface of the wall panel assembly 10. In some embodiments, for example, in the retained configuration, the traversing of the plane defined by the front surface of the wall panel assembly 10 by the extension axis 3550 of the load-supporting portion 3512 is such that the axis 3550 is angled relative to the plane defined by the front surface of the wall panel assembly 10 (e.g. extending to the left or to the right), and that the axis 3550 and the plane define an acute angle therebetween. In some embodiments, for example, in the retained configuration, the acute angle defined between the axis 3550 and the plane defined by the front surface of the wall panel assembly has a minimum value of at least 60 degrees.

In some embodiments, for example, in the retained configuration, the load-supporting portion 3512 extends outwardly and in an upward direction, relative to the front surface of the wall panel assembly 10. In this respect, in some embodiments, for example, the axis 3550 is angled relative to a normal axis of the plane defined by the front surface of the wall panel assembly 10, the axis 3550 and the normal axis defining an acute angle. In some embodiments, for example, in the support-ready configuration, the acute angle defined between the axis 3550 and the normal axis of the plane defined by the front surface of the wall panel assembly has a minimum value of at least 1 degree.

In some embodiments, for example, in the retained configuration, the load-supporting portion 3512 extends outwardly and in a downward direction, relative to the front surface of the wall panel assembly 10. In this respect, in some embodiments, for example, the axis 3550 is angled relative to a normal axis of the plane defined by the front surface of the wall panel assembly 10, the axis 3550 and the normal axis defining an acute angle. In some embodiments, for example, in the support-ready configuration, the acute angle defined between the axis 3550 and the normal axis of the plane defined by the front surface of the wall panel assembly has a maximum value of 5 degrees.

In some embodiments, for example, in the retained configuration, the load supporter 3510 is disposed, relative to the bracket 3502, such that the load-supporting portion 3512 extends outwardly, relative to the front surface 3504 of the bracket 3502. In some embodiments, for example, in the retained configuration, the load supporter 3510 is disposed, relative to the bracket 3502, such that the load-supporting portion 3512 extends in a direction along an axis 3550 that traverses a plane defined by the front surface 3504 of the bracket 3502. In some embodiments, for example, in the retained configuration, the traversing of the plane defined by the front surface of the wall panel assembly 10 by the extension axis of the load-supporting portion 3512 is such that the axis 3550 is normal to the plane defined by the front surface 3504 of the bracket 3502. In some embodiments, for example, in the retained configuration, the traversing of the plane defined by the front surface 3504 of the bracket 3502 by the extension axis of the load-supporting portion 3512 is such that the axis 3550 is angled relative to the plane defined by the front surface 3504 of the bracket 3502 (e.g. extending to the left or to the right), and that the axis 3550 and the plane define an acute angle therebetween. In some embodiments, for example, in the retained configuration, the acute angle defined between the axis 3550 and the plane defined by the front surface 3504 of the bracket 3502 has a minimum value of at least 60 degrees.

In some embodiments, for example, in the retained configuration, the load-supporting portion 3512 extends outwardly and in an upward direction, relative to the front surface 3504 of the bracket 3502. In this respect, in some embodiments, for example, the axis 3550 is angled relative to a normal axis of the plane defined by the front surface 3504 of the bracket 3502, the axis 3550 and the normal axis defining an acute angle. In some embodiments, for example, in the support-ready configuration, the acute angle defined between the axis 3550 and the normal axis of the plane defined by the front surface 3504 of the bracket 3502 has a minimum value of at least 1 degree.

In some embodiments, for example, in the support-ready configuration, the load-supporting portion 3512 extends outwardly and in a downward direction, relative to the front surface 3504 of the bracket 3502. In this respect, in some embodiments, for example, the axis 3550 is angled relative to a normal axis of the plane defined by the front surface 3504 of the bracket 3502, the axis 3550 and the normal axis defining an acute angle. In some embodiments, for example, in the support-ready configuration, the acute angle defined between the axis 3550 and the normal axis of the plane defined by the front surface 3504 of the bracket 3502 has a maximum value of 5 degrees.

In some embodiments, for example, while: (i) the bracket 3502 is hung from the wall panel assembly 10, and (ii) the load supporter 3510 is received in the cavity 3522, such that the retained configuration is established, the releasing of the load supporter 3510 is effectible in response to displacement of the load supporter 3510 in an upward direction.

In some embodiments, for example, the load supporter 3510 includes a load supporter panel 3514. As depicted in FIG. 57 to FIG. 63, the load supporter panel 3514 is connected to the load-supporting portion 3512, for example, by fasteners, welding, adhesives, and the like. In some embodiments, for example, the load supporter panel 3514 is connected to a side of the load supporting portion 3512 that is opposite the side of the load supporting portion 3512 in which the load retaining portion 3560 is disposed. In some embodiments, for example, the downwardly insertion of the load supporter 3510 into the cavity 3522 for disposition of the load supporter 3510 in the retained configuration is effected by downwardly displacement of the load supporter panel 3514 into the cavity 3522.

In some embodiments, for example, the load supporter panel 3514 includes one or more folds to increase the strength of the load supporter panel 3514.

In some embodiments, for example, the mounting assembly 3500 includes a release mechanism 3530. While the load supporter 3510 is disposed in the cavity 3522, the release mechanism 3530 is configured to: (i) retain the load supporter 3510 in the cavity 3522, and (ii) effect the release of the load supporter 3510 from the cavity 3522 while the load supporter 3510 is retained in the cavity 3522.

The releasing mechanism 3530 includes a bracket-defined releasing counterpart 3532 and a load supporter-defined releasing counterpart 3534, as depicted in FIG. 58 and FIG. 62. In some embodiments, for example, the bracket-defined releasing counterpart 3532 is a detent defined by the bracket 3502. In some embodiments, for example, the load supporter-defined releasing counterpart 3534 is an edge surface of the load supporter 3510. In some embodiments, for example, the load supporter-defined releasing counterpart 3534 includes a detent defined by the load supporter 3510. In some embodiments, for example, the load supporter-defined releasing counterpart 3534 is defined by the load supporter panel 3514. In some embodiments, for example, the load supporter-defined releasing counterpart 3534 is defined by an edge surface of the load supporter panel 3514. In some embodiments, for example, the load supporter-defined releasing counterpart 3534 includes a detent defined by the load supporter panel 3514.

In some embodiments, for example, at least one of the bracket-defined releasing counterpart 3532 and the load supporter-defined releasing counterpart 3534 is transitionable between a release-ineffective configuration and a release-effective configuration.

In some embodiments, for example, the cavity 3522, the load support panel 3514, and the release mechanism 3530 are co-operatively configured such that, while: (i) the bracket is connected to the wall panel assembly, for example, hung from a recess of the wall panel assembly 10, (ii) the load supporter panel 3514 is received in the cavity 3522, and (iii) while the at least one of the bracket-defined releasing counterpart 3532 and the load supporter-defined releasing counterpart 3534 is disposed in the release-ineffective configuration, the bracket-defined releasing counterpart 3532 is disposed in opposing relationship relative to the load supporter-defined releasing counterpart 3534 (e.g. the bracket-defined releasing counterpart 3532 is disposed above the load supporter-defined releasing counterpart 3534), such that displacement of the load supporter 3510, relative to the cavity 3522, in an upwardly direction, is opposed with effect that the releasing of the load supporter 3510 from the cavity 3522 is prevented. In some embodiments, for example, the opposing of displacement of the load supporter 3510, relative to the cavity, in an upward direction, is such that displacement of the load supporter panel 3514, relative to the cavity 3522, in the upwardly direction, is opposed.

In some embodiments, for example, the cavity 3522, the load support panel 3514, and the release mechanism 3530 are co-operatively configured such that, while: (i) the bracket is connected to the wall panel assembly, and (ii) the load supporter panel 3514 is received in the cavity 3522, and (iii) while the at least one of the bracket-defined releasing counterpart 3532 and the load supporter-defined releasing counterpart 3534 is disposed in the release-effective configuration, the load support panel 3514 is displaceable, relative to the cavity 3522, in an upward direction, to release the load supporter panel 3514 from the cavity 3522.

In some embodiments, for example, the at least one of the bracket-defined releasing counterpart 3532 and the load supporter-defined releasing counterpart 3534 is deformable, for example, resiliently deformable, to effect the transitioning of the at least one of the bracket-defined releasing counterpart 3532 and the load supporter-defined releasing counterpart 3534 from the release-ineffective configuration to the release-effective configuration. The deformation of the at least one of the bracket-defined releasing counterpart 3532 and the load supporter-defined releasing counterpart 3534 is with effect that the opposing of displacement of the load supporter panel 3514, relative to the cavity 3522, in the upward direction, is defeated.

In some embodiments, for example, the at least one of the bracket-defined releasing counterpart 3532 and the load supporter-defined releasing counterpart 3534 is biased to the release-ineffective configuration.

In some embodiments, for example, the transition of the at least one of the bracket-defined releasing counterpart 3532 and the load supporter-defined releasing counterpart 3534 from the release-ineffective configuration to the release-effective configuration is effected by depression of the at least one of the bracket-defined releasing counterpart 3532 and the load supporter-defined releasing counterpart 3534. In some embodiments, for example, while the at least one of the bracket-defined releasing counterpart 3532 and the load supporter-defined releasing counterpart 3534 is being depressed for disposition of the at least one of the bracket-defined releasing counterpart 3532 and the load supporter-defined releasing counterpart 3534 in the release-effective configuration, the transition of the at least one of the bracket-defined releasing counterpart 3532 and the load supporter-defined releasing counterpart 3534 from the release-effective configuration to the release-ineffective configuration is effected by release of the depression of the at least one of the bracket-defined releasing counterpart 3532 and the load supporter-defined releasing counterpart 3534.

In some embodiments, for example, the transitioning of the at least one of the bracket-defined releasing counterpart 3532 and the load supporter-defined releasing counterpart 3534 between the release-ineffective configuration and the release-effective configuration is effected by the bracket-defined releasing counterpart 3532. In this respect, in some embodiments, for example, the bracket-defined releasing counterpart 3532 is transitionable between a release-ineffective configuration and a release-effective configuration.

In some embodiments, for example, in the release-ineffective configuration, the bracket-defined releasing counterpart 3532 extends outwardly from the front surface 3504 of the bracket 3502. In some embodiments, for example, in the release-ineffective configuration, the outermost surface of the bracket-defined releasing counterpart 3532 extends outwardly from, and is off set from, the front surface 3504 of the bracket 3502.

In some embodiments, for example, in the release-effective configuration, there is an absence of outward extension of the bracket-defined releasing counterpart 3532 relative to the front surface 3504 of the bracket 3502. In some embodiments, for example, in the release-effective configuration, the outermost surface of the bracket-defined releasing counterpart 3532 and the front surface 3504 of the bracket 3502 are co-planar.

In some embodiments, for example, the cavity 3522, the load support panel 3514, and the release mechanism 3530 are co-operatively configured such that, while: (i) the bracket is connected to the wall panel assembly, for example, hung from a recess of the wall panel assembly 10, (ii) the load supporter panel 3514 is received in the cavity 3522, and (iii) while the bracket-defined releasing counterpart 3532 is disposed in the release-ineffective configuration, the bracket-defined releasing counterpart 3532 is disposed in opposing relationship relative to the load supporter-defined releasing counterpart 3534 (e.g. the bracket-defined releasing counterpart 3532 is disposed above the load supporter-defined releasing counterpart 3534), such that displacement of the load supporter 3510, relative to the cavity 3522, in an upwardly direction, is opposed, with effect that the releasing of the load supporter 3510 from the cavity 3522 is prevented. In some embodiments, for example, the opposing of displacement of the load supporter 3510, relative to the cavity 3522, in an upward direction, is such that the displacement of the load supporter panel 3514, relative to the cavity 3522, in the upwardly direction, is opposed.

In some embodiments, for example, the cavity 3522, the load support panel 3514, and the release mechanism 3530 are co-operatively configured such that, while: (i) the bracket is connected to the wall panel assembly, and (ii) the load supporter panel 3514 is received in the cavity 3522, and (iii) while the bracket-defined releasing counterpart 3532 is disposed in the release-effective configuration, the load support panel 3514 is displaceable, relative to the cavity 3522, in an upward direction, to release the load supporter panel 3514 from the cavity 3522.

In some embodiments, for example, the bracket-defined releasing counterpart 3532 is deformable, for example, resiliently deformable, to effect the transitioning of the bracket-defined releasing counterpart 3532 from the release-ineffective configuration to the release-effective configuration. The deformation of the bracket-defined releasing counterpart 3532 is with effect that the opposing of displacement of the load supporter panel 3514, relative to the cavity 3522, in the upward direction, is defeated.

In some embodiments, for example, the bracket-defined releasing counterpart 3532 is biased to the release-ineffective configuration.

In some embodiments, for example, the transition of the bracket-defined releasing counterpart 3532 from the release-ineffective configuration to the release-effective configuration is effected by depression of the bracket-defined releasing counterpart 3532 (e.g. by pushing on the bracket-defined release counterpart 3532). In some embodiments, for example, while the bracket-defined releasing counterpart 3532 is being depressed for disposition of the bracket-defined releasing counterpart 3532 in the release-effective configuration, the transition of the bracket-defined releasing counterpart 3532 from the release-effective configuration to the release-ineffective configuration is effected by release of the depression of the bracket-defined releasing counterpart 3532.

In some embodiments, for example, the transitioning of the at least one of the bracket-defined releasing counterpart 3532 and the load supporter-defined releasing counterpart 3534 between the release-ineffective configuration and the release-effective configuration is effected by the load supporter-defined releasing counterpart 3534. In this respect, in some embodiments, for example, the load supporter-defined releasing counterpart 3534 is transitionable between a release-ineffective configuration and a release-effective configuration.

In some embodiments, for example, in the release-ineffective configuration, there is an absence of inward extension of the load supporter-defined releasing counterpart 3534 relative to the rear surface of the load supporter panel 3514. In some embodiments, for example, in the release-ineffective configuration, the outermost surface of the load supporter-defined releasing counterpart 3534 and the rear surface of the load supporter panel 3514 are co-planar.

In some embodiments, for example, in the release-effective configuration, the load supporter-defined releasing counterpart 3534 extends inwardly from the rear surface of the load supporter panel 3514. In some embodiments, for example, in the release-effective configuration, the outermost surface of the load supporter-defined releasing counterpart 3534 extends inwardly from, and is off set from, the rear surface of the load supporter panel 3514.

In some embodiments, for example, the cavity 3522, the load support panel 3514, and the release mechanism 3530 are co-operatively configured such that, while: (i) the bracket is connected to the wall panel assembly, for example, hung from a recess of the wall panel assembly 10, (ii) the load supporter panel 3514 is received in the cavity 3522, and (iii) while the load supporter-defined releasing counterpart 3534 is disposed in the release-ineffective configuration, the bracket-defined releasing counterpart 3532 is disposed in opposing relationship relative to the load supporter-defined releasing counterpart 3534 (e.g. the bracket-defined releasing counterpart 3532 is disposed above the load supporter-defined releasing counterpart 3534), such that displacement of the load supporter 3510, relative to the cavity 3522, in an upwardly direction, is opposed, with effect that the releasing of the load supporter 3510 from the cavity 3522 is prevented. In some embodiments, for example, the opposing of displacement of the load supporter 3510, relative to the cavity 3522, in an upward direction, is such that displacement of the load supporter panel 3514, relative to the cavity 3522, in the upwardly direction, is opposed.

In some embodiments, for example, the cavity 3522, the load support panel 3514, and the release mechanism 3530 are co-operatively configured such that, while: (i) the bracket is connected to the wall panel assembly, and (ii) the load supporter panel 3514 is received in the cavity 3522, and (iii) while the load supporter-defined releasing counterpart 3534 is disposed in the release-effective configuration, the load support panel 3514 is displaceable, relative to the cavity 3522, in an upward direction, to release the load supporter panel 3514 from the cavity 3522.

In some embodiments, for example, the load supporter-defined releasing counterpart 3534 is deformable, for example, resiliently deformable, to effect the transitioning of the load supporter-defined releasing counterpart 3534 from the release-ineffective configuration to the release-effective configuration. The deformation of the load supporter-defined releasing counterpart 3534 is with effect that the opposing of displacement of the load supporter panel 3514, relative to the cavity 3522, in the upward direction, is defeated.

In some embodiments, for example, the load supporter-defined releasing counterpart 3534 is biased to the release-ineffective configuration.

In some embodiments, for example, the transition of the load supporter-defined releasing counterpart 3534 from the release-ineffective configuration to the release-effective configuration is effected by depression of the load supporter-defined releasing counterpart 3534 (e.g. by pulling on the load supporter-defined releasing counterpart 3534). In some embodiments, for example, while the load supporter-defined releasing counterpart 3534 is being depressed for disposition of the load supporter-defined releasing counterpart 3534 in the release-effective configuration, the transition of the load supporter-defined releasing counterpart 3534 from the release-effective configuration to the release-ineffective configuration is effected by release of the depression of the bracket-defined releasing counterpart 3532.

In some embodiments, for example, each one the bracket-defined releasing counterpart 3532 and the load supporter-defined releasing counterpart 3534, independently, is transitionable between a release-ineffective configuration and a release-effective configuration.

In some embodiments, for example, the load supporter 3510 includes a surface 3540. In some embodiments, for example, the surface 3540 is an urging surface 3540 for urging deformation of the bracket-defined releasing counterpart 3532 from the release-ineffective configuration to the release-effective configuration. In some embodiments, for example, the urging surface 3540 is defined by the load supporter panel 3514. As depicted in FIG. 57, while the load supporter panel 3514 is retained in the cavity 3522, or, as depicted in FIG. 58, while the load supporter panel 3514 is disposed in a retention-ready configuration such that the load supporter panel 3514 is insertable into the cavity 3522 for retention by the cavity 3522, the urging surface 3540 is angled, relative to the front surface 3504 of the bracket 3502. In some embodiments, for example, the urging surface 3540 is angled, relative to the rear surface of the load supporter panel 3514. In some embodiments, for example, the minimum angle defined between the urging surface 3540 and the front surface 3504 is at least 1 degree. In some embodiments, for example, the minimum angle defined between the urging-effectible surface 3540 and the rear surface of the load supporter panel 3514 is at least 1 degree. In some embodiments, for example, the urging surface 3540 is configured to engage with the bracket-defined releasing counterpart 3532, and to urge the bracket-defined releasing counterpart 3532 in a direction towards the front surface 3504 of the bracket 3502, to deform the bracket-defined releasing counterpart 3532 and transition the bracket-defined releasing counterpart 3532 from the release-ineffective configuration to the release-effective configuration, such that load supporter 3510, for example, the load supporter panel 3514, is insertable into the cavity 3522.

In some embodiments, for example, the surface 3540 is an urging-effectible surface 3540 for effecting urging deformation of the load supporter-defined releasing counterpart 3534 from the release-ineffective configuration to the release-effective configuration. In some embodiments, for example, the urging-effectible surface 3540 is defined by the load supporter panel 3514. As depicted in FIG. 57, while the load supporter panel 3514 is retained in the cavity 3522, or, as depicted in FIG. 58, while the load supporter panel 3514 is disposed in a retention-ready configuration such that the load supporter panel 3514 is insertable into the cavity 3522 for retention by the cavity 3522, the urging-effectible surface 3540 is angled, relative to the front surface 3504 of the bracket 3502. In some embodiments, for example, the urging surface 3540 is angled, relative to the rear surface of the load supporter panel 3514. In some embodiments, for example, the minimum angle defined between the urging-effectible surface 3540 and the front surface 3504 is at least 1 degree. In some embodiments, for example, the minimum angle defined between the urging-effectible surface 3540 and the rear surface of the load supporter panel 3514 is at least 1 degree. In some embodiments, for example, the urging-effectible surface 3540 is configured to engage with the bracket-defined releasing counterpart 3532, and to be urged by the bracket-defined releasing counterpart 3532 in a direction away from the front surface 3504 of the bracket 3502, to deform the load supporter-defined releasing counterpart 3534 and transition the load supporter-defined releasing counterpart 3534 from the release-ineffective configuration to the release-effective configuration, such that load supporter 3510, for example, the load supporter panel 3514, is insertable into the cavity 3522.

To support a load 3400 via the wall panel assembly 10 with the mounting assembly 3500, the bracket 3502 is first hung from, and then secured to the wall panel assembly 10, first connection counterpart 3506, the second connection counterparts 3508, as depicted in FIG. 62, similar to the manner by which the mounting assembly 500 is hung and secured to the wall panel assembly 10. At this point, the bracket-defined releasing counterpart 3532 is disposed in the release-ineffective configuration. Then, while the load supporter 3510 is disposed above the bracket 3502, the load supporter 3510 is lowered for inserting the load supporter 3510, for example, the load supporter panel 3514, in the cavity 3522.

In some embodiments, for example, wherein the surface 3540 is the urging surface 3540, the load supporter 3510 is lowered until the urging surface 3540 is engaged to the bracket-defined releasing counterpart 3532. In response to further displacement of the load supporter panel 3514 towards the cavity 3522, an urging force is applied by the urging surface 3540 to the bracket-defined releasing counterpart 3532. Due to the angle of the urging surface 3540 relative to the front surface 3504 of the bracket 3502, the force applied by the urging surface 3540 to the bracket-defined releasing counterpart 3532 includes a component that has a direction that is normal to and towards the front surface 3504 of the bracket 3502. The force applied by the urging surface 3540 to the bracket-defined releasing counterpart 3532 is with effect that the bracket-defined releasing counterpart 3532 is deformed, for urging transitioning from the release-ineffective configuration to the release-effective configuration. As the load supporter panel 3514 continues to be lowered towards the cavity 3522, the bracket-defined releasing counterpart 3532 is further urged to transitioned from the release-ineffective configuration to the release-effective configuration, until the bracket-defined releasing counterpart 3532 becomes disposed in the release-effective configuration, At this point, with the bracket-defined releasing counterpart 3532 disposed in the release-effective configuration, the load supporter 3510 has displaced past the bracket-defined releasing counterpart 3532, and is further displaced towards the bracket 3502 until the load supporter 3510, for example, the load supporter panel 3514, is inserted in the cavity 3522, with effect that the load supporter 3510 becomes disposed in the retained configuration, as depicted in FIG. 63. During the displacement of the load supporter 3510 towards the cavity 3522, the load supporter panel 3514, for example, the urging surface 3540, is disposed in opposing relationship with the bracket-defined releasing counterpart 3532, which opposes outward displacement of the bracket-defined releasing counterpart 3532. While the load supporter 3510 is inserted in the cavity 3522, the load supporter panel 3514, for example, the urging surface 3540, is no longer disposed in opposing relationship with the bracket-defined releasing counterpart 3532. While the urging surface 3540 is no longer disposed in opposing relationship with the bracket-defined releasing counterpart 3532, due to the bias of the bracket-defined releasing counterpart 3532, the bracket-defined releasing counterpart 3532 is transitioned from the release-effective configuration to the release-ineffective configuration. While the load supporter panel 3514 is disposed in the cavity 3532, and while the bracket-defined releasing counterpart 3532 is disposed in the release-ineffective configuration, the bracket-defined releasing counterpart 3532 is disposed in opposing relationship relative to the load supporter-defined releasing counterpart 3534 (e.g. the bracket-defined releasing counterpart 3532 is disposed above the load supporter-defined releasing counterpart 3534), such that displacement of the load supporter 3510, relative to the cavity 3522, in an upward direction, is opposed, to prevent release of the load supporter 3510 from the cavity 3522. At this point, a load 3400, for example, a wheel of an automobile, can be supported by the load-supporting portion 3512, as depicted in FIG. 64 and FIG. 65. While the mounting assembly 3500 is secured to the wall panel assembly 10 and the load 3400 is supported by the load-supporting portion 3512, the load 3400 is supported by the wall panel assembly 10 via the connection between the mounting assembly 3500 and the wall panel assembly 10.

To move the load supporter 3510 from the cavity 3522, the load 3400 is first removed, for example, by a user. Then, the bracket-defined releasing counterpart 3532 is transitioned from the release-ineffective configuration to the release-effective configuration. In some embodiments, for example, such transition is effected by depression of the bracket-defined releasing counterpart 3532 by a user. While the bracket-defined releasing counterpart 3532 is disposed in the release-effective configuration, the load support panel 3514 is displaced, relative to the cavity 3522, in an upward direction, to release the load supporter panel 3514, and therefore, the load supporter 3510 from the cavity 3522, as depicted in FIG. 62.

In some embodiments, for example, wherein the surface 3540 is the urging-effectible surface 3540, the load supporter 3510 is lowered until the urging-effectible surface 3540 is engaged to the bracket-defined releasing counterpart 3532. In response to further displacement of the load supporter panel 3514 towards the cavity 3522, an urging force is applied by the bracket-defined releasing counterpart 3532 to the urging-effectible surface 3540. Due to the angle of the urging-effectible surface 3540 relative to the front surface 3504 of the bracket 3502, the force applied by the bracket-defined releasing counterpart 3532 to the urging-effectible surface 3540 includes a component that has a direction that is normal to and away from the front surface 3504 of the bracket 3502. The force applied by the bracket-defined releasing counterpart 3532 to the urging-effectible surface 3540 is with effect that the load supporter-defined releasing counterpart 3534 is deformed, for urging transitioning from the release-ineffective configuration to the release-effective configuration. As the load supporter panel 3514 continues to be lowered towards the cavity 3522, the load supporter-defined releasing counterpart 3534 is further urged to transitioned from the release-ineffective configuration to the release-effective configuration, until the load supporter-defined releasing counterpart 3534 becomes disposed in the release-effective configuration, At this point, with the load supporter-defined releasing counterpart 3534 disposed in the release-effective configuration, the load supporter 3510 has displaced past the bracket-defined releasing counterpart 3532, and is further displaced towards the bracket 3502 until the load supporter 3510, for example, the load supporter panel 3514, is inserted in the cavity 3522, with effect that the load supporter 3510 becomes disposed in the retained configuration, as depicted in FIG. 63. During the displacement of the load supporter 3510 towards the cavity 3522, the load supporter panel 3514, for example, the urging-effectible surface 3540, is disposed in opposing relationship with the bracket-defined releasing counterpart 3532, which opposes outward displacement of the load supporter-defined releasing counterpart 3534. While the load supporter 3510 is inserted in the cavity 3522, the load supporter panel 3514, for example, the urging-effectible surface 3540, is no longer disposed in opposing relationship with the bracket-defined releasing counterpart 3532. While the urging-effectible surface 3540 is no longer disposed in opposing relationship with the bracket-defined releasing counterpart 3532, due to the bias of the load supporter-defined releasing counterpart 3534, the load supporter-defined releasing counterpart 3534 is transitioned from the release-effective configuration to the release-ineffective configuration. While the load supporter panel 3514 is disposed in the cavity 3532, and while the load supporter-defined releasing counterpart 3534 is disposed in the release-ineffective configuration, the bracket-defined releasing counterpart 3532 is disposed in opposing relationship relative to the load supporter-defined releasing counterpart 3534 (e.g. the bracket-defined releasing counterpart 3532 is disposed above the load supporter-defined releasing counterpart 3534), such that displacement of the load supporter 3510, relative to the cavity 3522, in an upward direction, is opposed, to prevent release of the load supporter 3510 from the cavity 3522. At this point, a load 3400, for example, a wheel of an automobile, can be supported by the load-supporting portion 3512, as depicted in FIG. 64 and FIG. 65. While the mounting assembly 3500 is secured to the wall panel assembly 10 and the load 3400 is supported by the load-supporting portion 3512, the load 3400 is supported by the wall panel assembly 10 via the connection between the mounting assembly 3500 and the wall panel assembly 10.

To move the load supporter 3510 from the cavity 3522, the load 3400 is first removed, for example, by a user. Then, the load supporter-defined releasing counterpart 3534 is transitioned from the release-ineffective configuration to the release-effective configuration. In some embodiments, for example, such transition is effected by outward pulling of the load supporter-defined releasing counterpart 3534 by a user. While the load supporter-defined releasing counterpart 3534 is disposed in the release-effective configuration, the load support panel 3514 is displaced, relative to the cavity 3522, in an upward direction, to release the load supporter panel 3514 from the cavity 3522, as depicted in FIG. 62.

In some embodiments, for example, while the surface 3540 is engaged to the bracket-defined releasing counterpart 3532, in response to further displacement of the load supporter panel 3514 towards the cavity 3522: 1) an urging force is applied by the surface 3540 to the bracket-defined releasing counterpart 3532, and 2) an urging force is applied by the bracket-defined releasing counterpart 3532 to the urging-effectible surface 3540. The force applied by the surface 3540 to the bracket-defined releasing counterpart 3532 is with effect that the bracket-defined releasing counterpart 3532 is deformed, for urging transitioning from the release-ineffective configuration to the release-effective configuration, and the force applied by the bracket-defined releasing counterpart 3532 to the surface 3540 is with effect that the load supporter-defined releasing counterpart 3534 is deformed, for urging transitioning from the release-ineffective configuration to the release-effective configuration. In such embodiments, for example, each one of the bracket-defined releasing counterpart 3532 and the load supporter-defined releasing counterpart 3534, independently, is urged to transition from the release-ineffective configuration to the release-effective configuration, to effect the insertion of the load support panel 3514 in the cavity 3522.

In some embodiments, for example, it is desirable for the load supporter 3510 to be releasably removable from the bracket 3502. While a load is to be supported by the assembly 3500, the load supporter 3510 is inserted into the cavity 3522 to retain the load supporter 3510. While a load does not need to be supported by the assembly 3500, the load supporter 3510 is releasable from the cavity 3522, such that less space is taken up by the assembly 3500. This allows the load supporter 3510 to be stored away, which creates more space for users to safely walk by the wall panel assembly 10, or to work around the wall panel assembly 10, on which the bracket 3502 is hung and secured. In some embodiments, for example, depending on the shape, size, or weight of the load to be supported, a first load supporter 3510 having a first configuration is removed from the bracket 3502, and a second load supporter 3510 having a second configuration is inserted into the cavity 3522 for supporting the load. For example, the first load supporter 3510 can include a hook (for example, the hook depicted in FIG. 57), and the second load supporter 3510 can include a loop. In this respect, in some embodiments, for example, the bracket 3502 is configured to retain load supporters 3510 of different configurations, such that the load supporters 3510 are interchangeable. In some embodiments, for example, the load supporter 3510 can include a hook of various shapes. In some embodiments, for example, the load supporter 3510 can include a hanging rod that is retainable by two brackets 3502, such as a hanging rod for clothes or coats.

In some embodiments, for example, the mounting assembly 3500 is released from retention from the wall panel assembly 10, for example, by rotating the first connection counterpart 3506 via rotation of the assembly 3500 and displacing the assembly 350 from the wall panel assembly 10, as described herein with respect to bracket connector 504 and the cavity 130. In some embodiments, for example, while the assembly 3500 is released from the wall panel assembly 10, the assembly 3500 is repositionable to another part of the wall panel assembly 10 and hangable, connectible, and securable to the wall panel assembly 10 at said another part of the wall panel assembly 10, or is repositionable to another wall panel assembly 10 and hangable, connectible, and securable to said another wall panel assembly 10. In some embodiments, for example, the load supporter 3510 can first be removed from the cavity 3522, and then the remainder of the assembly 3500 is released from retention from the wall panel assembly 10.

In some embodiments, for example, a kit for the mounting assembly 3500 includes a bracket 3502, including a front surface 3504, and a retainer 3520, wherein a cavity 3522 disposed between the front surface 3504 and the retainer 3520. The kit further includes a load supporter 3510, including a load-supporting portion 3512 configured to support a load, such as load 3400. The front surface 3504 of the bracket 3502, the retainer 3520 of the bracket 3502, and the load supporter 3510 are co-operatively configured such that downwardly insertion of the load supporter 3510 into the cavity 3522 is with effect that the load supporter 3510 becomes disposed in the retained configuration, as described herein. In some embodiments, for example, the load supporter 3510 of the kit for the mounting assembly 3500 further includes the load supporter panel 3514. In some embodiments, for example, the kit for the mounting assembly 3500 further includes the release mechanism 3514.

In some embodiments, for example, the material of the bracket 3502 includes steel. In some embodiments, for example, the material of the bracket 3502 includes plastic. In some embodiments, for example, the material of the retainer 3520 includes steel. In some embodiments, for example, the material of the retainer 3520 includes plastic. In some embodiments, for example, the material of the load supporter 3510 includes steel. In some embodiments, for example, the material of the load supporter 3510 includes plastic.

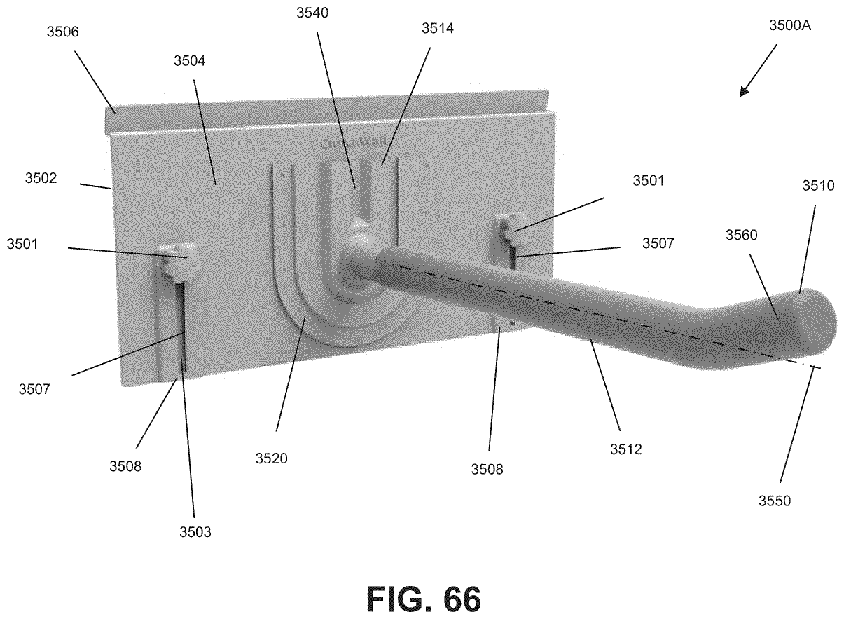

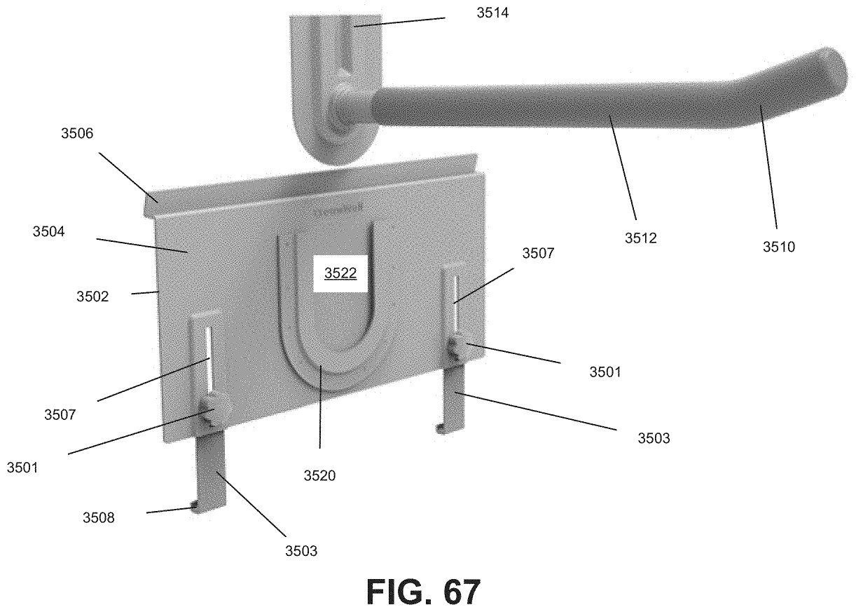

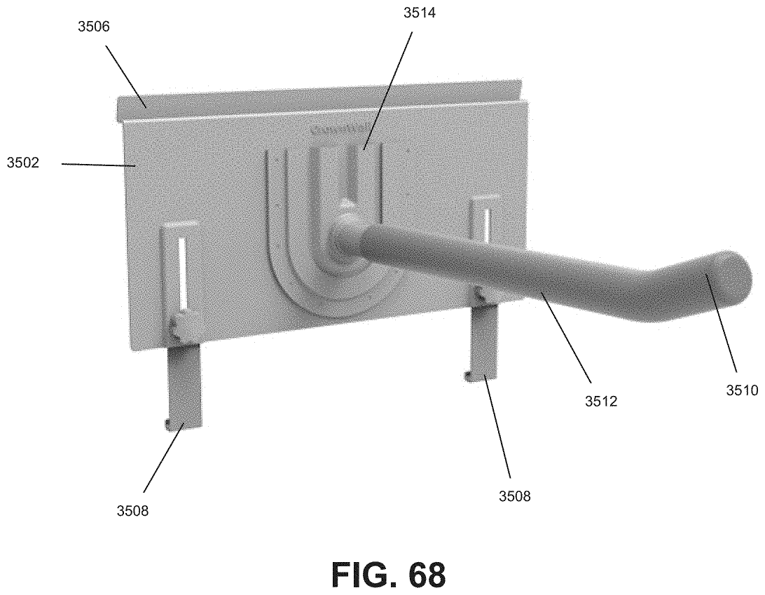

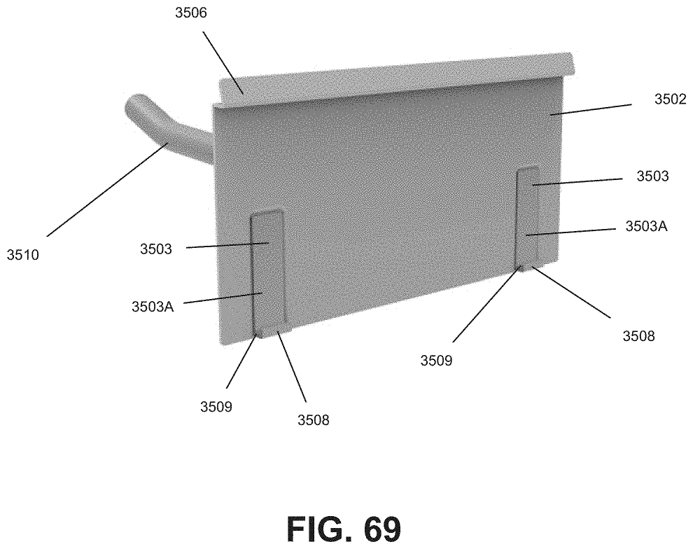

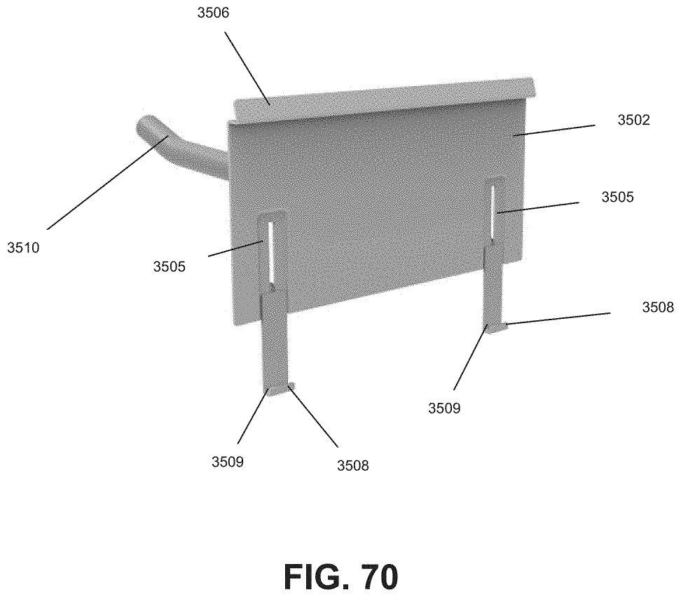

FIG. 66 to FIG. 72 depict a mounting assembly 3500A that is an alternate embodiment of the mounting assembly 3500. The mounting assembly 3500A substantially corresponds to the mounting assembly 3500, except the retainer 3520 and the bracket 3502 of the mounting assembly 3500A are separate components that are connected together, for example, by fasteners, welding, adhesives, and the like, and, in some embodiments, the mounting assembly 3500A does not include the bracket-defined releasing counterpart 3532.

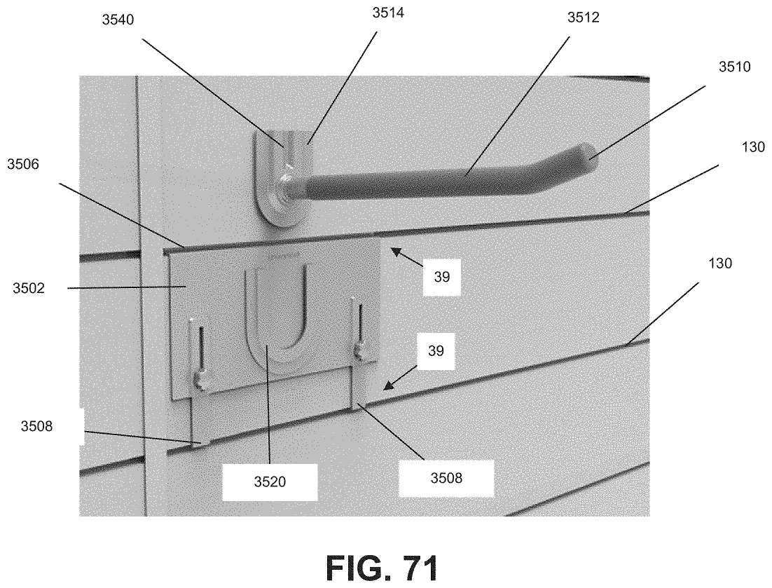

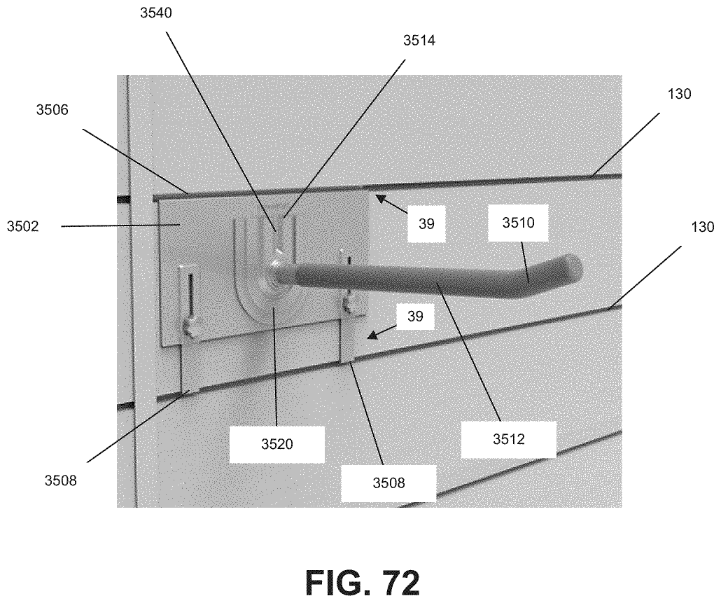

As depicted in FIG. 71 and FIG. 72, the mounting assembly 3500A is hung and secured to the wall panel assembly 10 in substantially the same manner as the mounting assembly 3500, and the load supporter 3510 of the mounting assembly 3500A is insertible into the cavity 3522 of the mounting assembly 3500A in substantially the same manner as the load supporter 3510 of the mounting assembly 3500 is insertible into the cavity 3522 of the mounting assembly 3500.

The preceding discussion provides many example embodiments. Although each embodiment represents a single combination of inventive elements, other examples may include all suitable combinations of the disclosed elements. Thus if one embodiment comprises elements A, B, and C, and a second embodiment comprises elements B and D, other remaining combinations of A, B, C, or D, may also be used.

The term “connected” or “coupled to” may include both direct coupling (in which two elements that are coupled to each other contact each other) and indirect coupling (in which at least one additional element is located between the two elements).

Although the embodiments have been described in detail, it should be understood that various changes, substitutions and alterations could be made herein.

Moreover, the scope of the present application is not intended to be limited to the particular embodiments of the process, machine, manufacture, and composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

As can be understood, the examples described above and illustrated are intended to be examples only. The invention is defined by the appended claims.

1-60. (canceled)

61. A mounting assembly configured to be hung from a recess defined within a wall panel assembly, the wall panel assembly including a front surface, the mounting assembly comprising:
a bracket;
a load supporter, including a load-supporting portion, the load-supporting portion configured to support a load, the load supporter coupled to the bracket, such that the load supporter is rotatable, relative to the bracket, about a rotation axis;
wherein:
the load supporter is transitionable between a support-ready configuration and a storage configuration via rotation of the load supporter, relative to the bracket, about the rotation axis;
in the support-ready configuration, the load-supporting portion extends in a direction along an axis that traverses a plane defined by the front surface of the wall panel assembly;
in the storage configuration, the load-supporting portion extends in a direction along an axis that is parallel to the plane defined by the front surface of the wall panel assembly.

62. The mounting assembly of claim 61, further comprising:
a sleeve support that is connected to the bracket, wherein the load supporter is rotatably coupled to the sleeve support, such that the coupling of the load supporter to the bracket is effected by the rotatable coupling of the load supporter to the sleeve support;
a locking mechanism;
wherein:
the sleeve support, the load supporter, and the locking mechanism are co-operatively configured to releasably lock the load supporter in at least the support-ready configuration, such that transition to the storage configuration is prevented.

63. The mounting assembly of claim 62, wherein the locking mechanism includes:
a guide pin, extending from the load supporter;
a vertical slot, defined by the sleeve support;
the guide pin, the slot, the sleeve support, and the load supporter are co-operatively configured such that:
while the pin is disposed above the slot, the load supporter is displaced, relative to the sleeve support, in a downwardly direction, such that the guide pin is slidably received in the slot for disposition of the guide pin in the slot to effect releasable locking of the load supporter in the support-ready configuration, wherein, while the load supporter is releasably locked in the support-ready configuration, rotational displacement of the load supporter, relative to the bracket, to transition to the storage configuration, is prevented;
while the load supporter is releasable locked in the support-ready configuration, the load supporter is releasable from the locking in the support-ready configuration via displacement of the load supporter, relative to the sleeve support, in an upwardly direction, with effect that the guide pin is displaced, relative to the slot, such that the guide pin becomes disposed out of the slot and above the sleeve support, with effect that the load supporter is released from the releasable locking, and is rotatable, relative to the bracket, to transition to the storage configuration.

64. The mounting assembly of claim 61, wherein the wall panel assembly comprises a panel-defined connection counterpart, and the assembly comprises a bracket-defined connection counterpart, wherein:
the panel-defined connection counterpart and the bracket-defined connection counterpart are co-operatively configured for the hanging of the bracket to the wall panel assembly; and
while the bracket is hung to the wall panel assembly, the bracket is vertically supported by the wall panel assembly, and displacement of the bracket, relative to the wall panel assembly, in a direction that is normal to the front surface of the wall panel assembly, is opposed.

65. The mounting assembly of claim 61, wherein, in the support-ready configuration, the traversing of the plane defined by the front surface of the wall panel assembly by the extension axis of the load-supporting portion is such that the axis is normal to the plane defined by the front surface of the wall panel assembly.

66. The mounting assembly of claim 61, wherein the rotation axis is parallel to a plane defined by the front surface of the wall panel assembly.

67. A mounting assembly configured to be hung from a recess of a wall panel assembly, the wall panel assembly including a front surface, the mounting assembly comprising:
a bracket, including a front surface and a retainer, and a cavity disposed between the front surface and the retainer;
a load supporter, including:
a load-supporting portion, the load-supporting portion configured to support a load;
wherein:
the front surface of the bracket, the retainer of the bracket, and the load supporter are co-operatively configured such that downwardly insertion of the load supporter into the cavity is with effect that the load supporter becomes disposed in a retained configuration;
in the retained configuration:
the retainer is:
vertically supporting the load supporter; and
opposing displacement of the load supporter, relative to the bracket, in an outwardly direction relative to the front surface of the wall panel assembly; and
the load-supporting portion extends in a direction along an axis that traverses a plane defined by the front surface of the wall panel assembly.

68. The mounting assembly of claim 67, wherein, in the retained configuration, the traversing of the plane defined by the front surface of the wall panel assembly by the extension axis of the load-supporting portion is such that the axis is normal to the plane defined by the front surface of the wall panel assembly.

69. The mounting assembly of claim 67, further comprising:
a release mechanism, comprising a bracket-defined releasing counterpart and a load supporter-defined releasing counterpart;
the bracket-defined releasing counterpart is transitionable between a release-effective configuration and a release-ineffective configuration;
wherein:
the cavity, the load support retainer, and the release mechanism are co-operatively configured such that, while: (i) the bracket is hung from the recess of the wall panel assembly, and (ii) the load supporter retainer is received in the cavity:
while the bracket-defined releasing counterpart is disposed in the release-ineffective configuration, the bracket-defined releasing counterpart is disposed in opposing relationship relative to the load supporter-defined releasing counterpart, such that displacement of the load supporter, relative to the cavity, in an upwardly direction, is opposed;
while the bracket-defined releasing counterpart is disposed in the release-effective configuration, the load support panel is displaceable, relative to the cavity, in the upwardly direction, to release the load supporter panel from the cavity;
the bracket-defined releasing counterpart is deformable to effect the transitioning of the bracket-defined releasing counterpart from the release-ineffective configuration to the release-effective configuration, the deformation of the bracket-defined releasing counterpart is with effect that the opposing of displacement of the load supporter panel, relative to the cavity, in the upward direction, is defeated; and
the bracket-defined releasing counterpart is biased to the release-ineffective configuration.

70. The mounting assembly of claim 67, wherein:
the load-supporting portion of the load supporter is configured to be received by an aperture of the load for extension through the aperture, such that, while the load is being supported by the load-supporting portion, the load-supporting portion is extended through the aperture.

71. The mounting assembly of claim 67, wherein the wall panel assembly comprises a panel-defined connection counterpart, and the assembly comprises a bracket-defined connection counterpart, wherein:
the panel-defined connection counterpart and the bracket-defined connection counterpart are co-operatively configured for the hanging of the bracket to the wall panel assembly; and
while the bracket is hung to the wall panel assembly, the bracket is vertically supported by the wall panel assembly, and displacement of the bracket, relative to the wall panel assembly, in a direction that is normal to the a front surface of the wall panel assembly, is opposed.

72. The mounting assembly of claim 67, wherein the load supporter includes a load supporter panel, and the downwardly insertion of the load supporter into the cavity for disposition of the load supporter in the retained configuration is effected by downwardly displacement of the load supporter panel into the cavity.

73. The mounting assembly of claim 67, wherein, while the load supporter is disposed in the retained configuration, the opposing of displacement of the load supporter, relative to the bracket, includes opposing displacement of the load supporter, relative to the bracket, in a lateral direction relative to the front surface of the wall panel assembly.

74. A kit for a mounting assembly configured to be hung from a recess of a wall panel assembly, the wall panel assembly including a front surface, the kit comprising:
a bracket, including a front surface and a retainer, and a cavity disposed between the front surface and the retainer;
a load supporter, including:
a load-supporting portion, the load-supporting portion configured to support a load;
wherein:
the front surface of the bracket, the retainer of the bracket, and the load supporter are co-operatively configured such that downwardly insertion of the load supporter into the cavity is with effect that the load supporter becomes disposed in a retained configuration;
in the retained configuration:
the retainer is:
vertically supporting the load supporter; and
opposing displacement of the load supporter, relative to the bracket, in an outwardly direction relative to the front surface of the wall panel assembly; and
the load-supporting portion extends in a direction along an axis that traverses a plane defined by the front surface of the wall panel assembly.

75. The kit of claim 74, wherein, in the retained configuration, the traversing of the plane defined by the front surface of the wall panel assembly by the extension axis of the load-supporting portion is such that the axis is normal to the plane defined by the front surface of the wall panel assembly.

76. The kit of claim 74, further comprising:
a release mechanism, comprising a bracket-defined releasing counterpart and a load supporter-defined releasing counterpart;
at least one of the bracket-defined releasing counterpart and the load supporter-defined releasing counterpart is transitionable between a release-effective configuration and a release-ineffective configuration;
wherein:
the cavity, the load support retainer, and the release mechanism are co-operatively configured such that, while: (i) the bracket is hung from the recess of the wall panel assembly, and (ii) the load supporter retainer is received in the cavity:
while the at least one of the bracket-defined releasing counterpart and the load supporter-defined releasing counterpart is disposed in the release-ineffective configuration, the bracket-defined releasing counterpart is disposed in opposing relationship relative to the load supporter-defined releasing counterpart, such that displacement of the load supporter, relative to the cavity, in an upwardly direction, is opposed;
while the at least one of the bracket-defined releasing counterpart and the load supporter-defined releasing counterpart is disposed in the release-effective configuration, the load support panel is displaceable, relative to the cavity, in the upwardly direction, to release the load supporter panel from the cavity;
the at least one of the bracket-defined releasing counterpart and the load supporter-defined releasing counterpart is deformable to effect the transitioning of the at least one of the bracket-defined releasing counterpart and the load supporter-defined releasing counterpart from the release-ineffective configuration to the release-effective configuration, the deformation of the at least one of the bracket-defined releasing counterpart and the load supporter-defined releasing counterpart is with effect that the opposing of displacement of the load supporter panel, relative to the cavity, in the upward direction, is defeated; and
the at least one of the bracket-defined releasing counterpart and the load supporter-defined releasing counterpart is biased to the release-ineffective configuration.

77. The kit of claim 74, wherein:
the load-supporting portion of the load supporter is configured to be received by an aperture of the load for extension through the aperture, such that, while the load is being supported by the load-supporting portion, the load-supporting portion is extended through the aperture.

78. The kit of claim 74, wherein the wall panel assembly comprises a panel-defined connection counterpart, and the assembly comprises a bracket-defined connection counterpart, wherein:
the panel-defined connection counterpart and the bracket-defined connection counterpart are co-operatively configured for the hanging of the bracket to the wall panel assembly; and.
while the bracket is hung to the wall panel assembly, the bracket is vertically supported by the wall panel assembly, and displacement of the bracket, relative to the wall panel assembly, in a direction that is normal to the a front surface of the wall panel assembly, is opposed.

79. The kit of claim 74, wherein the load supporter includes a load supporter panel, and the downwardly insertion of the load supporter into the cavity for disposition of the load supporter in the retained configuration is effected by downwardly displacement of the load supporter panel into the cavity.

80. The kit of claim 74, wherein, while the load supporter is disposed in the retained configuration, the opposing of displacement of the load supporter, relative to the bracket, includes opposing displacement of the load supporter, relative to the bracket, in a lateral direction relative to the front surface of the wall panel assembly.
